(19) United States
(12) Patent Application Publication
(10) Pub. No.: US 2015/0359217 A1
(43) Pub. Date: Dec. 17, 2015

(54) FRESHNESS-RETENTIVE FILM

(71) Applicant: MITSUI CHEMICALS TOHCELLO, INC., Chiyoda-ku, Tokyo (JP)

(72) Inventors: Junichi NARITA, Chiyoda-ku, Tokyo (JP); Tsunetoshi SHINADA, Chiyoda-ku, Tokyo (JP); Kazuhiko NEGISHI, Koga-shi, Ibaraki (JP)

(73) Assignee: MITSUI CHEMICALS TOHCELLO, INC., Chiyoda-ku, Tokyo OT (JP)

(21) Appl. No.: 14/763,973

(22) PCT Filed: Mar. 13, 2014
(86) PCT No.: PCT/JP2014/056598

§ 371 Date: Jul. 28, 2015

(30) Foreign Application Priority Data
Mar. 14, 2013 (JP) 2013-051536
May 23, 2013 (JP) 2013-108524
Jul. 2, 2013 (JP) 2013-139180
Oct. 18, 2013 (JP) 2013-217871
Nov. 21, 2013 (JP) 2013-240601

(51) Int. Cl. A01N 37/12; A01N 25/34; A01N 25/10; A01N 33/08

(52) U.S. Cl. CPC A01N 37/12; A01N 33/08; A01N 25/34; A01N 25/10

(57) ABSTRACT

The present invention provides a freshness-retentive film having high antibacterial characteristics. In the freshness-retentive film according to the present invention, at least one compound selected from the group consisting of palmityldiethanolamine, stearyldiethanolamine, glycerol monolaurate, and diglycerol monolaurate is present on at least one surface of the film at 0.002 to 0.5 g/m².

### TECHNICAL FIELD

The present invention relates to freshness-retentive films.

### BACKGROUND ART

Commercial products requiring freshness, such as fresh food products including vegetables and fruit are distributed while contained in packaging materials formed of films. These fresh food products cause discoloring and degradation such as wilt, and in turn start rotting as time goes by, leading to a reduction in their values as commercial products. For this reason, commercial products such as these fresh food products should be wrapped in packaging materials to retain freshness.

In particular, packaged cut vegetables are prepared by cutting cabbage, lettuce, or the like into strips of about 2 to 10 mm, immersing these strips in an aqueous solution of 100 to 200 ppm hypochlorous acid for 5 to 30 minutes, and sterilizing common bacteria, and packaging the strips in films, and are sold in supermarkets and the like or used in restaurant chains to increase cooking efficiency these days. These packaged cut vegetables should be prevented from being contaminated by invasion of bacteria into the sterilized contents of the packages or by proliferation of bacteria in nutrient fluids eluted from the contents to adhere to inner surfaces of the packaging materials. Consequently, development of films and packaging materials which have high antibacterial characteristics and barely allow migration of antibacterial components to the contents has been required.

Patent Literatures 1 and 2 disclose techniques related to films having antibacterial activity. Patent Literatures 3 to 5 disclose techniques related to films having antistatic activity.

### CITATION LIST

### Patent Literature

Patent Literature 1: JP11-158391A

Patent Literature 2: JP2003-176384A

Patent Literature 3: JP9-3273A

Patent Literature 4: JP60-57461 B

Patent Literature 5: JP48-54155A

### SUMMARY OF INVENTION

### Technical Problem

However, the techniques described in Patent Literatures 1 to 5 have low antibacterial characteristics and low freshness retentiveness based on the antibacterial characteristics, and cannot attain high antibacterial characteristics stably. An object of the present invention is to provide a freshness-retentive film and packaging material having high antibacterial characteristics.

### Solution to Problem

The present invention is the following [1] to [13].

[1] A freshness-retentive film, containing at least one compound selected from the group consisting of palmityldiethanolamine, stearyldiethanolamine, glycerol monolaurate, and diglycerol monolaurate, wherein the at least one compound is present on at least one surface at 0.002 to 0.5 g/m².
[2] The freshness-retentive film according to [1], wherein the freshness-retentive film contains the compound in an amount of 0.001 to 3% by mass.
[3] The freshness-retentive film according to [1] or [2], wherein the freshness-retentive film contains at least one of a propylene-based polymer and an ethylene-based polymer.
[4] The freshness-retentive film according to any of [1] to [3], wherein at least one surface has a wetting index of 35 dyn or more.
[5] The freshness-retentive film according to any of [1] to [4], wherein the freshness-retentive film further contains at least one of myristyldiethanolamine monostearate and stearyldiethanolamine monostearate.
[6] The freshness-retentive film according to any of [1] to [5], wherein a region contains the compound in a thickness-wise direction from a surface of the film to be in contact with a content, the region ranging from 50 to 90% of the overall thickness of the film.
[7] The freshness-retentive film according to any of [1] to [6], wherein the freshness-retentive film includes two or more layers, and wherein the freshness-retentive film contains the compound only in a layer having a surface of the film to be in contact with a content.
[8] The freshness-retentive film according to any of [1] to [7], wherein the freshness-retentive film contains an ethylene-based polymer, and the density of the ethylene-based polymer increases in a thickness-wise direction from the surface of the film to be in contact with a content.
[9] A freshness-retentive film, containing 0.01 to 1.0% by mass of alkyldiethanolamine and 0.01 to 1.0% by mass of at least one of diglycerol monopalmitate and diglycerol monomyristate.
[10] The freshness-retentive film according to [9], wherein the alkyldiethanolamine is present on at least one surface at 0.002 to 0.5 g/m².
[11] The freshness-retentive film according to [9] or [10], wherein the alkyldiethanolamine is at least one of palmityldiethanolamine and stearyldiethanolamine.
[12] A freshness-retentive film, containing 50 to 95% by mass of a linear low density polyethylene (A) having a density of 0.85 to 0.95 g/cm³, and 5 to 50% by mass of a high pressure low density polyethylene (B) having a density of 0.91 to 0.93 g/cm³, where the total amount of the linear low density polyethylene (A) and the high pressure low density polyethylene (B) is 100% by mass, 0.5 to 10 parts by mass of an adhesive (C), 0.5 to 5 parts by mass of an antifog additive (D), and 0.001 to 3 parts by mass of at least one specific compound (E) selected from the group consisting of palmityldiethanolamine, stearyldiethanolamine, glycerol monolaurate, and glycerol monocaprate relative to 100 parts by mass of the total amount of the linear low density polyethylene (A) and the high pressure low density polyethylene (B), wherein the specific compound (E) is present on at least one surface at 0.002 to 0.5 g/m².
[13] A packaging material, including the freshness-retentive film according to any of [1] to [12].

### Advantageous Effect of Invention

The present invention can provide a freshness-retentive film and packaging material having high antibacterial characteristics.

### DESCRIPTION OF EMBODIMENTS

### First Embodiment

In the freshness-retentive film according to the present invention, at least one compound selected from the group consisting of palmityldiethanolamine, stearyldiethanolamine, glycerol monolaurate, and diglycerol monolaurate (hereinafter also referred to as Specific compound 1) is present at 0.002 to 0.5 g/m² on at least one surface of the film. Specific compound 1 is present at 0.002 to 0.5 g/m² on at least one surface of the freshness-retentive film attains a freshness-retentive film having high antibacterial characteristics. The freshness-retentive film preferably contains 0.001 to 3% by mass of Specific compound 1 to attain antibacterial characteristics. The freshness-retentive film preferably contains at least one of a propylene-based polymer and an ethylene-based polymer to attain light weight and high film processability. To attain antibacterial characteristics, the number of surviving bacterial cells on at least one surface of the freshness-retentive film is preferably 1/100 times or less after 24 hours after the freshness-retentive film is subjected to the antibacterial test according to JIS Z2801 using E. coli under a condition where the surface of the freshness-retentive film is not wiped with alcohol to keep the state of the surface of the freshness-retentive film.

In the present invention, the freshness-retentive film indicates a film having an effect of retaining the freshness of a packaged object by the antibacterial action of the surface of the film facing the packaged object sealed in a package formed of the freshness-retentive film.

### <Specific Compound 1>

Palmityldiethanolamine, stearyldiethanolamine, glycerol monolaurate, and diglycerol monolaurate can be used singly, or a mixture thereof can be used as Specific compound 1 according to the present invention. Palmityldiethanolamine is an alkyldiethanolamine having a palmityl group being a long-chain alkyl group having 16 carbon atoms. Stearyldiethanolamine is an alkyldiethanolamine having a stearyl group having 18 carbon atoms. Glycerol monolaurate is a monoester of lauric acid (12 carbon atoms) and glycerol. Diglycerol monolaurate is a monoester of lauric acid (12 carbon atoms) and diglycerol.

Stearyldiethanolamine and palmityldiethanolamine have relatively higher melting points than those of myristyldiethanolamine and lauryldiethanolamine. For this reason, stearyldiethanolamine and palmityldiethanolamine are not likely to relatively volatilize in melt molding of the freshness-retentive film, particularly during heat setting in the case where the freshness-retentive film is a stretched film. In addition, stearyldiethanolamine and palmityldiethanolamine have high antibacterial characteristics and freshness retentiveness. In addition, in the freshness-retentive film used as a packaging film, stearyldiethanolamine and palmityldiethanolamine relatively slowly migrate to a packaged object which is a content in contact with the packaging film. Stearyldiethanolamine and palmityldiethanolamine can attain a freshness-retentive film having high safety and can keep its performance. The “packaged object” in the freshness-retentive film may be referred to as “content.”

(Alkyldiethanolamine; the number of carbon atoms of long-chain alkyl group; melting point)

stearyldiethanolamine; 18 carbon atoms; 51° C.

palmityldiethanolamine; 16 carbon atoms; 28° C.

myristyldiethanolamine; 14 carbon atoms; 22 to 23° C.

lauryldiethanolamine; 12 carbon atoms; liquid at normal temperature.

Specific compound 1 according to the present invention may contain a similar compound. Palmityldiethanolamine (16 carbon atoms) may contain a small amount of alkyldiethanolamine having an alkyl group having 12 to 20 carbon atoms such as myristyldiethanolamine (14 carbon atoms) and stearyldiethanolamine (18 carbon atoms), for example. Stearyldiethanolamine (18 carbon atoms) may contain a small amount of alkyldiethanolamine having an alkyl group having 16 to 20 carbon atoms, for example. Specific compound 1 may contain a small amount of a compound similar to palmityldiethanolamine or stearyldiethanolamine in which amine partially forms an ester with an aliphatic carboxylic acid. Glycerol monolaurate may contain a small amount of a monoester of a higher linear aliphatic carboxylic acid having 10 or 14 carbon atoms and glycerol, for example. Diglycerol monolaurate may contain a small amount of a monoester of a higher aliphatic carboxylic acid having 10 or 14 carbon atoms and diglycerol, or the like. The (di)glycerol monoester may contain a small amount of a similar compound such as (di)glycerol diester and (di)glycerol triester or a similar compound in which glycerol moiety is replaced with diglycerol, or diglycerol moiety is replaced with triglycerol. In general, these similar compounds of Specific compound 1 are synthesized simultaneously or difficult to separate during steps such as synthesis or separation of Specific compound 1. The similar compound may be contained in an amount of 50 parts by mass or less or 40 parts by mass or less relative to 100 parts by mass of Specific compound 1. The similar compound is preferably not contained at all.

The freshness-retentive film according to the present invention can optionally contain, in addition to Specific compound 1, other optional additives described later, such as antistatic agents, antifog additives (excluding Specific compound 1), and lubricants. These other additives and the similar compound in total can be contained in an amount of 50 parts by mass or less, 40 parts by mass or less, or 30 parts by mass or less relative to 100 parts by mass of Specific compound 1.

### <Providing Functions Such as Antibacterial Characteristics and Freshness Retentiveness>

In the freshness-retentive film according to the present invention, Specific compound 1 is present on at least one surface thereof at 0.002 to 0.5 g/m². In the freshness-retentive film according to the present invention, Specific compound 1 is present on at least one surface thereof at preferably 0.004 to 0.4 g/m², more preferably 0.01 to 0.3 g/m², still more preferably 0.02 to 0.2 g/m². Specific compound 1 is preferably present at 0.002 to 0.5 g/m² on the surface of the freshness-retentive film in contact with a content. Examples of the method of distributing Specific compound 1 on the surface of the freshness film include a coating method of spraying Specific compound 1 onto the surface of the film or applying a solution, a suspension, or the like containing Specific compound 1 onto the surface of the film as described above. Alternatively, Specific compound 1 may be contained in a surface layer or an intermediate layer having the surface of the freshness-retentive film in contact with the content. The content of Specific compound 1 in the freshness-retentive film is preferably 0.001 to 3% by mass, more preferably 0.01 to 3% by mass, still more preferably 0.1 to 2% by mass to cause bleed out of Specific compound 1 in an amount in the range above to the surface of the film.

### <Method of Determining Specific Compound 1 on Surface of Freshness-Retentive Film>

The amount of Specific compound 1 on the surface of the freshness-retentive film is calculated from the amount of Specific compound 1 coated in the case where Specific compound 1 is applied onto the surface of the film by coating. In the case where Specific compound 1 is compounded in the freshness-retentive film, the amount of Specific compound 1 on the surface of the freshness-retentive film is determined as follows: The surface of the freshness-retentive film is washed with dichloromethane. The washing liquid is recovered, and is condensed to a certain volume. The washing liquid is silylated to determine the amount of Specific compound 1 by gas chromatography mass spectrometry (GC/MS).

### <Polyethylene Glycol (PEG)>

The freshness-retentive film according to the present invention preferably contains polyethylene glycol (PEG) in a content of 0.001 to 1% by mass to promote bleed out of Specific compound 1. The content is more preferably 0.010 to 0.500% by mass, still more preferably 0.030 to 0.400% by mass, particularly preferably 0.040 to 0.300% by mass. The polyethylene glycol (PEG) can have any weight average molecular weight. To prevent volatilization of Specific compound 1 by heating during molding, the weight average molecular weight is preferably 50,000 or more. To more effectively demonstrate freshness retentiveness and antibacterial characteristics by Specific compound 1, polyethylene glycol (PEG) is preferably contained in a layer having Specific compound 1.

### <Thermoplastic Resin>

The freshness-retentive film according to the present invention is preferably composed of a thermoplastic resin. Examples of the thermoplastic resin include homopolymers or copolymers of α-olefins such as ethylene, propylene, 1-butene, 1-hexene, 4-methyl-1-pentene, and 1-octene. Specifically, examples thereof include ethylene-based polymers such as high pressure low density polyethylenes, linear low density polyethylenes (LLDPEs), and high density polyethylenes; propylene-based polymers such as propylene homopolymers, propylene-α-olefin random copolymers, and propylene block copolymers; and polyolefins such as poly(l-butene) and poly(4-methyl-1-pentene). Examples of the thermoplastic resin also include polyesters such as poly(ethylene terephthalate), poly(butylene terephthalate), and poly(ethylene naphthalate); polyamides such as nylon-6, nylon-66, and poly(meta-xylene adipamide); poly(vinyl chloride), polyimides, ethylene vinyl acetate copolymers or saponified products thereof; biodegradable resins such as poly(vinyl alcohol), polyacrylonitriles, polycarbonates, polystyrenes, ionomers, poly(lactic acid), and poly(butylene succinate), or mixtures thereof. These thermoplastic resins can be used singly or in combinations of two or more. Among these thermoplastic resins, preferred are polyolefins, polyesters, polyamides, and the like for their high rigidity and transparency. As the thermoplastic resin, more preferred are ethylene-based polymers and propylene-based polymers for their light weights and high film processability, and still more preferred are propylene-based polymers for their high flexibility and transparency.

### <Propylene-Based Polymer>

Examples of the propylene-based polymer include crystalline polymers mainly composed of propylene such as propylene homopolymers manufactured and sold under the name of polypropylene (also referred to as homo PP), propylene-α-olefin random copolymers (also referred to as random PP), and mixture of propylene homopolymers and low-crystalline or non-crystalline propylene-ethylene random copolymers (also referred to as block PP). The propylene-based polymer may be a mixture of propylene homopolymers having different molecular weights, or may be a mixture of propylene homopolymers and random copolymers of propylene and ethylene or α-olefins having 4 to 10 carbon atoms.

Examples of the propylene-based polymer specifically include copolymers of main monomer propylenes such as polypropylene, propylene-ethylene copolymers, propylene-ethylene-1-butene copolymers, propylene-1-butene copolymers, propylene-1-pentene copolymers, propylene-1-hexene copolymers, and propylene-1-octene copolymers and at least one selected from ethylene and α-olefins having 4 to 10 carbon atoms. These may be used singly or in combinations of two or more.

The density of the propylene-based polymer is preferably 0.890 to 0.930 g/cm³, more preferably 0.900 to 0.920 g/cm³. The MFR of the propylene-based polymer (ASTM D1238, load: 2160 g, temperature: 230° C.) is preferably 0.5 to 60 g/10 min, more preferably 0.5 to 10 g/10 min, still more preferably 1 to 5 g/10 min.

In the freshness-retentive film according to the present invention including three or more layers, the resin forming an intermediate layer other than surface layers (surface layer and rear surface layer) is preferably a propylene homopolymer having a melting point (Tm) of 155 to 170° C., or a copolymer of a propylene and 1 mol % or less α-olefin to attain enhanced rigidity and heat resistance of the freshness-retentive film. The resin forming the surface layer and the rear surface layer of the film is preferably a propylene-based polymer having a melting point (Tm) in the range of 125° C. or more and less than 155° C., preferably 130 to 145° C. In particular, to attain a freshness-retentive film having high heat sealing characteristics, and heat sealing characteristics and heat resistance in a good balance, the resin forming the surface layer and the rear surface layer is preferably a propylene-α-olefin random copolymer. Throughout the specification, in a freshness-retentive film composed of two or more layers, the surface layer indicates the layer including the surface of the film to be in contact with a content or a packaged object. The rear surface layer indicates the layer including the surface opposite to the surface of the surface layer.

### <Ethylene-Based Polymer>

Examples of the ethylene-based polymer include ethylene homopolymers, copolymers of main monomer ethylene and at least one α-olefin having 3 to 8 carbon atoms, ethylene-vinyl acetate copolymers, and saponified product and ionomers thereof. Specifically, examples thereof include copolymers of main monomer ethylenes such as polyethylene, ethylene-propylene copolymers, ethylene-1-butene copolymers, ethylene-1-pentene copolymers, ethylene-1-hexene copolymers, ethylene-4-methyl-1-pentene copolymers, and ethylene-1-octene copolymers and at least one α-olefin having 3 to 8 carbon atoms. The α-olefin is preferably contained in a content of 1 to 15 mol % in these copolymers.

Examples of the ethylene-based polymer include ethylene polymers manufactured and sold under the name of polyethylene. Specifically, high pressure low density polyethylene (LDPE), linear low density polyethylene (LLDPE), and high density polyethylene (HDPE) are preferable, and LLDPE is more preferable. LLDPE is a copolymer of ethylene and a small amount of propylene, butene-1, heptene-1, hexene-1, octene-1, or 4-methyl-pentene-1. The ethylene-based polymer may be an ethylene homopolymer or may be a polymer mainly composed of ethylene such as LLDPE.

The density of the ethylene-based polymer is preferably 0.910 to 0.940 g/cm³, more preferably 0.920 to 0.930 g/cm³. A density of 0.910 g/cm³ or more enhances the heat sealing characteristics of the film. A density of 0.940 g/cm³ or less enhances the processability and the transparency of the film.

### <Other Additives>

The freshness-retentive film according to the present invention may contain heat stabilizers (antioxidants), weathering stabilizers, ultraviolet absorbing agents, lubricants, slipping agents, nucleus agents, blocking preventing agents, antistatic agents, antifog additives, pigments, dyes, and various fillers such as talc, silica, and diatomite in the range not impairing the intention of the present invention.

Examples of the heat stabilizer include phenol-based antioxidants such as 3,5-di-t-butyl-4-hydroxytoluene, tetrakis[methylene(3,5-di-t-butyl-4-hydroxy)hydrocinnamate]methane, n-octadecyl-3-(4′-hydroxy-3,5-di-t-butylphenyl)propionate, and 2,2′-methylene-bis(4-methyl-6-t-butylphenol); benzophenone-based antioxidants such as 2-hydroxy-4-methoxybenzophenone, 2-hydroxy-4-octoxybenzophenone, and 2,4-dihydroxybenzophenone; benzotriazole-based antioxidants such as 2-(2′-hydroxy-5-methylphenyl)benzotriazole and substituted benzotriazole; 2-ethylhexyl-2-cyano-3,3-diphenyl acrylate, ethyl-2-cyano-3,3-diphenyl acrylate, phenyl salicylate, and 4-t-butylphenyl salicylate. These may be used singly or in combinations of two or more.

Examples of the antistatic agent include alkylamines and derivatives thereof, higher alcohols, pyridine derivatives, sulfated oil, soaps, sulfate ester salts of olefins, alkyl sulfate esters, fatty acid ethyl sulfonates, alkyl sulfonates, alkylnaphthalene sulfonates, alkylbenzene sulfonates, naphthalene sulfonates, succinic acid ester sulfonates, phosphoric acid ester salts, partial fatty acid esters of polyhydric alcohols, ethylene oxide adducts of fatty alcohols, ethylene oxide adducts of fatty acids, ethylene oxide adducts of fatty amino or fatty acid amide, ethylene oxide adducts of alkylphenol, ethylene oxide adducts of alkylnaphthol, ethylene oxide adducts of partial fatty acid esters of polyhydric alcohols, and polyethylene glycol. These may be used singly or in combinations of two or more.

Examples of the lubricant include stearic acid, stearamide, oleamide, higher alcohols, and liquid paraffins. These may be used singly or in combinations of two or more.

Examples of the ultraviolet absorbing agent include ethylene-2-cyano-3,3′-diphenyl acrylate, 2-(2′-hydroxy-5′-methylphenyl)benzotriazole, 2-(2′-hydroxy-3′-t-butyl-5′-methylphenyl)-5-chlorobenzotriazole, 2-hydroxy-4-methoxybenzophenone, 2,2′-dihydroxy-4-methoxybenzophenone, and 2-hydroxy-4-octoxybenzophenone. These may be used singly or in combinations of two or more.

Examples of the antifog additive include, but not include Specific compound 1, higher aliphatic alcohols, glycerol fatty acids, diglycerol fatty acids, acid esters of these mono- or diglycerol fatty acids, higher aliphatic amines, higher fatty acid esters, and mixtures thereof. These may be used singly or in combinations of two or more.

### <Freshness-Retentive Film and Production Method Thereof>

A freshness-retentive film containing a propylene-based polymer or an ethylene-based polymer and the method of producing the film will now be described, but the present invention will not be limited to these freshness-retentive films.

### (Freshness-Retentive Film Containing Propylene-Based Polymer)

The freshness-retentive film according to the present invention containing a propylene-based polymer may be a single-layer film, may be a two-layer film, or may be composed of three or more layers.

The freshness-retentive film may be a non-stretched propylene film, or a monoaxially stretched polypropylene film. In the applications for cut vegetables, for example, the freshness-retentive film is preferably a biaxially stretched polypropylene film for transparency and mechanical physical characteristics of the film.

Particularly in stretched films, the freshness-retentive film is preferably composed of three or more layers for the following reason. In such a configuration, the surface layer and the rear surface layer having low melting points, and the intermediate layer having a high melting point are used to provide the difference in the melting point. The difference can prevent the melting of the intermediate layer during heat sealing of the film if the surface layer and the rear surface layer are melted, and can heat seal the film without shrinking the film. If the freshness-retentive film according to the present invention is a multi-layer film composed of at least three layers of the rear surface layer, the intermediate layer, and the surface layer, and is composed of a propylene-based polymer, at least one layer of the rear surface layer, the intermediate layer, and the surface layer in the freshness-retentive film may contain Specific compound 1. Particularly, the intermediate layer contains preferably 0.001 to 3% by mass of Specific compound 1. If the intermediate layer contains 0.001 to 3% by mass of Specific compound 1, and even if the content of Specific compound 1 contained in the surface layer and/or the rear surface layer is 0.001% by mass or less, Specific compound 1 can migrate between the layers so that Specific compound 1 can be present at 0.002 to 0.5 g/m² on at least one surface of the freshness-retentive film.

The ratio of the thicknesses of the rear surface layer, the intermediate layer, and the surface layer is preferably 3/94/3 to 10/80/10, more preferably 4/92/4 to 8/84/4. If the thickness proportions of the rear surface layer and the surface layer each are 3% or more with respect to the total thickness of these layers, sufficient heat seal strength is attained. If the thickness proportions of the rear surface layer and the surface layer each are 10% or less with respect to the total thickness of these layers, Bleed out of Specific compound 1 to the surface of the surface layer of the freshness-retentive film can be readily caused to keep stable antibacterial characteristics of the film.

The total thickness of the freshness-retentive film is preferably 15 to 50 μm, more preferably 20 to 40 μm. If the freshness-retentive film is a multi-layer film composed of three or more layers, the ratio of the thicknesses of the surface layer, the intermediate layer, and the rear surface layer within the range above can attain a freshness-retentive film having heat sealing characteristics, rigidity, and heat resistance in a good balance. A thickness of 15 μm or more enhances rigidity to readily keep the shape of the bag formed of the freshness-retentive film, and enhances handling characteristics and pierce strength. A thickness of 50 μm or less enhances productivity and reduces cost.

Irrespective of the number of layers (three or more layers, single layer, or two layers) in the freshness-retentive film according to the present invention, the content of Specific compound 1 is preferably 0.001 to 3% by mass, more preferably 0.01 to 3% by mass, still more preferably 0.03 to 2% by mass, particularly preferably 0.04 to 0.9% by mass, most preferably 0.04 to 0.6% by mass of the overall freshness-retentive film.

Examples of the method of producing the freshness-retentive film composed of three or more layers include a method of coating the surface of the surface layer with Specific compound 1, or a method of containing Specific compound 1 in the surface layer. Specific compound 1 may be contained only in the surface layer. Other preferred aspects thereof include a method of containing Specific compound 1 in the intermediate layer(s) or partially in the intermediate layer(s). In this case, a specific amount of Specific compound 1 is present on the surface of the surface layer by bleed out of Specific compound 1 from the intermediate layer to the surface of the surface layer. Alternatively, Specific compound 1 may be contained only in the intermediate layer or only in part of the intermediate layer. In this case, Specific compound 1 is contained only in the intermediate layer or only in part of the intermediate layer in an amount of preferably 0.001 to 3% by mass, more preferably 0.01 to 3% by mass, still more preferably 0.03 to 2% by mass, particularly preferably 0.04 to 0.9% by mass, most preferably 0.04 to 0.6% by mass of the overall freshness-retentive film.

If the respective layers of the freshness-retentive film contain Specific compound 1, Specific compound 1 may be preliminarily compounded in materials for the respective layers to provide a predetermined amount of Specific compound 1 on the surface. Preferably, a composition containing large amounts of Specific compound 1 and other additives (masterbatch) is prepared, and is mixed with the propylene-based polymer such that the final amount of Specific compound 1 on the surface falls within a desired range. The mixture is placed in an extruder or the like, and is molded.

If the freshness-retentive film according to the present invention is a biaxially stretched polypropylene film, preferred conditions on biaxial stretching are a temperature of 90 to 140° C. and a stretching ratio of 4 to 6 in longitudinal stretching and a temperature of 140 to 200° C. and a stretching ratio of 8 to 12 in lateral stretching. After stretching, the film is preferably heat set to stabilize the heat shrinkage rate of the film. The heat setting is performed preferably at 160° C. or more for 5 seconds or more, more preferably at 160 to 220° C. for 5 to 10 seconds.

Particularly in the non-stretched film, a surface layer having a low melting point and an intermediate layer and a rear surface layer having high melting points are used to provide the difference in the melting point. A film having such a layer configuration can be heat sealed without melting the intermediate layer and the rear surface layer if the surface layer serving as the surface to be sealed is melted during heat sealing. For this reason, the freshness-retentive film is preferably composed of two or more layers.

If the freshness-retentive film according to the present invention is a multi-layer film composed of at least three layers of the rear surface layer, the intermediate layer, and the surface layer, and is composed of a propylene-based polymer, at least one layer of the rear surface layer, the intermediate layer, and the surface layer in the freshness-retentive film may contain Specific compound 1. Particularly, the surface layer preferably contains 0.001 to 3% by mass of Specific compound 1. If Specific compound 1 is contained in an amount of 0.001 to 3% by mass in the surface layer, Specific compound 1 can be present at 0.002 to 0.5 g/m² on the surface of the surface layer to be in contact with a content.

The ratio of the thicknesses of the surface layer, the intermediate layer, and the rear surface layer is preferably 10/80/10 to 40/30/40, more preferably 20/60/20 to 35/30/35. If the thickness proportion of the surface layer is 10% or more with respect to the total thickness of these layers, sufficient heat seal strength can be attained in a single package. Bleed out of Specific compound 1 to the surface layer serving as the surface to be sealed can be readily caused to keep stable antibacterial characteristics.

The total thickness of the freshness-retentive film is preferably 15 to 120 μm, more preferably 20 to 100 μm. If the freshness-retentive film is a multi-layer film composed of three or more layers and the ratio of the thicknesses of the surface layer, the intermediate layer, and the rear surface layer is within the range above, the freshness-retentive film can attain heat sealing characteristics, rigidity, and heat resistance in a good balance.

In an aspect of the multi-layer film containing the propylene-based polymer, the propylene-based polymer of the intermediate layer preferably has a melting point (Tm) of 135 to 160° C. The propylene-based polymer of the surface layer and the rear surface layer has a melting point (Tm) of preferably 120° C. or more and less than 155° C., more preferably 130 to 145° C. Among these propylene-based polymers, particularly preferred are propylene-α-olefin random copolymers, which attain a multi-layer film having high heat sealing characteristics.

In an aspect of the multi-layer film containing palmityldiethanolamine and/or stearyldiethanolamine in the surface layer and the intermediate layer, these compounds may be preliminarily compounded in the materials for the surface layer and the intermediate layer. Preferably, a composition containing large amounts of palmityldiethanolamine and/or stearyldiethanolamine, and other additives (masterbatch) is prepared, and is mixed with the propylene-based polymer such that the final amount of palmityldiethanolamine and/or stearyldiethanolamine compounded falls within a desired range. The mixture is placed in an extruder, and is formed into the surface layer and the intermediate layer.

### (Freshness-Retentive Film Containing Ethylene-Based Polymer)

If the freshness-retentive film according to the present invention contains an ethylene-based polymer, the freshness-retentive film may be a single-layer film, may be a two-layer film, or may be a multi-layer film composed of three or more layers. Alternatively, the freshness-retentive film according to the present invention may be a non-stretched film or may be a film stretched in at least one axial direction such as a monoaxially stretched film or a biaxially stretched film. Preferred ethylene-based polymers are high pressure low density polyethylene (LDPE), linear low density polyethylene (LLDPE), and high density polyethylene (HDPE) as described above.

If the freshness-retentive film contains Specific compound 1 in the film, the content of Specific compound 1 in the freshness-retentive film is preferably 0.01 to 3% by mass, more preferably 0.01 to 2% by mass. Alternatively, Specific compound 1 may be applied onto the surface of the freshness-retentive film such that Specific compound 1 is present at 0.002 to 0.5 g/m² on at least one surface of the freshness-retentive film.

Particularly in the biaxially stretched film, the freshness-retentive film is preferably composed of three or more layers for the following reason. In such a configuration, the surface layer and the rear surface layer having low melting points, and the intermediate layer having a high melting point are used to provide the difference in the melting point. The difference can prevent the melting of the intermediate layer during heat sealing of the film if the surface layer and the rear surface layer are melted, and can heat seal the film without shrinking the film. If the freshness-retentive film according to the present invention is a multi-layer film composed of at least three layers of the rear surface layer, the intermediate layer, and the surface layer, and is a biaxially stretched film composed of an ethylene-based polymer, at least one layer of the rear surface layer, the intermediate layer, and the surface layer in the freshness-retentive film may contain Specific compound 1. Particularly, the intermediate layer preferably contains 0.001 to 3% by mass of Specific compound 1. If the intermediate layer contains 0.001 to 3% by mass of Specific compound 1, Specific compound 1 migrates between the layers and Specific compound 1 can be present at 0.002 to 0.5 g/m² on at least one surface of the freshness-retentive film even when the content of Specific compound 1 in the surface layer and/or the rear surface layer is 0.001% by mass or less.

The ratio of the thicknesses of the rear surface layer, the intermediate layer, and the surface layer is preferably 3/94/3 to 10/80/10, more preferably 4/92/4 to 8/84/4. If the thickness proportions of the rear surface layer and the surface layer each are 3% or more with respect to the total thickness of these layers, sufficient heat seal strength is attained. If the thickness proportions of the rear surface layer and the surface layer each are 10% or less with respect to the total thickness of these layers, bleed out of Specific compound 1 to the surface of the surface layer of the freshness-retentive film can be readily caused to keep stable antibacterial characteristics of the film.

The total thickness of the freshness-retentive film is preferably 15 to 50 μm, more preferably 20 to 40 μm. If the freshness-retentive film is a multi-layer film composed of three or more layers, the ratio of the thicknesses of the surface layer, the intermediate layer, and the rear surface layer within the range above can attain a freshness-retentive film having heat sealing characteristics, rigidity, and heat resistance in a good balance. A thickness of 15 μm or more enhances rigidity to readily keep the shape of the bag formed of the freshness-retentive film, and enhances handling characteristics and pierce strength. A thickness of 50 μm or less enhances productivity and reduces cost.

Irrespective of the number of layers (three or more layers, single layer, or two layers) in the freshness-retentive film according to the present invention, the content of Specific compound 1 is preferably 0.001 to 3% by mass, more preferably 0.01 to 3% by mass, still more preferably 0.03 to 2% by mass, particularly preferably 0.04 to 0.9% by mass, most preferably 0.04 to 0.6% by mass of the overall freshness-retentive film.

Examples of the method of producing the freshness-retentive film composed of three or more layers include a method of coating the surface of the surface layer with Specific compound 1, or a method of containing Specific compound 1 in the surface layer and the intermediate layer. Specific compound 1 may be contained only in the surface layer. In the stretched film, other preferred aspects thereof include a method of containing Specific compound 1 in the intermediate layer(s) or partially in the intermediate layer(s). In this case, Specific compound 1 migrates among the layers through the intermediate layer to bleed out to the surface of the surface layer so that a specific amount of Specific compound 1 is present on the surface of the surface layer. Alternatively, Specific compound 1 may be contained only in the intermediate layer or only in part of the intermediate layer. In this case, Specific compound 1 is contained only in the intermediate layer or only in part of the intermediate layer in an amount of preferably 0.001 to 3% by mass, more preferably 0.01 to 3% by mass, still more preferably 0.03 to 2% by mass, particularly preferably 0.04 to 0.9% by mass, most preferably 0.04 to 0.6% by mass of the overall freshness-retentive film.

If the respective layers of the freshness-retentive film contain Specific compound 1, Specific compound 1 may be preliminarily compounded in materials for the respective layers to provide a predetermined amount of Specific compound 1 on the surface. Preferably, a composition containing large amounts of Specific compound 1 and other additives (masterbatch) is prepared, and is mixed with a polyethylene-based polymer such that the final amount of Specific compound 1 on the surface falls within a desired range. The mixture is placed in an extruder or the like, and is molded.

If the freshness-retentive film according to the present invention is a biaxially stretched polyethylene film, preferred conditions on biaxial stretching is a temperature of 60 to 120° C. and a stretching ratio of 4 to 6 in longitudinal stretching and a temperature of 100 to 120° C. and a stretching ratio of 8 to 12 in lateral stretching. After stretching, the film is preferably heat set to stabilize the thermal shrinkage rate of the film. The heat setting is performed preferably at 100° C. or more for 5 seconds or more, more preferably at 100 to 150° C. for 5 to 10 seconds.

Particularly in the non-stretched film, a surface layer having a low melting point and an intermediate layer and a rear surface layer having high melting points are used to provide the difference in the melting point. A film having such a layer configuration can be heat sealed without melting the intermediate layer and the rear surface layer opposite the surface layer if the surface layer is melted during heat sealing. For this reason, the freshness-retentive film is preferably composed of two or more layers.

The melting point can be increased by increasing the density of the ethylene-based polymer contained in each layer. At this time, to prevent bleeding of Specific compound 1 to the surface of the rear surface layer, the density of the ethylene-based polymer contained in the rear surface layer can be increased, thereby preventing migration of Specific compound 1 to the rear surface layer and further promoting bleeding of Specific compound 1 to the surface layer. The density of the ethylene-based polymer contained in the surface layer is preferably 0.880 to 0.935 g/cm³, more preferably 0.900 to 0.930 g/cm³ because Specific compound 1 in the intermediate layer readily migrates to the surface layer and no blocking occurs. The density of the ethylene-based polymer contained in the intermediate layer and the rear surface layer is preferably 0.910 to 0.960 g/cm³, more preferably 0.920 to 0.950 g/cm³ because Specific compound 1 in the intermediate layer readily migrates to the surface layer and the rigidity of the film is not significantly high. The density of the ethylene-based polymer contained in the intermediate layer and the rear surface layer is preferably 0.005 to 0.050 g/cm³ higher than that of the ethylene-based polymer contained in the surface layer.

If the freshness-retentive film according to the present invention is a multi-layer film composed of at least three layers of the rear surface layer, the intermediate layer, and the surface layer, and is composed of a propylene-based polymer, at least one layer of the rear surface layer, the intermediate layer, and the surface layer in the freshness-retentive film may contain Specific compound 1. Particularly, the surface layer and the intermediate layer preferably contain 0.001 to 3% by mass of Specific compound 1. If the surface layer and the intermediate layer contain 0.001 to 3% by mass of Specific compound 1, Specific compound 1 can be present at 0.002 to 0.5 g/m² on the surface of the surface layer to be in contact with a content.

In the non-stretched film, the ratio of the thicknesses of the surface layer, the intermediate layer, and the rear surface layer is preferably 10/80/10 to 40/20/40, more preferably 20/60/20 to 35/30/35. If the thickness proportion of the surface layer is 10% or more with respect to the total thickness of these layers, sufficient heat seal strength can be attained in a single package. Bleed out of Specific compound 1 to the surface of the surface layer can be readily caused to keep stable antibacterial characteristics.

The total thickness of the freshness-retentive film is preferably 15 to 120 μm, more preferably 20 to 100 μm. If the freshness-retentive film is a multi-layer film composed of three or more layers, the ratio of the thicknesses of the surface layer, the intermediate layer, and the rear surface layer within the range above can attain a freshness-retentive film having heat sealing characteristics, rigidity, and heat resistance in a good balance.

If the freshness-retentive film is a film composed of two or more layers and contains Specific compound 1 in a part of the layers, Specific compound 1 may be compounded directly in the material for the respective layers. Preferably, a composition containing large amounts of Specific compound 1 and other additives (masterbatch) is prepared, and is mixed with an ethylene-based polymer such that the final amount of Specific compound 1 compounded in the freshness-retentive film falls within a desired range. The mixture is placed in an extruder, and a part of the layers is formed.

### <Packaging Material>

The packaging material according to the present invention includes the freshness-retentive film according to the present invention. The packaging material according to the present invention may be composed of the freshness-retentive film according to the present invention. For example, the packaging material according to the present invention can be produced as follows: the freshness-retentive film is folded into two with the surface layer thereof facing inward, and both ends of the film are sealed by heat sealing or melt-cut sealing. Alternatively, the packaging material according to the present invention can be produced as follows: two freshness-retentive films are layered with their surface layers facing each other, and three sides of the laminate are sealed by heat sealing or melt-cut sealing. The rear surface layer of the packaging material can be optionally printed before formation of the packaging material.

### Other Preferred Embodiments

At least one surface of the freshness-retentive film according to the present invention preferably has a wetting index of 35 dyn or more to enhance the antibacterial characteristics of the film. The wetting index is more preferably 36 dyn or more, still more preferably 37 dyn or more, particularly preferably 38 dyn or more. The upper limit of the wetting index is not limited in particular, and can be 50 dyn or less, for example. The surface of the surface layer of the freshness-retentive film to be in contact with a content preferably has a wetting index of 35 dyn or more. The wetting index indicates a value determined through a mixed solution for a wet tension test manufactured by Wako Pure Chemical Industries, Ltd. The surface of the freshness-retentive film is preferably subjected to a corona treatment to have a wetting index of 35 dyn or more.

Preferably, the freshness-retentive film according to the present invention further contains at least one of myristyldiethanolamine monostearate and stearyldiethanolamine monostearate because the bleed out of Specific compound 1 can be promoted and the amount of Specific compound 1 in the film can be reduced. The amount of the at least one of myristyldiethanolamine monostearate and stearyldiethanolamine monostearate contained in the freshness-retentive film is preferably 0.001 to 1% by mass, more preferably 0.002 to 0.1% by mass.

Furthermore, the freshness-retentive film according to the present invention preferably contains at least one selected form the group consisting of glycerol monostearate (C18 MG), glycerol monopalmitate (C16 MG), and diglycerol monopalmitate (C16 DG) to promote the bleed out of Specific compound 1. In particular, the freshness-retentive film according to the present invention more preferably contains C16 DG in view of molding characteristics. The at least one selected from the group consisting of C18 MG, C16 MG, and C16 DG is preferably used in combination with at least one of the myristyldiethanolamine monostearate and the stearyldiethanolamine monostearate. The amount of the at least one selected from the group consisting of C18 MG, C16 MG, and C16 DG contained in the freshness-retentive film is preferably 0.01 to 1.0% by mass, more preferably 0.03 to 0.80% by mass, still more preferably 0.05 to 0.80% by mass, particularly preferably 0.05 to 0.50% by mass. The amount of the at least one selected from the group consisting of C18 MG, C16 MG, and C16 DG present on at least one surface of the freshness-retentive film is preferably 0.01 to 1.0 g/m², more preferably 0.03 to 0.80 g/m², still more preferably 0.05 to 0.80% by mass, particularly preferably 0.05 to 0.50% by mass. The amount present on the surface of the film indicates a value determined by the same method as the method of determining the amount of Specific compound 1 on the surface of the film.

In the freshness-retentive film composed of two or more layers, at least one of myristyldiethanolamine monostearate and stearyldiethanolamine monostearate may be contained in any of the layers, and is preferably contained at least in the same layer as that containing Specific compound 1. Namely, if Specific compound 1 is contained in an intermediate layer, at least one of myristyldiethanolamine monostearate and stearyldiethanolamine monostearate is preferably contained in the intermediate layer. If Specific compound 1 is contained in the surface layer, at least one of myristyldiethanolamine monostearate and stearyldiethanolamine monostearate is preferably contained in the surface layer. At least one of myristyldiethanolamine monostearate and stearyldiethanolamine monostearate can be compounded in each of the layers by the same method as that of compounding Specific compound 1 in each of the layers.

In the freshness-retentive film according to the present invention, Specific compound 1 is preferably contained in a region in a thickness-wise direction from a surface of the film to be in contact with a content, the region ranging from 50 to 90% of the overall thickness of the film. Namely, if the overall thickness of the film is 100%, the surface of the film to be in contact with a packaged object or content is defined as a position of 0%, and the opposite surface of the film remote from the surface to be in contact with the content is defined as a position of 100%, Specific compound 1 is preferably contained in a region ranging from 50 to 90%. Specific compound 1 contained in this region can appropriately bleed out to the surface of the film to be in contact with the content, thereby demonstrating the antibacterial characteristics and, in turn, the freshness retentiveness of the film. The region more preferably ranges from 65 to 90%, still more preferably 80 to 90%. Examples of the method of containing Specific compound 1 in this region include a method of preparing a freshness-retentive film according to the present invention having a three-layer structure and containing Specific compound 1 in the intermediate layer. Examples thereof also include a method of containing Specific compound 1 in the intermediate layer and one of the surface layer and the rear surface layer. Preferably, Specific compound 1 is contained in the intermediate layer and surface layer to effectively demonstrate the antibacterial characteristics and the freshness retentiveness of the film by smooth bleed out of Specific compound 1. Specific compound 1 may be contained only in this region, or may be contained in a region other than this region. Preferably, this region further contains at least one of myristyldiethanolamine monostearate and stearyldiethanolamine monostearate. In the freshness-retentive film, the surface of the film to be in contact with a content can be determined from whether 0.002 to 0.5 g/m² of Specific compound 1 is present on the surface thereof.

Preferably, the freshness-retentive film according to the present invention is composed of two or more layers, and contains Specific compound 1 only in the layer having a surface to be in contact with a content. Namely, Specific compound 1 is preferably contained only in the surface layer to be in direct contact with a content. If Specific compound 1 is contained only in the surface layer, bleed out of a predetermined amount of Specific compound 1 to the surface of the film to be in contact with a content can be readily caused, so that the antibacterial characteristics of the film are enhanced and the total content of Specific compound 1 contained in the film can be reduced. If Specific compound 1 is applied onto the surface of the surface layer, this case is also included in the case where Specific compound 1 is contained only in the surface layer.

Preferably, the freshness-retentive film according to the present invention contains an ethylene-based polymer, and the density of the ethylene-based polymer increases in a thickness-wise direction from the surface of the film to be in contact with a content. Namely, in the freshness-retentive film containing an ethylene-based polymer, the resin density of the ethylene-based polymer preferably increases from the surface of the film to be in contact with a content toward the surface opposite to the surface of the film to be in contact with a content. Such gradient of the resin density readily causes the bleed out of Specific compound 1 present in the freshness-retentive film to the surface of the film to be in contact with a content. Moreover, the amount of Specific compound 1 present on the surface to be in contact with a content can fall within the range specified in the present invention even if the content of Specific compound 1 in the freshness-retentive film is reduced, attaining high antibacterial characteristics. The density of the ethylene-based polymer may continuously increase, or may increase stepwise in the thickness-wise direction. For example, in the freshness-retentive film composed of three layers, the densities of the ethylene-based polymer contained in the intermediate layer and the rear surface layer are preferably higher than the density of the ethylene-based polymer contained in the surface layer. Alternatively, the density of the ethylene-based polymer contained in the rear surface layer may be higher than the densities of the ethylene-based polymer contained in the surface layer and the intermediate layer. Alternatively, the density of the ethylene-based polymer contained in the layers may increase from the surface layer through the intermediate layer to the rear surface layer in this order. Preferably, at least, the density of the ethylene-based polymer contained in the intermediate layer is higher than the density of the ethylene-based polymer contained in the surface layer.

### Second Embodiment

The freshness-retentive film according to the present invention contains palmityldiethanolamine and/or stearyldiethanolamine on the surface thereof at 0.002 to 0.5 g/m². If palmityldiethanolamine and/or stearyldiethanolamine is present on the surface of the film at 0.002 to 0.5 g/m², high antibacterial characteristics are attained. The surface of the film is preferably a surface to be in contact with a content. The freshness-retentive film according to the present invention has not only an antibacterial effect and high freshness retentiveness, but also has high transparency. Moreover, freshness-retentive film according to the present invention has high molding characteristics because antibacterial components barely scatter during molding of the film. The freshness-retentive film preferably contains 0.01 to 3% by mass of palmityldiethanolamine and/or stearyldiethanolamine of the overall film. The freshness-retentive film preferably has a haze of below 10%. Preferably, the number of surviving bacterial cells on at least one surface of the freshness-retentive film is 1/100 times or less after 24 hours after the freshness-retentive film is subjected to the antibacterial test according to JIS Z2801 using E. coli under a condition where the surface of the freshness-retentive film is not wiped with alcohol to keep the state of the surface of the freshness-retentive film. If the surface of the freshness-retentive film having the number of surviving bacterial cells of 1/100 times or less is used as a surface to be in contact with a content, the effect of retaining the freshness of the content can be attained. The packaging material according to the present invention includes the freshness-retentive film according to the present invention.

The freshness-retentive film according to the present invention has high antibacterial characteristics. A content can be packaged in the packaging material according to the present invention while the safety of the content is kept. Examples of contents to be packaged include fruit and vegetables, flowers and ornamental plants, and animal-derived foodstuff such as meat and fresh fish. The freshness of these products can be retained for a relatively long time. Particularly, the freshness-retentive film and the packaging material according to the present invention are suitable for packaging of half-prepared or prepared fresh food products such as cut vegetables, and can prevent proliferation of bacteria.

The resin material for the freshness-retentive film according to the present invention is preferably thermoplastic resins, and more preferably at least one of propylene-based polymers and ethylene-based polymers. The same thermoplastic resins, propylene-based polymers, and ethylene-based polymer as those exemplified in First Embodiment can be used.

<Stearyldiethanolamine and/or Palmityldiethanolamine>

In the present invention, high freshness retentiveness is demonstrated by stearyldiethanolamine and/or palmityldiethanolamine present on the surface of the film at 0.002 to 0.5 g/m². If the amount of the compound present on the surface of the film is less than 0.002 g/m², an effect of preventing proliferation of E. coli after 24 hours is insufficient. If the amount of the compound present on the surface of the film is more than 0.5 g/m², the surface of the film becomes sticky and has a haze of more than 10%, which are not desirable as a packaging film. The amount of palmityldiethanolamine and/or stearyldiethanolamine present on the surface of the film is preferably 0.004 to 0.3 g/m², more preferably 0.007 to 0.1 g/m², still more preferably 0.01 to 0.03 g/m². The amount of palmityldiethanolamine and/or stearyldiethanolamine present on the surface of the film indicates a value determined by the method described in First Embodiment.

As described above, stearyldiethanolamine and palmityldiethanolamine have melting points relatively higher than those of myristyldiethanolamine and lauryldiethanolamine, and are not likely to relatively volatilize during melt molding of the film. In addition, stearyldiethanolamine and palmityldiethanolamine are likely to relatively slowly migrate to a content in a packaging material including a freshness-retentive film containing stearyldiethanolamine or palmityldiethanolamine, and have high safety. Furthermore, in aspects in which stearyldiethanolamine and/or palmityldiethanolamine is compounded in a film, the migration of stearyldiethanolamine and palmityldiethanolamine in the film is controlled more readily than that of myristyldiethanolamine and lauryldiethanolamine, so that the freshness-retentive performance of the film can be continued.

In aspects in which palmityldiethanolamine and/or stearyldiethanolamine is compounded in a film, the content of palmityldiethanolamine and/or stearyldiethanolamine in the film is preferably 0.001 to 3% by mass, more preferably 0.01 to 3% by mass, still more preferably 0.05 to 2% by mass, particularly preferably 0.1 to 0.5% by mass. At a content of 0.001% by mass or more, an effect of preventing proliferation of E. coli and Staphylococcus aureus after 24 hours is attained, and the freshness-retentive effect is high. At a content of 3% by mass or less, the film has no sticky surface and is readily handled. The film has a haze 10% or less, and therefore is suitable for a packaging film.

The other additives exemplified in First Embodiment can optionally be applied onto or compounded in the freshness-retentive film according to the present invention as long as the film has the freshness-retentive performance.

### <Freshness-Retentive Film Containing Propylene-Based Polymer>

Examples of the freshness-retentive film containing a propylene-based polymer include single-layer films and multi-layer films composed of two or more layers. The freshness-retentive film is preferably a stretched film stretched at least in one axial direction, which is suitable for a packaging film. The stretching ratio in the one axial direction is preferably 2 to 15. Among these stretched films, biaxially stretched films are more preferred because these films have high transparency. Biaxial stretching may be successive biaxial stretching or simultaneous biaxial stretching. The stretching ratio is preferably 2 to 15 in both longitudinal and lateral directions. A biaxially stretched film is preferably produced by a method of stretching the film 5 to 8 times in the longitudinal direction, and successively stretching the film 8 to 10 times in the lateral direction with a center mechanism to control the final thickness of the film to be 15 to 50 μm, preferably 20 to 40 μm. A thickness of 15 μm or more enhances rigidity to readily keep the shape of the bag formed of the freshness-retentive film, and enhances handling characteristics and pierce strength. A thickness of 50 μm or less enhances productivity and reduces cost. In a preferred method, the film is stretched 5 to 10 times (planar stretching ratio of 25 to 100) in the longitudinal direction and in the lateral direction.

The freshness-retentive film containing a propylene-based polymer is preferably a multi-layer film composed of at least three layers of a surface layer, an intermediate layer, and a rear surface layer. In this case, the amount of palmityldiethanolamine and/or stearyldiethanolamine compounded in the intermediate layer is preferably 0.01 to 3% by mass, more preferably 0.01 to 1% by mass, still more preferably 0.03 to 0.9% by mass, particularly preferably 0.04 to 0.6% by mass. In this aspect, the amount of palmityldiethanolamine and/or stearyldiethanolamine compounded in the overall multi-layer film is preferably 0.01 to 3% by mass, more preferably 0.01 to 1% by mass, still more preferably 0.03 to 0.9% by mass, particularly preferably 0.04 to 0.6% by mass. Palmityldiethanolamine and/or stearyldiethanolamine may be compounded only in one layer of the surface layer, the intermediate layer, and the rear surface layer, may be compounded only in the intermediate layer and the surface layer, or may be compounded in the intermediate layer, the surface layer, and the rear surface layer.

If the freshness-retentive film is a multi-layer film composed of three or more layers, the ratio of the thicknesses of the rear surface layer, the intermediate layer, and the surface layer is preferably 3/94/3 to 10/80/10, more preferably 4/92/4 to 8/84/4. If the thickness proportions of the rear surface layer and the surface layer each are 10% or less with respect to the total thickness of these layers, palmityldiethanolamine and/or stearyldiethanolamine in the intermediate layer can be migrated toward the surface of the film to keep the amount of palmityldiethanolamine and/or stearyldiethanolamine present on the surface of the film in an appropriate range. Thereby, sufficient antibacterial activity is demonstrated. According to this aspect, even if palmityldiethanolamine and/or stearyldiethanolamine is not positively compounded in the surface layer or the rear surface layer, the amount of palmityldiethanolamine and/or stearyldiethanolamine present on the surface of the film can be controlled to be 0.002 to 0.5 g/m² through migration of palmityldiethanolamine and/or stearyldiethanolamine from the intermediate layer toward the surface of the film over time. The freshness-retentive film can have the same thickness as that of the film in First Embodiment. In this aspect, preferred conditions on biaxial stretching are a temperature of 90 to 140° C. and a stretching ratio of 4 to 6 in longitudinal stretching, and a temperature of 140 to 200° C. and a stretching ratio of 8 to 12 in lateral stretching. After stretching, the film is preferably heat set to stabilize mechanical physical characteristics. Heat setting is performed preferably at 160° C. or more for 5 seconds or more, more preferably at 160 to 220° C. for 5 to 10 seconds.

In another aspect, palmityldiethanolamine and/or stearyldiethanolamine may be applied onto the surface of the biaxially stretched film at 0.002 to 0.5 g/m².

In an aspect of a multi-layer film containing a propylene-based polymer, the propylene-based polymer of the intermediate layer preferably has a melting point (Tm) of 155 to 170° C. The propylene-based polymer of the surface layer and rear surface layer has a melting point (Tm) of preferably 125° C. or more and less than 155° C., more preferably 130 to 145° C. Among these propylene-based polymers, particularly propylene-α-olefin random copolymers are preferred because multi-layer films having high heat sealing characteristics are attained using these copolymers. Thereby, a multi-layer film having heat sealing characteristics, rigidity, and heat resistance in a good balance and high freshness-retentive performance is attained.

In an aspect of the biaxially stretched multi-layer film in which palmityldiethanolamine and/or stearyldiethanolamine is compounded in the intermediate layer, palmityldiethanolamine and/or stearyldiethanolamine may be preliminarily compounded in the material for an intermediate layer. Preferably, a composition containing large amounts of palmityldiethanolamine and/or stearyldiethanolamine and other additives (masterbatch) is prepared, and is mixed with the propylene-based polymer such that the final amount of palmityldiethanolamine and/or stearyldiethanolamine compounded falls within a desired range. The mixture is placed in an extruder to form an intermediate layer.

### <Freshness-Retentive Film Containing Ethylene-Based Polymer>

The freshness-retentive film containing an ethylene-based polymer may be a single-layer film or a multi-layer film composed of two or more layers. The freshness-retentive film can be a stretched film stretched in at least one axial direction suitable for a packaging film. The stretching ratio in one axial direction is preferably 2 to 15. In the biaxially stretched film, planar stretching ratio is preferably 25 to 100.

In an aspect in which palmityldiethanolamine and/or stearyldiethanolamine is compounded in the film, the amount compounded is preferably 0.01 to 3% by mass, more preferably 0.01 to 1% by mass. Alternatively, palmityldiethanolamine and/or stearyldiethanolamine may be applied onto the surface of the film so that palmityldiethanolamine and/or stearyldiethanolamine is present on the surface of the film at 0.002 to 0.5 g/m².

If the freshness-retentive film is a multi-layer film, a three-layer film composed of a surface layer, an intermediate layer, and a rear surface layer can be cast molded through co-extrusion with a multi-layer extruder, for example. In this case, palmityldiethanolamine and/or stearyldiethanolamine can be compounded only in the surface layer requiring freshness-retentive function. An anti-blocking agent can be compounded only in the rear surface layer to be, for example, printed. Because compounding of these compounds in the intermediate layer constituting most of the film is not necessary, the method above is preferable in view of production efficiency and economy. If the freshness-retentive film is a three-layer film, the ratio of the thicknesses of the respective layers and the total thickness of the film can be the same as those in First Embodiment.

In an aspect of the freshness-retentive film in which the film is a multi-layer film and palmityldiethanolamine and/or stearyldiethanolamine is compounded in the surface layer to be in contact with a content, palmityldiethanolamine and/or stearyldiethanolamine may be preliminarily compounded in an ethylene-based polymer. Preferably, a composition containing large amounts of palmityldiethanolamine and/or stearyldiethanolamine and other additives (masterbatch) is prepared, and is mixed with the ethylene-based polymer such that the final amount of palmityldiethanolamine and/or stearyldiethanolamine compounded falls within a desired range. The mixture is placed in an extruder to form a surface layer.

### <Packaging Material>

The packaging material according to the present invention includes the freshness-retentive film according to the present invention. The packaging material according to the present invention is, for example, a packaging material such as bags and packaging wrapping films composed of the freshness-retentive film according to the present invention. The packaging material is produced by the same method as in First Embodiment. In addition, the packaging material can be partially perforated, or be opened at the upper portion thereof to prevent generation of anaerobic bacteria and thus prevent stagnation of a foul odor inside the packaged material. Furthermore, the concentrations of oxygen and carbon dioxide can be controlled, or another gas can be used in packaging.

Particularly in the packaging material such as bags composed of the stretched film, the rear surface layer thereof may be optionally printed before production of the film. In the packaging material such as bags composed of a non-stretched film, for example, the non-stretched film may be optionally bonded to a stretched film, and may be used as the inner surface of the laminate film to be in contact with a content.

The packaging material is suitable for applications to freshness-retentive packaging of sterilized cut vegetables, half-prepared or prepared food materials, and the like, which requires severe retention of freshness, and can effectively prevent proliferation of bacteria. Examples of contents to be packaged include fruit and vegetables, flowers and ornamental plants, and animal-derived foodstuff such as meat and fresh fish. The packaging material can retain the freshness of these contents for a relatively long time. Particularly, the packaging material is suitable for packaging of half-prepared or prepared fresh food products such as cut vegetables, and can sufficiently prevent proliferation of bacteria.

Particularly a demand has been growing for a packaging material composed of a freshness-retentive film which can be used to package cabbage, lettuce, or the like after being cut into strips of about 2 to 10 mm, and sterilizing common bacteria to be sold in supermarkets and the like or distributed from distribution centers to their restaurant chains for increasing cooking efficiency. The so-called packaged cut vegetables should be prevented from being contaminated by invasion of bacteria into sterilized contents or by proliferation of bacteria in nutrient fluids eluted from the contents to adhere to inner surfaces of the packaging materials. For this reason, a packaging material composed of a freshness-retentive film which has antibacterial characteristics and barely allows migration of antibacterial components to the contents has been required in particular. To meet these demands, however, significantly severer and safer antibacterial activity than those in the conventional films are necessary. In contrast, the freshness-retentive film according to the present invention can meet these demands and demonstrate high freshness-retentive performance because a specific compound is present on the surface of the film in a specific proportion.

Furthermore, in the freshness-retentive film according to the present invention in which the specific compound is present in the specific proportion, smoking by vaporization or bleed out of the compound to the surface of the film after molding is appropriately controlled during melt molding. For this reason, the specific compound of the packaging material is prevented from migrating to a content, therefore not affecting the taste of the content.

### Third Embodiment

In the freshness-retentive film according to the present invention, 0.01 to 1.0% by mass of alkyldiethanolamine and 0.01 to 1.0% by mass of diglycerol monopalmitate and/or diglycerol monomyristate (0.01 to 1.0% by mass of diglycerol monopalmitate and diglycerol monomyristate in total if diglycerol monopalmitate and diglycerol monomyristate both are contained) are contained in the overall film including its surface. Throughout the specification, the term “the overall film including its surface” indicates “the total amount contained on the surface and in regions other than the surface of freshness-retentive film according to the present invention.” If diglycerol monopalmitate and/or diglycerol monomyristate together with alkyldiethanolamine is contained in the film, alkyldiethanolamine having antibacterial characteristics can bleed out onto the surface of the film with diglycerol monopalmitate and/or diglycerol monomyristate to attain a surface of the freshness-retentive film according to the present invention having antibacterial characteristics and simultaneously anti-fogging characteristics and antistatic characteristics. Furthermore, the freshness-retentive film according to the present invention has stably and highly reproductive antibacterial characteristics at a temperature ranging from 25 to 40° C., in particular, at which bacteria readily proliferate.

The alkyldiethanolamine is preferably present on the surface of the freshness-retentive film at 0.002 to 0.5 g/m². Throughout the specification, the term “on the surface” indicates “on at least one surface of the freshness-retentive film according to the present invention.” The surface is preferably a surface to be in contact with a content. If the amount of alkyldiethanolamine on the surface is within this range, the film can have sufficient antibacterial characteristics to attain an effect of retaining the freshness of a packaged object which is content such as fresh food products.

Examples of the alkyldiethanolamine include capryldiethanolamine, lauryldiethanolamine, palmityldiethanolamine, and stearyldiethanolamine. Palmityldiethanolamine and/or stearyldiethanolamine is preferred. If at least one of palmityldiethanolamine and stearyldiethanolamine is used as alkyldiethanolamine, volatilization during molding of the stretched film is small, and high molding characteristics and high antibacterial activity can be demonstrated.

The packaging material according to the present invention is composed of the freshness-retentive film according to the present invention. To keep the freshness of fresh food products such as cut vegetables, flowers and ornamental plants, and the like, which is difficult to keep, the fresh food products as packaged objects can be wrapped in packaging materials composed of the freshness-retentive film to keep the freshness of the packaged objects for a long time. Particularly, the packaging material according to the present invention shows stable and highly reproductive antibacterial characteristics even at a storage temperature ranging from 25 to 40° C., and can effectively prevent proliferation of bacteria and effectively retain the freshness of the packaged objects. Particularly, the packaging material according to the present invention is suitable for cut vegetables, which are packaged after sterilization, in view of prevention of reproliferation of bacteria.

For the resin material for the freshness-retentive film according to the present invention, thermoplastic resins are preferable, and at least one of propylene-based polymers and ethylene-based polymers is more preferable. The same thermoplastic resins, propylene-based polymers, and ethylene-based polymers as those exemplified in First Embodiment can be used. The freshness-retentive film can optionally contain the other additives exemplified in First Embodiment.

### <Diglycerol Fatty Acid Ester>

Diglycerol fatty acid ester is prepared through dehydration condensation of diglycerol and fatty acid. Preferably, the reaction mixture is distilled in high vacuum to efficiently extract the monoester and thus increase the content of monofatty acid ester to 80% by mass or more. The diglycerol fatty acid ester has a structure represented by Formula (1) and composed of a linear C3 hydrocarbon having one ester bond to a fatty acid and a linear C3 hydrocarbon having three OH groups bonded thereto:

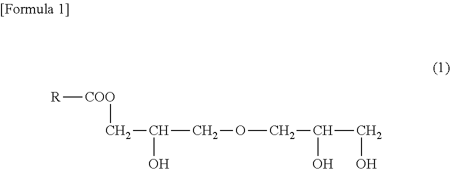

For this reason, diglycerol fatty acid ester has a volatilizing temperature higher than that of glycerol fatty acid ester described later, and causes less smoke during production of a biaxially stretched polypropylene film, particularly during processing with a tenter. In addition, diglycerol fatty acid ester, which has a low melting point, readily bleeds out to the surface of the film together with palmityldiethanolamine and/or stearyldiethanolamine. Specific examples of R in Formula (1) include a capryl group, a lauryl group, a palmityl group, a stearyl group, an oleyl group, a 12-hydroxystearyl group, and a behenyl group. In the present invention, diglycerol monopalmitate and/or diglycerol monomyristate can be preferably used to reduce volatility and attain antistatic characteristics, anti-fogging characteristics, and antibacterial characteristics.

### <Glycerol Fatty Acid Ester>

Glycerol fatty acid ester is prepared through dehydration condensation of glycerol and fatty acid. The glycerol fatty acid ester has a structure represented by Formula (2) and composed of a linear C3 hydrocarbon having one ester bond to a fatty acid and two OH groups bonded thereto:

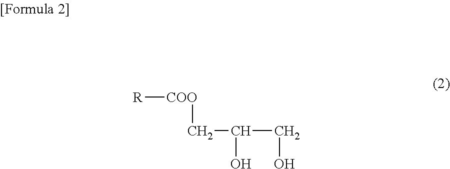

Specific examples of R in Formula (2) include a capryl group, a lauryl group, a palmityl group, a stearyl group, an oleyl group, a 12-hydroxystearyl group, and a behenyl group. The glycerol fatty acid ester, which has such a structure, has a volatilizing temperature lower than that of the diglycerol fatty acid ester above, and causes more smoke during production of a biaxially stretched polypropylene film, particularly during processing with a tenter. In addition, glycerol fatty acid ester, which has a high melting point, barely bleeds out to the surface of the film together with palmityldiethanolamine and/or stearyldiethanolamine.

### <Alkyldiethanolamine>

Alkyldiethanolamine is prepared through an addition reaction of alkylamine and ethylene oxide. Alkyldiethanolamine preferably has an alkyl group having 16 to 18 carbon atoms. Alkyldiethanolamine has a structure composed of alkylamine and two C2 hydrocarbons and two OH groups bonded to alkylamine, such as stearyldiethanolamine represented by Formula (3) below:

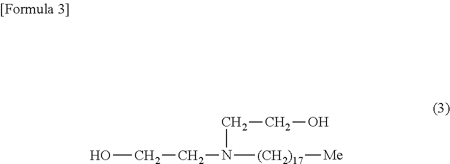

In the present invention, palmityldiethanolamine and stearyldiethanolamine having high antibacterial characteristics have 16 and 18 carbon atoms, respectively. Palmityldiethanolamine and stearyldiethanolamine have high melting points and boiling points, barely volatilize during molding, and barely migrate to packaged objects, compared to myristyldiethanolamine and lauryldiethanolamine. In addition, palmityldiethanolamine and stearyldiethanolamine have structures close to that of diglycerol fatty acid ester above. If palmityldiethanolamine and stearyldiethanolamine coexist with diglycerol fatty acid ester, these compounds can be miscible to bleed out to the surface of the film together. The amount of alkyldiethanolamine to be used has an upper limit in countries from a hygiene perspective. In the present invention, to effectively cause bleed out of the compounds to the surface of the film and attain the antistatic characteristics and the anti-fogging characteristics of the films with less amount, diglycerol monopalmitate and/or diglycerol monomyristate is compounded in the film.

At this time, even if crystalline alkyldiethanolamine is present on the surface of the film, the film can attain antistatic performance and anti-fogging characteristics. In general, food products are placed at a temperature of 5 to 40° C. This temperature is lower than the melting point (51° C.) of stearyldiethanolamine, and stearyldiethanolamine is crystalline.

However, the film does not attain antibacterial characteristics in some cases if alkyldiethanolamine remains crystalline. For example, in an antibacterial test according to JIS Z2801, a predetermined amount of Escherichia coli (E. coli) or the like is added to a 1/500 nutrient broth. The nutrient broth is dropped onto the surface of the film of a 4 cm square, and is covered with a polyethylene film. The sample is placed at 35° C. After 24 hours, the surface of the freshness-retentive film is washed to recover the nutrient broth. The number of bacterial cells is measured with a nutrient agar. In this test method, alkyldiethanolamine should be diffused in the nutrient broth (solution) in a concentration of 30 ppm or more.

At this time, because glycerol fatty acid ester has a higher melting point and a larger amount of heat of fusion than those of diglycerol fatty acid ester, glycerol fatty acid ester takes in alkyldiethanolamine to form crystals. In this case, these crystals do not readily dissolve out to inhibit the demonstration of the antibacterial characteristics of alkyldiethanolamine. For example, food products are generally placed at a temperature of 5 to 40° C. This temperature is lower than the melting point (73° C.) of glycerol monostearate, and a necessary amount of stearyldiethanolamine cannot be eluted even in contacting with the solution. Accordingly, diglycerol monopalmitate and/or diglycerol monomyristate, which has a melting point (43° C., 26° C., respectively) lower than the melting point (51° C.) of stearyldiethanolamine and a 10% volatilizing temperature higher than that of stearyldiethanolamine, can be used to attain sufficient antibacterial characteristics of the film.

### <Freshness-Retentive Film>

The freshness-retentive film according to the present invention is preferably composed of a single-layer film or a multi-layer film composed of two or more layers, both of which contain a propylene-based polymer or an ethylene-based polymer. In the freshness-retentive film according to the present invention, 0.01 to 1.0% by mass of alkyldiethanolamine and 0.01 to 1.0% by mass of diglycerol monopalmitate and/or diglycerol monomyristate are contained in the overall film including its surface. If alkyldiethanolamine, diglycerol monopalmitate, and diglycerol monomyristate are thus contained, appropriate amounts of these components contained bleed out to attain a highly transparent film which is not sticky. In addition, if the film is used as a packaging material, these components barely migrate to packaged objects, and do not affect the tastes of food products as packaged objects in particular. A freshness-retentive film having high antibacterial characteristics, anti-fogging characteristics, and antistatic characteristics is attained. Furthermore, the packaging material can be partially perforated, or be opened at the upper portion thereof to prevent generation of anaerobic bacteria and thus prevent stagnation of a foul odor inside the packaged object.

In the freshness-retentive film according to the present invention, because alkyldiethanolamine together with diglycerol monopalmitate and diglycerol monomyristate bleeds out to the surface of the film over time, the contents of the respective components in the film change. The contents of alkyldiethanolamine, diglycerol monopalmitate, and diglycerol monomyristate present on the surface of the freshness-retentive film according to the present invention are determined by the following method: the surface of the film is washed with dichloromethane. The washing liquid is recovered, and is condensed. A predetermined volume thereof is extracted, is silylated, and is measured with a gas chromatograph mass spectrometer (GC/MS). The content of alkyldiethanolamine in the film is 0.01 to 1.0% by mass, preferably 0.03 to 0.80% by mass, more preferably 0.05 to 0.80% by mass because contamination of an apparatus or the like used in molding and an excess bleed out to the surface of the film can be prevented and bleed out of alkyldiethanolamine to the surface of the film can be caused to attain necessary and sufficient antibacterial characteristics. A content of less than 0.01% by mass cannot attain sufficient antibacterial characteristics of the film. A content of more than 1.0% by mass may cause alkyldiethanolamine to adhere to a packaged object in formation of a packaging material.

Furthermore, to cause bleed out of alkyldiethanolamine more smoothly, the freshness-retentive film may contain at least one of glycerol monopalmitate and glycerol monostearate. However, large amounts of glycerol monopalmitate and glycerol monostearate contained in the film may reduce or inhibit the antibacterial characteristics of alkyldiethanolamine. Accordingly, glycerol monopalmitate and/or glycerol monostearate is preferably contained in an amount of less than 20 parts by mass relative to 100 parts by mass of the content of diglycerol monopalmitate and/or diglycerol monomyristate.

The amount of alkyldiethanolamine present on the surface of the freshness-retentive film is preferably 0.002 to 0.5 g/m², more preferably 0.003 to 0.1 g/m², still more preferably 0.003 to 0.05 g/m², particularly preferably 0.003 to 0.01 g/m² to effectively attain antibacterial characteristics. Furthermore, alkyldiethanolamine is preferably palmityldiethanolamine and/or stearyldiethanolamine. These compounds have smaller vapor pressure at high temperatures, and barely volatilize during molding, and have necessary and sufficient antibacterial activity. In addition, diglycerol monopalmitate and/or diglycerol monomyristate may be present on the surface of the freshness-retentive film. The total amount of these compounds present on the surface of the film is preferably 0.002 to 0.5 g/m², more preferably 0.003 to 0.1 g/m², still more preferably 0.003 to 0.05 g/m², particularly preferably 0.003 to 0.01 g/m². Furthermore, at least one of glycerol monopalmitate and glycerol monostearate may be present on the surface of the freshness-retentive film. The amount thereof is preferably less than 20 parts by mass relative to 100 parts by mass of the total amount of diglycerol monopalmitate and/or diglycerol monomyristate present on the surface of the film to effectively retain antibacterial characteristics of the film.

The content of diglycerol monopalmitate and/or diglycerol monomyristate in the film is 0.01 to 1.0% by mass, preferably 0.03 to 0.80% by mass, more preferably 0.05 to 0.80% by mass because contamination of an apparatus or the like used in molding and an excess bleed out to the surface of the film can be prevented, and such an amount of bleed out of alkyldiethanolamine to the surface of the film can be caused to attain necessary and sufficient antibacterial activity. A content of less than 0.01 by mass cannot cause sufficient bleed out of alkyldiethanolamine, reducing antibacterial characteristics. A content of more than 1.0% by mass may cause alkyldiethanolamine to adhere to a packaged object in formation of a packaging material.

### <Freshness-Retentive Film Containing Propylene-Based Polymer and its Production Method>

If the freshness-retentive film according to the present invention is formed of a propylene-based polymer, the freshness-retentive film is preferably a biaxially stretched multi-layer film composed of at least three layers of a rear surface layer, an intermediate layer, and a surface layer. One of the reasons is because such a configuration allows compounding of additives only in the intermediate layer during molding to avoid contamination of an apparatus put into contact with the rear surface layer and the surface layer, such as a roll. Another reason is because such a configuration can readily prepare a packaging material in which the melting point(s) of one or both of the rear surface layer and the surface layer can be reduced during processing of packaging bags. The intermediate layer contains alkyldiethanolamine (especially palmityldiethanolamine and/or stearyldiethanolamine) in an amount of preferably 0.01 to 1.0% by mass, more preferably 0.02 to 0.80% by mass, still more preferably 0.05 to 0.50% by mass of all of the layers including the surface of the film. The intermediate layer contains diglycerol monopalmitate and/or diglycerol monomyristate in an amount of preferably 0.01 to 1.0% by mass, more preferably 0.02 to 0.80% by mass, still more preferably 0.05 to 0.50% by mass of all of the layers including the surface of the film. If the intermediate layer contains glycerol monopalmitate and glycerol stearate, the content of glycerol monopalmitate and/or glycerol stearate is preferably less than 20 parts by mass, more preferably less than 10 parts by mass, still more preferably less than 5 parts by mass relative to 100 parts by mass of the content of diglycerol monopalmitate and/or diglycerol monomyristate.

If the amount of alkyldiethanolamine contained in the intermediate layer is within this range, the film attains an antibacterial effect, high transparency, and high molding characteristics because the antibacterial components barely scatter during molding of the film. Furthermore, the antibacterial components barely migrate to the contents in packaging, and do not affect the tastes or the like of packaged objects. If the amount of diglycerol monopalmitate and/or diglycerol monomyristate contained in the intermediate layer is within this range, the antibacterial component alkyldiethanolamine bleeds out to the surface of the film in an appropriate amount, so that the film is not sticky, and has high transparency and high molding characteristics because the components barely scatter during molding of the film. Furthermore, the components barely migrate to the contents in packaging, and do not affect the tastes or the like of packaged objects.

If the freshness-retentive film according to the present invention is a biaxially stretched film composed of a rear surface layer, an intermediate layer, and a surface layer and containing a propylene-based polymer, alkyldiethanolamine is present on the surface of the surface layer to be in contact with a content at preferably 0.002 to 0.5 g/m², more preferably 0.003 to 0.1 g/m², still more preferably 0.003 to 0.05 g/m², particularly preferably 0.004 to 0.03 g/m². In addition, diglycerol monopalmitate and/or diglycerol monomyristate is present at preferably 0.002 to 0.5 g/m², more preferably 0.003 to 0.1 g/m², still more preferably 0.003 to 0.05 g/m², particularly preferably 0.004 to 0.03 g/m². If at least one of glycerol monopalmitate and glycerol monostearate is present, the amount of glycerol monopalmitate and glycerol monostearate present on the surface of the surface layer is preferably less than 20 parts by mass relative to 100 parts by mass of the amount of diglycerol monopalmitate and/or diglycerol monomyristate.

If the freshness-retentive film containing a propylene-based polymer is composed of three layers, the ratio of the thicknesses of the respective layers can be the same as that in First Embodiment. The thickness of the freshness-retentive film can be the same as that in First Embodiment. A biaxially stretched film containing a propylene-based polymer can be prepared by the same method as the method described in Second Embodiment.

If the intermediate layer contains a desired amount of alkyldiethanolamine and a desired amount of diglycerol monopalmitate and/or diglycerol monomyristate, these compounds may be preliminarily compounded in the material for an intermediate layer. Preferably in view of production efficiency, a composition containing large amounts of alkyldiethanolamine and diglycerol monopalmitate and/or diglycerol monomyristate (masterbatch) is prepared, and is mixed with the propylene-based polymer such that the final amounts of alkyldiethanolamine and diglycerol monopalmitate and/or diglycerol monomyristate fall within predetermined ranges. The mixture is placed in an extruder to form an intermediate layer.

### <Freshness-Retentive Film Containing Ethylene-Based Polymer and its Production Method>

If the freshness-retentive film according to the present invention is formed of an ethylene-based polymer, the film is preferably composed of two or more layers and contains alkyldiethanolamine (especially, palmityldiethanolamine and/or stearyldiethanolamine) and diglycerol monopalmitate and/or diglycerol monomyristate in the surface layer to be in contact with a content. The content of alkyldiethanolamine in the film is 0.01 to 1.00% by mass, preferably 0.02 to 0.80% by mass, more preferably 0.05 to 0.50% by mass. The content of diglycerol monopalmitate and/or diglycerol monomyristate is 0.01 to 1.00% by mass, preferably 0.02 to 0.80% by mass, more preferably 0.05 to 0.50% by mass. If the film contains at least one of glycerol monopalmitate and glycerol monostearate, the total amount of glycerol monopalmitate and glycerol monostearate is preferably less than 20 parts by mass, more preferably less than 10 parts by mass, still more preferably less than 0.05 parts by mass relative to 100 parts by mass of the total amount of diglycerol monopalmitate and/or diglycerol monomyristate.

In the freshness-retentive film, alkyldiethanolamine is present on the surface of the film at preferably 0.002 to 0.5 g/m², more preferably 0.003 to 0.1 g/m², still more preferably 0.003 to 0.05 g/m², particularly preferably 0.004 to 0.03 g/m². In addition, diglycerol monopalmitate and/or diglycerol monomyristate is present at preferably 0.002 to 0.5 g/m², more preferably 0.003 to 0.1 g/m², still more preferably 0.003 to 0.05 g/m², particularly preferably 0.004 to 0.03 g/m². If at least one of glycerol monopalmitate and glycerol monostearate is present on the surface of the freshness-retentive film, the total amount of glycerol monopalmitate and glycerol monostearate present on the surface of the film is preferably less than 20 parts by mass relative to 100 parts by mass of the total amount of diglycerol monopalmitate and/or diglycerol monomyristate present on the surface of the film.

The freshness-retentive film may be composed of a single layer or a multi-layer of two or more layers. If the freshness-retentive film having three layers of a rear surface layer, an intermediate layer, and a surface layer is formed, cast molding, inflation molding, and the like can be used. Preferred is cast molding through co-extrusion of three layers with an extruder. In this case, a predetermined amount of alkyldiethanolamine and a predetermined amount of diglycerol monopalmitate and/or diglycerol monomyristate can be contained only in the surface layer requiring freshness-retentive function during cast molding. An anti-blocking agent can be compounded in the rear surface layer to be, for example, printed. Such cast molding does not need addition of additives in the intermediate layer constituting most of the film, and is preferable in view of production efficiency and economy. The ratio of the thicknesses of the respective layers and the thickness of the freshness-retentive film can be the same as those in First Embodiment.

If the surface layer contains alkyldiethanolamine and diglycerol monopalmitate and/or diglycerol monomyristate, a material for a surface layer may be prepared by preliminarily compounding an ethylene-based polymer containing a predetermined amount of alkyldiethanolamine and a predetermined amount of diglycerol monopalmitate and/or diglycerol monomyristate. Preferably, a masterbatch containing alkyldiethanolamine and diglycerol monopalmitate and/or diglycerol monomyristate is prepared, and is mixed with the ethylene-based polymer such that the final amounts of alkyldiethanolamine and diglycerol monopalmitate and/or diglycerol monomyristate fall within the predetermined ranges. The mixture is placed in an extruder to form a surface layer.

The packaging material according to the present invention can be produced in the same manner as in First Embodiment.

### Fourth Embodiment

The freshness-retentive film according to the present invention contains 50 to 95% by mass of a linear low density polyethylene (A) having a density of 0.85 to 0.95 g/cm³, and 5 to 50% by mass of a high pressure low density polyethylene (B) having a density of 0.91 to 0.93 g/cm³ where the total amount of the linear low density polyethylene (A) and the high pressure low density polyethylene (B) is 100% by mass. The film contains 0.5 to 10 parts by mass of an adhesive (C), 0.5 to 5 parts by mass of an antifog additive (D), and 0.001 to 3 parts by mass of at least one specific compound (E) selected from the group consisting of palmityldiethanolamine, stearyldiethanolamine, glycerol monolaurate, and glycerol monocaprate relative to 100 parts by mass of the total amount of the linear low density polyethylene (A) and the high pressure low density polyethylene (B). The specific compound (E) is present on at least one surface of the film at 0.002 to 0.5 g/m², preferably 0.005 to 0.1 g/m², more preferably 0.008 to 0.08 g/m², still more preferably 0.010 to 0.050 g/m². The freshness-retentive film can be a freshness-retentive stretched film. Preferably, the specific compound (E) can be present at least on the surface of the film to be in contact with a content at 0.002 to 0.5 g/m², preferably 0.005 to 0.1 g/m², more preferably 0.008 to 0.08 g/m², still more preferably 0.010 to 0.050 g/m². The number of surviving bacterial cells on at least one surface of the freshness-retentive film is preferably 1/100 times or less after 24 hours after the freshness-retentive film is subjected to the antibacterial test according to JIS Z2801 using E. coli under a condition where the surface of the freshness-retentive film is not wiped with alcohol to keep the state of the freshness-retentive film. The freshness-retentive film according to the present invention has antibacterial characteristics and anti-fogging characteristics derived from the specific compound (E) present on the surface of the film and has high freshness retentiveness attained by a synergistic effect of the antibacterial characteristics and the anti-fogging characteristics. The freshness-retentive film according to the present invention has adhesion derived from the adhesive (C) contained in the film, and can be suitably used to pack fresh food products and processed food products on trays. The freshness-retentive film according to the present invention shows stable and highly reproductive antibacterial characteristics at normal temperature ranging from 25 to 40° C., and has high freshness retentiveness of packaged objects.

### <Linear Low Density Polyethylene (A)>

The linear low density polyethylene (A) used in the present invention has a density of 0.85 to 0.95 g/cm³. The density is preferably 0.87 to 0.945 g/cm³, more preferably 0.89 to 0.94 g/cm³. Examples of the linear low density polyethylene (A) include ethylene-α-olefin copolymers having a degree of crystallization of 0 to 50% determined by X-ray diffraction. The degree of crystallization is preferably 5 to 45%, more preferably 10 to 40%. Preferably, the linear low density polyethylene (A) is composed of an ethylene unit as a main component. The linear low density polyethylene (A) contains preferably 80 to 99 mol %, more preferably 85 to 97 mol %, still more preferably 88 to 95 mol % of ethylene units. Examples of α-olefins copolymerized with ethylene include propylene, 1-butene, 1-pentene, 1-hexene, 1-heptene, 1-octene, 1-nonene, 1-decene, 3-methyl-1-butene, and 4-methyl-1-pentene. These α-olefin comonomers can be used singly, or two or more thereof can be used as in terpolymers.

The linear low density polyethylene (A) can be produced by copolymerization of ethylene and the α-olefin under a gaseous phase or a liquid phase in the presence of a transition metal catalyst. Examples of usable transition metal catalysts include Ziegler catalysts, Phillips catalysts, and metallocene-based catalysts. Metallocene-based catalysts are preferred in consideration of the balance among sealing characteristics, strength, elastic modulus, elongation, and the like at low temperatures. Any polymerization method can be used without limitation. Polymerization can be performed by polymerization methods such as gaseous phase polymerization, solution polymerization, and bulk polymerization.

Considering sealing characteristics, strength, elastic modulus, elongation characteristics, and the like of the resulting film at low temperatures, the linear low density polyethylene (A) has a melt flow rate (hereinafter described as MFR) at 190° C. and a load of 2.16 kg of preferably 0.1 to 10 g/10 min, more preferably 1 to 8 g/10 min, still more preferably 2 to 6 g/10 min.

If the total amount of the linear low density polyethylene (A) and the high pressure low density polyethylene (B) described later is 100% by mass, the content of the linear low density polyethylene (A) is 50 to 95% by mass, preferably 55 to 90% by mass, more preferably 60 to 85% by mass, still more preferably 70 to 80% by mass.

### <High Pressure Low Density Polyethylene (B)>

In the present invention, the high pressure low density polyethylene (B) is a low density polyethylene produced by high pressure radical polymerization and having many long-chain branches. The density is 0.91 to 0.93 g/cm³. The density is preferably 0.912 to 0.925 g/cm³, more preferably 0.914 to 0.920 g/cm³. Considering the molding characteristics of the film and the transparency, the flexibility, the elongation characteristics, and the like of the resulting film, the high pressure low density polyethylene (B) used in the present invention has an MFR at 190° C. and a load of 2.16 kg of preferably 0.01 to 100 g/10 min, more preferably 0.05 to 10 g/10 min, still more preferably 1 to 9 g/10 min, particularly preferably 4 to 8 g/10 min. Examples of commercially available products of the high pressure low density polyethylene (B) include a trade name MIRASON F212, 12, 11P, and 16P manufactured by Mitsui Chemicals, Inc.

The high pressure low density polyethylene (B) preferably has a swell ratio of 1.3 or more where the swell ratio indicates a degree of long-chain branches, that is, a ratio (Ds/D) of the diameter (Ds) of a strand, which is extruded at 190° C. and an extrusion rate of 10 mm/min from a nozzle of a capillary flow meter, to the nozzle inner diameter (D) where the nozzle has an inner diameter (D) of 2.0 mm and a length of 15 mm.

Alternatively, the high pressure low density polyethylene (B) may be a copolymer with a monomer other than ethylene in the range not impairing the intention of the present invention. For example, the high pressure low density polyethylene (B) may be a copolymer with 50 mol % or less, preferably 30 mol % or less, and more preferably 20 mol % or less of a polymerizable monomer such as other α-olefins, vinyl acetate, and acrylic acid esters.

The proportion of the high pressure low density polyethylene (B) contained in the freshness-retentive film affects the molding characteristics of the film and the transparency, the flexibility, and the like of the resulting film. If the total amount of the linear low density polyethylene (A) and the high pressure low density polyethylene (B) is 100% by mass, the content of the linear low density polyethylene (B) is 5 to 50% by mass, preferably 10 to 45% by mass, more preferably 15 to 40% by mass, still more preferably 20 to 30% by mass. At a content of less than 5% by mass, the film has low molding characteristics. At a content of more than 50% by mass, the film has low transparency and flexibility.

### <Adhesive (C)>

Examples of the adhesive (C) used in the present invention include aliphatic hydrocarbon resins, aromatic hydrocarbon resins, aliphatic and aromatic copolymerization hydrocarbon resins, dicyclopentadiene hydrocarbon resins, hydrogenated aliphatic hydrocarbon resins, hydrogenated aromatic hydrocarbon resins, hydrogenated aliphatic and aromatic copolymerization hydrocarbon resins, hydrogenated dicyclopentadiene hydrocarbon resins, synthetic terpene-based hydrocarbon resins, terpene-based hydrocarbon resins, hydrogenated terpene-based hydrocarbon resins, coumarone indene-based hydrocarbon resins, low molecular weight styrene-based resins, and rosin-based hydrocarbon resins. These resins may be used singly or in the form of a mixture of two or more of the resins. Examples of the adhesive (C) specifically include aliphatic hydrocarbon resins containing the C4 fraction and the C5 fraction produced by cracking of petroleum or naphtha, mixtures thereof, or any fraction thereof such as isoprene and 1,3-pentadiene in the C5 fraction as a main raw material; aromatic hydrocarbon resins containing styrene derivatives and indenes in the C9 fraction produced by cracking of petroleum or naphtha as a main raw material; aliphatic and aromatic copolymerization hydrocarbon resins prepared by copolymerization of any fraction of the C4 fraction and the C5 fraction with the C9 fraction; dicyclopentadiene-based hydrocarbon resins prepared with dimers as a main raw material which are prepared with cyclopentadiene contained in the C5 fraction prepared by cracking of petroleum or naphtha as a raw material; hydrogenated aliphatic hydrocarbon resins prepared by hydrogenating aliphatic hydrocarbon resins; hydrogenated aromatic hydrocarbon resins prepared by hydrogenating aromatic hydrocarbon resins; hydrogenated aliphatic and aromatic copolymerization hydrocarbon resins prepared by hydrogenating aliphatic and aromatic copolymerization hydrocarbon resins; hydrogenated dicyclopentadiene-based hydrocarbon resins prepared by hydrogenating dicyclopentadiene-based resins; synthetic terpene-based hydrocarbon resins having structures including aliphatic, alicyclic, and aromatic hydrocarbon resins; terpene-based hydrocarbon resins prepared with α, β-pinene in turpentine as a raw material; hydrogenated terpene-based hydrocarbon resins prepared by hydrogenating terpene-based hydrocarbon resins; coumarone indene-based hydrocarbon resins prepared with indenes and styrenes in coal tar naphtha as a raw material; low molecular weight styrene-based resins; and rosin-based hydrocarbon resins.

Examples of commercially available products of the aliphatic hydrocarbon resins include a trade name MARUKAREZ S-110A manufactured by Maruzen Petrochemical Co., Ltd., and a trade name Escorez 1315 manufactured by Tonex, Co., Ltd. Examples of commercially available products of the aromatic hydrocarbon resins include a trade name Petcoal 120 manufactured by Tosoh Corporation and a trade name HI-REZ manufactured by Mitsui Chemicals, Inc. Examples of commercially available products of the aliphatic and aromatic copolymerization hydrocarbon resins include a trade name Escorez 2307 and 213 manufactured by Tonex, Co., Ltd. Examples of commercially available products of the dicyclopentadiene-based hydrocarbon resins include a trade name MARUKAREZ M-525A and M-510 manufactured by Maruzen Petrochemical Co., Ltd. Examples of commercially available products of the hydrogenated aliphatic hydrocarbon resins include a trade name MARUKAREZ H-505 manufactured by Maruzen Petrochemical Co., Ltd. Examples of commercially available products of the hydrogenated aromatic hydrocarbon resins include a trade name ARKON P-125 and P-115 manufactured by ARAKAWA CHEMICAL INDUSTRIES, LTD. Examples of commercially available products of the hydrogenated aliphatic and aromatic copolymerization hydrocarbon resins include a trade name I-MARV P-125 and P-140 manufactured by Idemitsu Petrochemical Co., Ltd.

Examples of commercially available products of the hydrogenated dicyclopentadiene-based hydrocarbon resins include a trade name Escorez 5320HC and 228F manufactured by Tonex, Co., Ltd. Examples of commercially available products of the synthetic terpene-based hydrocarbon resins include a trade name Escorez 1401 manufactured by Tonex, Co., Ltd.

Examples of commercially available products of the terpene-based hydrocarbon resins include a trade name YS resin PX-1250 and 1150 manufactured by YASUHARA CHEMICAL CO., LTD. Examples of commercially available products of the hydrogenated terpene-based hydrocarbon resins include a trade name CLEARON P-125 and P-115 manufactured by YASUHARA CHEMICAL CO., LTD. Examples of commercially available products of the coumarone indene-based hydrocarbon resins include a trade name ESCURON V-120 manufactured by NIPPON STEEL & SUMIKIN CHEMICAL CO., LTD. Examples of the low molecular weight styrene-based resins include a trade name HIMER S manufactured by Sanyo Chemical Industries, Ltd. Examples of commercially available products of the rosin-based hydrocarbon resins include a trade name SUPER ESTER A-125 and S-100 manufactured by ARAKAWA CHEMICAL INDUSTRIES, LTD.

The content of the adhesive (C) contained in the freshness-retentive film is 0.5 to 10 parts by mass, preferably 1 to 8 parts by mass, more preferably 2 to 7 parts by mass, still more preferably 3 to 6 parts by mass relative to 100 parts by mass of the total amount of the linear low density polyethylene (A) and the high pressure low density polyethylene (B) in consideration of the characteristics of the resulting film such as adhesion, tackiness, cutting properties, and impact strength.

### <Antifog Additive (D)>

The antifog additive (D) used in the present invention is compounded as an additive (excluding a specific compound (E)) to prevent fogging of the surface of the film caused by condensation of the moisture content in the air. Accordingly, any additive having an effect of hydrophilizing the surface of the film to spread generated water droplets thereon can be used without limitation. Examples of such an antifog additive include surfactants. Examples of the surfactants specifically include sorbitan fatty acid esters such as sorbitan oleate, sorbitan laurate, sorbitan behenate, and sorbitan stearate; glycerol fatty acid esters such as glycerol oleate and glycerol stearate; polyglycerol fatty acid esters such as diglycerol oleate, diglycerol laurate, diglycerol behenate, triglycerol oleate, triglycerol laurate, triglycerol behenate, tetraglycerol oleate, tetraglycerol stearate, hexaglycerol laurate, hexaglycerol behenate, decaglycerol oleate, and decaglycerol laurate; polyoxyalkylene ethers such as polyoxyethylene lauryl ether; polyoxyethylene fatty acid esters such as polyoxyethylene monolaurate; alkylamines such as lauryldiethanolamine other than palmityldiethanolamine and stearyldiethanolamine; and alkylalkanolamides such as lauric acid diethanolamide. The antifog additive (D) will not be limited to these. These are used singly or in the form of a mixture.

The content of the antifog additive (D) contained in the freshness-retentive film is 0.5 to 5 parts by mass, preferably 0.7 to 4 parts by mass, more preferably 0.8 to 3 parts by mass, still more preferably 1 to 2.5 parts by mass relative to 100 parts by mass of the total amount of the linear low density polyethylene (A) and the high pressure low density polyethylene (B). A content of less than 0.5 parts by mass cannot attain the anti-fogging effect. A content of more than 5 parts by mass reduces the transparency of the resulting film due to bleed out of the antifog additive. Preferably, the antifog additive (D) is preliminarily mixed with one of the linear low density polyethylene (A) and the high pressure low density polyethylene (B) component to form a masterbatch, and the masterbatch is mixed with the remaining components to prepare a resin composition.

### <Specific Compound (E)>

In the present invention, the specific compound (E) is at least one compound selected from the group consisting of palmityldiethanolamine, stearyldiethanolamine, glycerol monolaurate, and glycerol monocaprate. Palmityldiethanolamine is an alkyldiethanolamine having a palmityl group, which is a long-chain alkyl group having 16 carbon atoms. Stearyldiethanolamine is an alkyldiethanolamine having a stearyl group having 18 carbon atoms. Glycerol monolaurate is a monoester of lauric acid (12 carbon atoms) and glycerol. Glycerol monocaprate is a monoester of capric acid (10 carbon atoms) and glycerol. As described above, stearyldiethanolamine and palmityldiethanolamine have relatively higher melting points than those of myristyldiethanolamine and lauryldiethanolamine, and are not likely to relatively volatilize during molding of film. Furthermore, stearyldiethanolamine and palmityldiethanolamine have high antibacterial characteristics and freshness retentiveness, and if used in the packaging film, these compounds relatively slowly migrate to the content in contact with the packaging film. Accordingly, these compounds have high safety, and can retain their performance.

These Specific compounds (E) each may contain a similar compound. For example, palmityldiethanolamine (16 carbon atoms) may contain a small amount of an alkyldiethanolamine having an alkyl group having 12 to 20 carbon atoms such as myristyldiethanolamine (14 carbon atoms) or stearyldiethanolamine (18 carbon atoms). Stearyldiethanolamine (18 carbon atoms) may contain a small amount of an alkyldiethanolamine having an alkyl group having 16 to 20 carbon atoms, or the like. These amine compounds may contain a small amount of a similar compound in which part of amine of these amine compounds forms an ester with aliphatic carboxylic acid. Glycerol monolaurate may contain a small amount of a monoester of a higher linear aliphatic carboxylic acid having 10 or 14 carbon atoms and glycerol, or the like. Glycerol monocaprate (C10) may contain a small amount of a monoester of a higher aliphatic carboxylic acid having 8 or 12 carbon atoms and glycerol, or the like. These glycerol monoesters may contain a small amount of a similar compound, that is, glycerol diester or glycerol triester, or a similar compound in which glycerol moiety is replaced with diglycerol or triglycerol. These similar compounds are synthesized simultaneously or difficult to separate during steps such as synthesis or separation of the specific compound (E). These similar compounds may be contained in a content of 50 parts by mass or less relative to 100 parts by mass of the specific compound (E). The content is preferably small.

Furthermore, in the present invention, the specific compound (E) can optionally also be used in combination with other additives such as antistatic agents and lubricants. The total amount of these other additives and the similar compound may be 50 parts by mass or less relative to 100 parts by mass of the specific compound (E) used. The content is preferably small.

The content of the specific compound (E) contained in the freshness-retentive film is 0.001 to 3 parts by mass, preferably 0.01 to 2 parts by mass, more preferably 0.1 to 1.5 parts by mass, still more preferably 0.3 to 1 part by mass relative to 100 parts by mass of the total amount of the linear low density polyethylene (A) and the high pressure low density polyethylene (B) to attain sufficient antibacterial characteristics.

### <Providing Functions Such as Antibacterial Characteristics and Freshness Retentiveness>

In the freshness-retentive film according to the present invention, the specific compound (E) is present on the surface thereof at 0.002 to 0.5 g/m². The amount of the specific compound (E) present on the surface of the film is preferably 0.005 to 0.1 g/m², more preferably 0.008 to 0.08 g/m², still more preferably 0.010 to 0.050 g/m². The specific compound (E) present on the surface of the film in an amount in the range above can attain high antibacterial characteristics and freshness retentiveness of the film. If the amount of the specific compound (E) present on the surface of the film is less than 0.002 g/m², sufficient antibacterial characteristics and freshness retentiveness are not attained. If the amount of the specific compound (E) present on the surface of the film is more than 0.5 g/m², the film has low transparency. The amount of the specific compound (E) on the surface of the film can be determined by the same method as that in First Embodiment. The surface of the film is preferably the surface to be in contact with a content.

### <Production Method>

The freshness-retentive film according to the present invention may be produced with a resin composition containing the predetermined amounts of the components (A) to (E). Examples of the method of producing a freshness-retentive film include the following methods 1) to 4):

1) a method of mechanically mixing the predetermined amounts of the components (A) to (E) with other components optionally added in an extruder, a kneader, or the like.

2) a method of dissolving the predetermined amounts of the components (A) to (E) and other components optionally added in a proper good solvent (e.g., hydrocarbon solvent such as hexane, heptane, decane, cyclohexane, benzene, toluene, and xylene), and removing the solvent.

3) a method of separately dissolving the predetermined amounts of the components (A) to (E) and other components optionally added in a proper good solvent to prepare solutions, mixing the solutions, and removing the solvents.

4) a method using a combination of methods 1) to 3).

Among these methods, method 1) is preferably used. Specifically, the components can be melted by heating, and be kneaded with a kneader such as a kneader, a Banbury mixer, and a roll, a single- or twin-screw extruder, or the like. Alternatively, various resin pellets may be dry blended. If the freshness-retentive film is composed of several layers, the respective layers forming the freshness-retentive film can be produced by the method.

The freshness-retentive film may be produced by kneading a resin composition containing the predetermined amounts of the components (A) to (E) and optional other components, melting the resin composition, and molding the resin composition into a film with an extrusion molding machine equipped with a T die, for example. The freshness-retentive film may be formed of only a layer containing the predetermined amounts of the components (A) to (E) and optional other components, or may be a laminate of other resin film layers. Examples of the resins for forming other resin film layers include polyolefin-based resins such as homopolymers and copolymers of ethylene, propylene, and butene. Mixtures of these polyolefin-based resins and a recovered product of film ends called ear portions, which are generated during molding a film containing the predetermined amounts of the components (A) to (E), can also be used.

The thickness of the freshness-retentive film is preferably 5 to 50 μm, more preferably 8 to 30 μm, still more preferably 8 to 20 μm in view of strength, handling characteristics, cost, and the like. If other resin film layers are laminated, the resin composition containing the components (A) to (E) as essential components is formed into layers having a thickness of 1 to 5 μm, and another resin composition is formed into other layers having the same thickness as above. These layers are alternately laminated such that the overall thickness of the film is within the range above. In this case, the layer formed of the resin composition containing the predetermined amounts of the components (A) to (E) as essential components is preferably laminated so as to be the outermost layer. If the freshness-retentive film is a laminate, the thickness of the layer formed of the resin composition containing the predetermined amounts of the components (A) to (E) as essential components is preferably 50% or more of the overall thickness of the film.

The freshness-retentive film can be molded by any method as long as the overall film contains the predetermined amounts of the components (A) to (E) as described above. Preferably, the film is molded using a resin composition containing the predetermined amounts of the components (A) to (E) by extrusion molding with an extruder equipped with a T die. In a preferred T die extrusion molding method, as an orientation prevention treatment, for example, the molding temperature is 180 to 270° C., the draft ratio (stretching ratio within the draft distance) is 40 to 130, the draft distance (distance from the die tip to a point where the film is put into contact with, for example, the cooling roll) is 50 to 120 mm, and the film is taken up at a film temperature of 40 to 70° C. and a stretching ratio of 1.1 to 1.3. The melt molded film is cooled with a cooling apparatus such as a cooling roll, and is formed. The forming temperature is preferably 15 to 80° C. If other film layers are laminated, films may be individually molded, and may be laminated with a laminator or the like. In view of production efficiency, a laminate film is preferably formed by co-extrusion with a multi-layer extrusion molding machine.

### EXAMPLES

Hereinafter, the present invention will be described in more detail by way of Examples. In the following description, the term “parts” indicates “parts by mass,” and “%” indicates “% by mass.”

### [Experiment 1]

### <Test Method>

### (1) Antibacterial Test

An antibacterial test was performed using Escherichia coli (E. coli) according to JIS Z2801. To keep the state of the surface of the freshness-retentive film, the surface thereof was not wiped with alcohol.

Predetermined amounts of Escherichia coli (E. coli), Staphylococcus aureus, Salmonella, and Vibrio parahaemolyticus (broth (0.4 cc) used in a JIS test) were added to a 1/500 nutrient broth. The nutrient broth was dropped onto the surface of a freshness-retentive film of a 4 cm square, and was covered with a polyethylene film. The film was placed at 35° C., and after 24 hours, the surface of the freshness-retentive film was washed. The washing liquid containing the nutrient broth was recovered, and was cultured on a nutrient agar. The number of colonies was counted.

Since the number of bacterial cells is difficult to count under a microscope, the number of colonies was visually counted. The number of colonies per gram (g) was defined as the number of living bacterial cells CFU (colony forming unit) (unit: [colonies/g]). A sample sandwiched between two polyethylene films was used as a control (Control) for comparison. In Tables, the averages at n=1 to 3 are also shown. If a fluctuation in the measured values is 10 times or more, the average is not calculated according to the JIS specification.

The fluctuation in antibacterial characteristics and antibacterial activity was evaluated according to the following criteria, respectively.

### (Fluctuation)

None: at n=1 to 3, the ratio of the minimum value to the maximum value is smaller than 10.

Small: at n=1 to 3, the ratio of the minimum value to the maximum value is within the range of 10 to 100.

Large: at n=1 to 3, the ratio of the minimum value to the maximum value is larger than 100.

### (Antibacterial Activity)

A: the number of bacterial cells <10, and the bacteria cannot be detected actually.

B: the ratio of the result of the experiment to the control (result of the experiment/control) is 1/100 or less.

C: the ratio of the result of the experiment to the control (result of the experiment/control) is more than 1/100 and 1/10 or less.

D: the ratio of the result of the experiment to the control (result of the experiment/control) is more than 1/10.

### (2) Amount of Stearyldiethanolamine on Surface of Freshness-Retentive Film (g/m²)

The amount of stearyldiethanolamine on the surface of the freshness-retentive film was determined from the amount of stearyldiethanolamine applied.

(3) Amount of Glycerol Monolaurate (C12) on Surface of Freshness-Retentive Film (g/m²)

The amount of glycerol monolaurate on the surface of the freshness-retentive film was determined from the amount of glycerol monolaurate applied.

(4) Amount of Diglycerol Monolaurate (C12) on Surface of Freshness-Retentive Film (g/m²)

The amount of diglycerol monolaurate on the surface of the freshness-retentive film was determined from the amount glycerol monolaurate applied.

### Examples 1 to 13, Comparative Examples 1 and 2

### (1) Freshness-Retentive Film Containing Propylene-Based Polymer

### (1-1) Intermediate Layer

As a material for an intermediate layer, a propylene homopolymer (melting point (Tm): 160° C., MFR: 3 g/10 min (manufactured by Prime Polymer Co., Ltd.)) was used.

### (1-2) Surface Layer and Rear Surface Layer

As a material for a surface layer and a rear surface layer, a propylene-ethylene random copolymer (melting point (Tm): 138° C., MFR: 7 g/10 min (manufactured by Prime Polymer Co., Ltd.)) was used.

A three-layer film composed of the rear surface layer, the intermediate layer, and the surface layer formed of these materials was continuously molded with a biaxial stretching machine at a ratio of the thickness of the layers of 1/8/1 to produce a freshness-retentive film composed of a multi-layer stretched film. The stretching temperature for the freshness-retentive film was 100° C. in longitudinal stretching and 180° C. in lateral stretching. The heat setting temperature was 180° C., and the heat setting time was 10 seconds. Furthermore, the surface of the rear surface layer was subjected to a corona treatment such that the corona-treated surface had a wetting index of 38 dyn.

Stearyldiethanolamine, glycerol monolaurate (C12), or diglycerol monolaurate was dissolved in a solution of purified water/isopropyl alcohol (IPA) (mass ratio: 80/20) heated to 50° C. The solution was applied onto the surface of the surface layer in the freshness-retentive film with a coating bar such that the amount of Specific compound 1 on the surface thereof was as shown in Tables 1 to 3. The coating was dried by heating with hot air at 100° C. for one minute. The results of the test are shown in Tables 1 to 3.

TABLE 1

| | | | | | | | | | Comparative |
|---|---|---|---|---|---|---|---|---|---|
| | | Example 1 | Example 2 | Example 3 | Example 4 | Example 5 | Example 6 | Example 7 | Example 1 |
| Amount of | | 0.200 | 0.100 | 0.050 | 0.040 | 0.020 | 0.010 | 0.005 | 0.001 |
| stearyldiethanolamine on | | | | | | | | | |
| surface | | | | | | | | | |
| (g/m²) | | | | | | | | | |
| Antibacterial test | Initial | 1.0 × 10⁵ | 1.0 × 10⁵ | 1.0 × 10⁵ | 1.0 × 10⁵ | 1.0 × 10⁵ | 1.0 × 10⁵ | 1.0 × 10⁵ | 1.0 × 10⁵ |
| (E. coli) | (colonies/g) | | | | | | | | |
| | After 24 h, n = 1 | <1.0 × 10 | <1.0 × 10 | <1.0 × 10 | <1.0 × 10 | <1.0 × 10 | 2.3 × 10² | 8.3 × 10⁴ | 8.8 × 10⁶ |
| | (colonies/g) | | | | | | | | |
| | After 24 h, n = 2 | <1.0 × 10 | <1.0 × 10 | <1.0 × 10 | <1.0 × 10 | <1.0 × 10 | 2.6 × 10² | 4.4 × 10⁴ | 8.3 × 10⁶ |
| | (colonies/g) | | | | | | | | |
| | After 24 h, n = 3 | <1.0 × 10 | <1.0 × 10 | <1.0 × 10 | <1.0 × 10 | <1.0 × 10 | 9.4 × 10² | 1.9 × 10⁵ | 1.0 × 10⁷ |
| | (colonies/g) | | | | | | | | |
| | Average | <1.0 × 10 | <1.0 × 10 | <1.0 × 10 | <1.0 × 10 | <1.0 × 10 | 5.0 × 10² | 1.1 × 10⁵ | 9.0 × 10⁶ |
| | (colonies/g) | | | | | | | | |
| | Fluctuation | Small | Small | Small | Small | Small | Small | Small | Small |
| | Antibacterial | A | A | A | A | A | B | B | D |
| | activity | | | | | | | | |
| | Control | 1.2 × 10⁷ | 1.2 × 10⁷ | 1.2 × 10⁷ | 1.2 × 10⁷ | 1.2 × 10⁷ | 1.2 × 10⁷ | 1.2 × 10⁷ | 1.2 × 10⁷ |
| | (colonies/g) | | | | | | | | |

TABLE 2

| | | | | Example | Example | Example | Example | Comparative |
|---|---|---|---|---|---|---|---|---|
| | | Example 8 | Example 9 | 10 | 11 | 12 | 13 | Example 2 |
| Amount of glycerol | | 0.200 | 0.100 | 0.050 | 0.040 | 0.020 | 0.010 | 0.001 |
| monolaurate on surface | | | | | | | | |
| (g/m²) | | | | | | | | |
| Antibacterial | Initial | 1.1 × 10⁵ | 1.1 × 10⁵ | 1.1 × 10⁵ | 1.1 × 10⁵ | 1.1 × 10⁵ | 1.1 × 10⁵ | 1.1 × 10⁵ |
| test | (colonies/g) | | | | | | | |
| (E. coli) | After 24 h, n = 1 | <1.0 × 10 | <1.0 × 10 | <1.0 × 10 | 1.3 × 10² | 2.3 × 10² | 1.5 × 10⁴ | 4.5 × 10⁶ |
| | (colonies/g) | | | | | | | |
| | After 24 h, n = 2 | <1.0 × 10 | <1.0 × 10 | <1.0 × 10 | <1.0 × 10 | 1.5 × 10³ | 1.6 × 10⁵ | 4.9 × 10⁶ |
| | (colonies/g) | | | | | | | |
| | After 24 h, n = 3 | <1.0 × 10 | <1.0 × 10 | <1.0 × 10 | <1.0 × 10 | 1.5 × 10² | 5.5 × 10⁴ | 4.4 × 10⁶ |
| | (colonies/g) | | | | | | | |
| | Average | <1.0 × 10 | <1.0 × 10 | <1.0 × 10 | 5.0 × 10 | 6.3 × 10² | 7.7 × 10⁴ | 4.6 × 10⁶ |
| | (colonies/g) | | | | | | | |
| | Fluctuation | Small | Small | Small | Small | Small | Small | Small |
| | Antibacterial | A | A | A | A-B | B | B | D |
| | activity | | | | | | | |
| | Control | 1.1 × 10⁷ | 1.1 × 10⁷ | 1.1 × 10⁷ | 1.1 × 10⁷ | 1.1 × 10⁷ | 1.1 × 10⁷ | 1.1 × 10⁷ |
| | (colonies/g) | | | | | | | |

TABLE 3

| | Example 14 |
|---|---|
| Amount of diglycerol monolaurate | 0.200 |
| on surface (g/m²) | |

| | | |
|---|---|---|
| Antibacterial | Initial (colonies/g) | 1.1 × 10⁵ |
| test (E. coli) | After 24 h, n = 1 | 6.0 × 10⁵ |
| | (colonies/g) | |
| | After 24 h, n = 2 | 5.1 × 10⁵ |
| | (colonies/g) | |
| | After 24 h, n = 3 | 1.4 × 10⁵ |
| | (colonies/g) | |
| | Average (colonies/g) | 4.2 × 10⁵ |
| | Fluctuation | Small |
| | Antibacterial activity | C |
| | Control (colonies/g) | 1.1 × 10⁷ |

Table 1 evidently shows that in Examples 1 to 7 in which stearyldiethanolamine was present on the surface of the freshness-retentive film at 0.002 to 0.5 g/m², the number of E. coli cells after 24 hours was 1/100 or less of that of the control, and the antibacterial characteristics were confirmed. In contrast, in Comparative Example 1 in which the amount of stearyldiethanolamine was out of the range, the antibacterial characteristics were not found.

Table 2 evidently shows that in Examples 8 to 13 in which glycerol monolaurate was present on the surface of the freshness-retentive film at 0.002 to 0.5 g/m², the number of E. coli cells after 24 hours was 1/100 or less of that of the control, and the antibacterial characteristics were confirmed. In contrast, in Comparative Example 2 in which the amount of glycerol monolaurate was out of the range, the antibacterial characteristics were not found.

Furthermore, Table 3 evidently shows that in Example 14 in which diglycerol monolaurate was present on the surface of the freshness-retentive film at 0.200 g/m², the number of E. coli cells after 24 hours was about 1/100 of that of the control, and the antibacterial characteristics were confirmed to some extent.

### Examples 15 to 26, Comparative Examples 3 to 9

### (2) Freshness-Retentive Film Containing Ethylene-Based Polymer

### (2-1) Intermediate Layer

As a material for an intermediate layer, linear low density polyethylene (manufactured by Mitsui Chemicals, Inc., density: 0.920 g/cm³, MFR: 4.0 g/10 min, melting point: 117.3° C.) was used.

### (2-2) Rear Surface Layer

As a material for a rear surface layer, a material containing the linear low density polyethylene and 1000 ppm of each of the following materials was used.

### (a) Silica

trade name Sylysia 730 (average particle size: 3 μm) manufactured by Fuji Silysia Chemical Ltd.

### (b) Erucamide

trade name ATMER SA 1753 manufactured by Ciba Specialty Chemicals Inc.

### (2-3) Surface Layer

As a material for a surface layer, a material prepared by compounding the linear low density polyethylene, 1000 ppm of the following material (a), and 1000 ppm of the following material (b), and the following materials (c) to (f) in amounts as shown in Tables 4 to 8 was used.

### (a) Silica

trade name Sylysia 730 (average particle size: 3 μm) manufactured by Fuji Silysia Chemical Ltd.

### (b) Erucamide

trade name ATMER SA 1753 manufactured by Ciba Specialty Chemicals Inc.

(c) Stearyldiethanolamine manufactured by Kao Corporation
(d) Glycerol Monolaurate (C12 Monogly) manufactured by Riken Vitamin Co., Ltd.
(e) Diglycerol Monolaurate (C12 Digly) manufactured by Riken Vitamin Co., Ltd.
(f) Polyethylene Glycol (PEG) PEG-1, molecular weight: 200000 (g/M), manufactured by Dai-ichi Kogyo Seiyaku Co., Ltd.

PEG-2, molecular weight: 20000 (g/M), manufactured by NOF CORPORATION

A three-layer cast film composed of the rear surface layer, the intermediate layer, and the surface layer formed of these materials was produced at a ratio of the thicknesses of the layers of 1/3/1. Extrusion conditions were a die temperature of 200° C. and a chill temperature of 50° C. The surface of the surface layer (sealed layer) was subjected to a corona treatment such that the wetting index was 38 dyn. The results of the test are shown in Tables 4 to 8.

TABLE 4

| | | Example 15 | Example 16 | Example 17 | Example 18 |
|---|---|---|---|---|---|
| Amount | Stearyldiethanolamine (C18) | 2000 | 2000 | 2000 | 2000 |
| compounded in | Glycerol monolaurate (C12) | | | 2000 | 2000 |
| surface layer | Diglycerol monolaurate | | | 2000 | 2000 |
| (ppm) | (C12) | | | | |
| | PEG-1 | | | | |
| | PEG-2 | | | 2000 | 2000 |
| Thickness of freshness-retentive film (μm) | | 30 | 40 | 30 | 40 |
| Antibacterial test | Initial (colonies/g) | 1.0 × 10⁵ | 1.0 × 10⁵ | 1.0 × 10⁵ | 1.0 × 10⁵ |
| (E. coli) | After 24 h, n = 1 (colonies/g) | 1.8 × 10³ | <1.0 × 10 | 5.1 × 10² | <1.0 × 10 |
| | After 24 h, n = 2 (colonies/g) | <1.0 × 10 | 2.6 × 10³ | <1.0 × 10 | <1.0 × 10 |
| | After 24 h, n = 3 (colonies/g) | 1.1 × 10⁵ | <1.0 × 10 | <1.0 × 10 | <1.0 × 10 |
| | Average (colonies/g) | Averaging | Averaging | Averaging | <1.0 × 10 |
| | | impossible | impossible | impossible | |
| | Fluctuation | Large | Large | Large | Small |
| | Antibacterial activity | A-B | A-B | A-B | A |
| | Control (colonies/g) | 1.4 × 10⁷ | 1.4 × 10⁷ | 1.4 × 10⁷ | 1.4 × 10⁷ |
| Antibacterial test | Initial (colonies/g) | 1.1 × 10⁵ | | 1.1 × 10⁵ | |
| (Staphylococcus | After 24 h, n = 1 (colonies/g) | <1.0 × 10 | | <1.0 × 10 | |
| aureus) | After 24 h, n = 2 (colonies/g) | <1.0 × 10 | | <1.0 × 10 | |
| | After 24 h, n = 3 (colonies/g) | <1.0 × 10 | | 1.6 × 10³ | |
| | Average (colonies/g) | <1.0 × 10 | | Averaging | |
| | | | | impossible | |
| | Fluctuation | Small | | Large | |
| | Antibacterial activity | A | | A-B | |
| | Control (colonies/g) | 1.6 × 10⁵ | | 1.6 × 10⁵ | |
| Antibacterial test | Initial (colonies/g) | 1.3 × 10⁵ | | 1.3 × 10⁵ | |
| (Salmonella) | After 24 h, n = 1 (colonies/g) | 8.7 × 10³ | | <1.0 × 10 | |
| | After 24 h, n = 2 (colonies/g) | 9.1 × 10³ | | 1.5 × 10² | |
| | After 24 h, n = 3 (colonies/g) | 1.2 × 10⁴ | | 8.0 × 10 | |
| | Average (colonies/g) | 9.9 × 10³ | | Averaging | |
| | | | | impossible | |
| | Fluctuation | Small | | Large | |
| | Antibacterial activity | B | | A-B | |
| | Control (colonies/g) | 1.3 × 10⁶ | | 1.3 × 10⁶ | |
| Antibacterial test | Initial (colonies/g) | 1.4 × 10⁵ | | 1.3 × 10⁵ | |
| (Vibrio | After 24 h, n = 1 (colonies/g) | <1.0 × 10 | | <1.0 × 10 | |
| parahaemolyticus) | After 24 h, n = 2 (colonies/g) | <1.0 × 10 | | <1.0 × 10 | |
| | After 24 h, n = 3 (colonies/g) | 2.9 × 10² | | <1.0 × 10 | |
| | Average (colonies/g) | Averaging | | <1.0 × 10 | |
| | | impossible | | | |
| | Fluctuation | Large | | Small | |
| | Antibacterial activity | A-B | | A | |
| | Control (colonies/g) | 1.3 × 10⁵ | | 1.3 × 10⁵ | |

TABLE 5

| | | Comparative | Example | Example | Comparative | Example |
|---|---|---|---|---|---|---|
| | | Example 3 | 19 | 20 | Example 4 | 21 |
| Amount | Stearyldiethanolamine | | 5000 | 2000 | 1000 | 1000 |
| compounded | (C18) | | | | | |
| in surface | Glycerol monolaurate | | | | 2000 | |
| layer (ppm) | (C12) | | | | | |
| | Diglycerol | | | | | |
| | monolaurate (C12) | | | | | |
| | PEG-1 | | | | | |
| | PEG-2 | | | | | |
| Thickness of freshness-retentive film | | 30 | 30 | 30 | 30 | 30 |
| (μm) | | | | | | |
| Antibacterial | Initial (colonies/g) | 1.1 × 10⁵ | 1.0 × 10⁵ | 1.0 × 10⁵ | 1.0 × 10⁵ | 1.0 × 10⁵ |
| test (E. coli) | After 24 h, n = 1 | 9.2 × 10⁶ | <1.0 × 10 | 9.1 × 10² | 9.3 × 10⁵ | 1.0 × 10³ |
| | (colonies/g) | | | | | |
| | After 24 h, n = 2 | 1.0 × 10⁷ | 9.6 × 10⁴ | 2.4 × 10² | 1.0 × 10⁶ | 1.2 × 10⁶ |
| | (colonies/g) | | | | | |
| | After 24 h, n = 3 | 8.5 × 10⁶ | <1.0 × 10 | <1.0 × 10 | 8.1 × 10⁵ | 1.5 × 10⁶ |
| | (colonies/g) | | | | | |
| | Average (colonies/g) | 9.2 × 10⁶ | Averaging | Averaging | 9.1 × 10⁵ | Averaging |
| | | | impossible | impossible | | impossible |
| | Fluctuation | Small | Large | Large | Small | Large |
| | Antibacterial activity | D | A-B | A-B | D | B-D |
| | Control (colonies/g) | 1.6 × 10⁷ | 1.6 × 10⁷ | 1.6 × 10⁷ | 1.6 × 10⁷ | 1.6 × 10⁷ |

TABLE 6

| | | Comparative | Comparative | Comparative | Comparative | Example |
|---|---|---|---|---|---|---|
| | | Example 5 | Example 6 | Example 7 | Example 8 | 22 |
| Amount | Stearyldiethanolamine | 1000 | 1000 | 1000 | 1000 | 1000 |
| compounded | (C18) | | | | | |
| in surface | Glycerol monolaurate | | | | | |
| layer (ppm) | (C12) | | | | | |
| | Diglycerol | 2000 | | | | |
| | monolaurate (C12) | | | | | |
| | Diglycerol palmitate | | 2000 | | | |
| | (C16) | | | | | |
| | Diglycerol myristate | | | 2000 | | |
| | (C14) | | | | | |
| | PEG-1 | | | | 2000 | |
| | PEG-2 | | | | | 2000 |
| Thickness of freshness-retentive film | | 30 | 30 | 30 | 30 | 30 |
| (μm) | | | | | | |
| Antibacterial | Initial (colonies/g) | 1.1 × 10⁵ | 1.1 × 10⁵ | 1.1 × 10⁵ | 1.0 × 10⁵ | 1.0 × 10⁵ |
| test (E. coli) | After 24 h, n = 1 | 1.1 × 10⁶ | 1.0 × 10⁷ | 2.0 × 10⁶ | 1.0 × 10⁶ | 1.8 × 10⁴ |
| | (colonies/g) | | | | | |
| | After 24 h, n = 2 | 1.2 × 10⁶ | 1.0 × 10⁷ | 4.9 × 10⁶ | 7.9 × 10⁵ | 2.3 × 10⁴ |
| | (colonies/g) | | | | | |
| | After 24 h, n = 3 | 1.6 × 10⁶ | 1.1 × 10⁷ | 2.8 × 10⁶ | 1.3 × 10⁶ | 8.9 × 10⁴ |
| | (colonies/g) | | | | | |
| | Average (colonies/g) | 1.3 × 10⁶ | 1.0 × 10⁷ | 3.2 × 10⁶ | 1.0 × 10⁶ | 4.3 × 10⁴ |
| | Fluctuation | Small | Small | Small | Small | Small |
| | Antibacterial activity | D | D | D | D | B |
| | Control (colonies/g) | 1.6 × 10⁷ | 1.6 × 10⁷ | 1.6 × 10⁷ | 1.6 × 10⁷ | 1.6 × 10⁷ |

TABLE 7

| | | Example 23 | Example 24 | Example 25 |
|---|---|---|---|---|
| Amount | Stearyldiethanolamine | 1000 | 2000 | 2000 |
| compounded | (C18) | | | |
| in surface | Glycerol monolaurate (C12) | 2000 | 2000 | 2000 |
| layer (ppm) | Diglycerol monolaurate | 2000 | 2000 | 2000 |
| | (C12) | | | |
| | Diglycerol palmitate (C16) | | | |
| | Diglycerol myristate (C14) | | | |
| | PEG-1 | | 2000 | |
| | PEG-2 | | | 2000 |
| Thickness of freshness-retentive film (μm) | | 30 | 30 | 30 |
| Antibacterial | Initial (colonies/g) | 1.1 × 10⁵ | 1.0 × 10⁵ | 1.0 × 10⁵ |
| test (E. coli) | After 24 h, n = 1 | <1.0 × 10 | <1.0 × 10 | 1.3 × 10⁴ |
| | (colonies/g) | | | |
| | After 24 h, n = 2 | <1.0 × 10 | 1.5 × 10² | 1.6 × 10³ |
| | (colonies/g) | | | |
| | After 24 h, n = 3 | 4.8 × 10⁵ | 1.2 × 10⁵ | 1.3 × 10³ |
| | (colonies/g) | | | |
| | Average (colonies/g) | Averaging | Averaging | Averaging |
| | | impossible | impossible | impossible |
| | Fluctuation | Large | Large | Large |
| | Antibacterial activity | A-D | A-B | B |
| | Control (colonies/g) | 1.6 × 10⁷ | 1.6 × 10⁷ | 1.6 × 10⁷ |

TABLE 8

| | | Comparative | Example |
|---|---|---|---|
| | | Example 9 | 26 |
| Amount | Stearyldiethanolamine (C18) | | |
| compounded | Glycerol monolaurate (C12) | 2000 | 2000 |
| in surface | Diglycerol monolaurate | 2000 | 2000 |
| layer (ppm) | (C12) | | |
| | Diglycerol palmitate (C16) | | |
| | Diglycerol myristate (C14) | | |
| | PEG-1 | 2000 | |
| | PEG-2 | | 2000 |
| Thickness of freshness-retentive film (μm) | | 30 | 30 |
| Antibacterial | Initial (colonies/g) | 1.1 × 10⁵ | 1.1 × 10⁵ |
| test (E. coli) | After 24 h, n = 1 (colonies/g) | 1.6 × 10⁶ | 1.3 × 10² |
| | After 24 h, n = 2 (colonies/g) | 1.7 × 10⁶ | 1.0 × 10⁶ |
| | After 24 h, n = 3 (colonies/g) | 1.7 × 10⁶ | 5.9 × 10⁵ |
| | Average (colonies/g) | 1.7 × 10⁶ | |
| | Fluctuation | Small | Large |
| | Antibacterial activity | D | B-D |
| | Control (colonies/g) | 1.6 × 10⁷ | 1.6 × 10⁷ |

Table 4 evidently shows that in Examples 15 and 16 in which 2000 ppm of stearyldiethanolamine was compounded in the surface layer of the freshness-retentive film, the film had antibacterial characteristics against E. coli, Staphylococcus aureus, Salmonella, and Vibrio parahaemolyticus. Examples 16 and 17 in which in addition to 2000 ppm of stearyldiethanolamine, 2000 ppm of glycerol monolaurate (C12), 2000 ppm of diglycerol monolaurate (C12), and 2000 ppm of polyethylene glycol (PEG-2, molecular weight: 20000) were added showed more stable antibacterial characteristics against these bacteria.

Table 5 evidently shows that Comparative Example 3 containing no Specific compound 1 had no antibacterial activity. In contrast, in Examples 19 and 20 containing 5000 ppm and 2000 ppm of stearyldiethanolamine in the surface layer, respectively, the antibacterial characteristics were confirmed. Comparative Example 4 containing 1000 ppm of stearyldiethanolamine, however, had no antibacterial characteristics. In Example 21 in which in addition to 1000 ppm of stearyldiethanolamine, 2000 ppm of glycerol monolaurate (C12) was compounded, the antibacterial characteristics were slightly confirmed.

Table 6 evidently shows that in Comparative Examples 5, 6, and 7 in which in addition to 1000 ppm of stearyldiethanolamine, 2000 ppm of diglycerol monolaurate (C12), 2000 ppm of diglycerol palmitate (C16), and 2000 ppm of diglycerol myristate (C14) were compounded, the antibacterial characteristics were not found. In Comparative Example 8 in which in addition to 1000 ppm of stearyldiethanolamine, 2000 ppm of polyethylene glycol (PEG-1) having a molecular weight of 200000 was added, the antibacterial characteristics were also not found. In contrast, in Example 22 in which in addition to 1000 ppm of stearyldiethanolamine, 2000 ppm of polyethylene glycol (PEG-2) having a molecular weight of 20000 was added, stable antibacterial characteristics were confirmed.

Table 7 evidently shows that Examples 23 to 25 in which in addition to 1000 ppm or 2000 ppm of stearyldiethanolamine, 2000 ppm of glycerol monolaurate (C12) and 2000 ppm of diglycerol monolaurate (C12) were compounded showed high antibacterial characteristics.

Table 8 evidently shows that in Comparative Example 9 in which without adding stearyldiethanolamine, 2000 ppm of glycerol monolaurate (C12) and 2000 ppm of diglycerol monolaurate (C12) were added, and 2000 ppm of polyethylene glycol (PEG 1) having a molecular weight of 200000 was added, the antibacterial characteristics were not found. In Example 26 in which instead of polyethylene glycol (PEG 1) having a molecular weight of 200000, 2000 ppm of polyethylene glycol (PEG 2) having a molecular weight of 20000 was added, the antibacterial characteristics were confirmed.

Examples 15 to 26 show sufficient antibacterial characteristics, which evidently indicates that Specific compound 1 is present on the surface of the freshness-retentive film at 0.002 to 0.5 g/m².

### Examples 27 to 30, Comparative Examples 10 and 11

### (3) Freshness-Retentive Film Containing Propylene-Based Polymer

### (3-1) Intermediate Layer

As a material for an intermediate layer, a material containing a propylene homopolymer (melting point (Tm): 160° C., MFR: 3 g/10 min (manufactured by Prime Polymer Co., Ltd.)), 1000 ppm of the following material (a), and 1000 ppm of the following material (b) was used.

### (a) Silica

trade name Sylysia 730 (average particle size: 3 μm) manufactured by Fuji Silysia Chemical Ltd.

### (b) Erucamide

trade name ATMER SA 1753 manufactured by Ciba Specialty Chemicals Inc.

### (3-2) Surface Layer

A material prepared by compounding the propylene homopolymer, 1000 ppm of the following material (a), and 1000 ppm of the following material (b), and the following materials (c) to (f) in amounts as shown in Table 9 was used.

(a) Silica trade name Sylysia 730 (average particle size: 3 μm) manufactured by Fuji Silysia Chemical Ltd.

### (b) Erucamide

trade name ATMER SA 1753 manufactured by Ciba Specialty Chemicals Inc.

(c) Stearyldiethanolamine (C18) manufactured by Kao Corporation
(d) Glycerol Monolaurate (C12) manufactured by Riken Vitamin Co., Ltd.
(e) Diglycerol Monolaurate (C12) manufactured by Riken Vitamin Co., Ltd.
(f) Diglycerol Palmitate (C16) manufactured by Riken Vitamin Co., Ltd.

### (3-2) Rear Surface Layer

As a material for a rear surface layer, a propylene-ethylene random copolymer (melting point (Tm): 138° C., MFR: 7 g/10 min (manufactured by Prime Polymer Co., Ltd.)) was used.

A three-layer film composed of the rear surface layer, the intermediate layer, and the surface layer was continuously molded with a biaxial stretching machine to produce a freshness-retentive film composed of a multi-layer stretched film. The stretching temperature for the freshness-retentive film was 100° C. in longitudinal stretching and 165° C. in lateral stretching. The heat setting temperature was 165° C., and the heat setting time was 10 seconds. The results of the test are shown in Table 9.

TABLE 9

| | | Comparative | Comparative | Example | Example | Example | Example |
|---|---|---|---|---|---|---|---|
| | | Example 10 | Example 11 | 27 | 28 | 29 | 30 |
| Amount | Stearyldiethanolamine | | 500 | | 500 | | 500 |
| compounded | (C18) | | | | | | |
| in surface | Glycerol monolaurate | 3000 | 3000 | 6000 | 6000 | 9000 | 9000 |
| layer (ppm) | (C12) | | | | | | |
| | Diglycerol palmitate | 3000 | 3000 | 3000 | 3000 | 3000 | 3000 |
| | (C16) | | | | | | |
| | Diglycerol | 3000 | 3000 | 6000 | 6000 | 9000 | 9000 |
| | monolaurate (C12) | | | | | | |
| Thickness of freshness-retentive | | 30 | 30 | 30 | 30 | 30 | 30 |
| film (μm) | | | | | | | |
| Antibacterial | Initial (colonies/g) | 1.8 × 10⁵ | 1.8 × 10⁵ | 1.8 × 10⁵ | 1.8 × 10⁵ | 1.8 × 10⁵ | 1.8 × 10⁵ |
| test (E. coli) | After 24 h, n = 1 | 2.1 × 10⁵ | 2.3 × 10⁵ | 2.3 × 10⁵ | 1.5 × 10⁴ | 4.3 × 10² | 1.6 × 10⁴ |
| | (colonies/g) | | | | | | |
| | After 24 h, n = 2 | 3.7 × 10⁵ | 1.3 × 10⁶ | 2.7 × 10⁵ | 1.2 × 10⁶ | 6.0 × 10 | 4.9 × 10³ |
| | (colonies/g) | | | | | | |
| | After 24 h, n = 3 | 7.7 × 10⁵ | 1.0 × 10⁴ | <1.0 × 10 | 9.0 × 10¹ | 1.2 × 10² | <1.0 × 10 |
| | (colonies/g) | | | | | | |
| | Average (colonies/g) | 4.5 × 10⁵ | Averaging | Averaging | Averaging | 2.0 × 10² | Averaging |
| | | | impossible | impossible | impossible | | impossible |
| | Fluctuation | Small | Large | Large | Large | Small | Large |
| | Antibacterial activity | D | D | A-D | A-D | B | A-B |
| | Control (colonies/g) | 1.3 × 10⁷ | 1.3 × 10⁷ | 1.3 × 10⁷ | 1.3 × 10⁷ | 1.3 × 10⁷ | 1.3 × 10⁷ |

Table 9 evidently shows that Comparative Examples 10 and 11 in which 0 or 500 ppm of stearyldiethanolamine, 3000 ppm of diglycerol palmitate (C16), 3000 ppm of glycerol monolaurate (C12), and 3000 ppm of diglycerol monolaurate (C12) were compounded showed no antibacterial activity. In contrast, Examples 27 and 28 in which 0 or 500 ppm of stearyldiethanolamine, 3000 ppm of diglycerol palmitate (C16), 6000 ppm of glycerol monolaurate (C12), and 6000 ppm of diglycerol monolaurate (C12) were compounded showed antibacterial characteristics. Furthermore, Examples 29 and 30 in which 0 or 500 ppm of stearyldiethanolamine, 3000 ppm of diglycerol palmitate (C16), 9000 ppm of glycerol monolaurate (C12), and 9000 ppm of diglycerol monolaurate (C12) were compounded showed stable and high antibacterial characteristics. Examples 27 to 30 show sufficient antibacterial characteristics, which evidently indicates that Specific compound 1 is present on the surface of the freshness-retentive film at 0.002 to 0.5 g/m².

### [Experiment 2]

### <Test Method>

### (1) Antibacterial Test

An antibacterial test was performed in the same manner as in Experiment 1.

### (2) Blocking

Cut freshness-retentive films of 40 mm×60 mm were prepared. These cut films were layered with the corona-treated surfaces facing each other or the non-corona-treated surfaces facing each other to prepare laminates. While a load of 100 g was applied from above to each of the laminates, the laminates were placed in an oven, and were left at 40° C. for 24 hours. Subsequently, the laminates were extracted, and were visually observed. These laminates were determined as “A” if the layers were readily peeled off, and determined as “B” if the layers were not peeled off.

### (3) Haze (HZ) [%]

The haze (HZ) (%) was measured with a Haze meter 300A (trade name) manufactured by Nippon Denshoku Industries Co., Ltd. The average of 5 measured values is shown in Tables.

(4) Amount of Stearyldiethanolamine on Surface of Freshness-Retentive Film (g/m²)

If stearyldiethanolamine was applied onto the surface of the freshness-retentive film, the amount thereof on the surface was determined from the amount of stearyldiethanolamine applied. If stearyldiethanolamine was compounded in a resin, the surface of the freshness-retentive film was washed with dichloromethane under an environment at room temperature (23° C.). The washing liquid was recovered, and was condensed. The predetermined volume thereof was extracted, and was silylated. Subsequently, the amount of stearyldiethanolamine was determined with a GC/MS manufactured by Agilent Technologies, Inc. to determine the amount of stearyldiethanolamine on the surface of the freshness-retentive film.

### Examples 1 to 7, Comparative Example 1, Reference Examples 1 to 5

Freshness-retentive films composed of a three-layer film (surface layer/intermediate layer/rear surface layer) containing a propylene-based polymer were formed of the following raw materials by the following method.

### (1) Intermediate layer

As a material for an intermediate layer, a propylene homopolymer (melting point (Tm): 160° C., MFR: 3 g/10 min (manufactured by Prime Polymer Co., Ltd.) was used.

### (2) Surface Layer and Rear Surface Layer

As a material for a surface layer and a rear surface layer, a propylene-ethylene random copolymer (melting point (Tm): 138° C., MFR: 7 g/10 min (manufactured by Prime Polymer Co., Ltd.)) was used.

These raw materials were used to form three layers composed of the two materials by melt extrusion molding, and the three layers were molded into a three-layer stretched film composed of a surface layer, an intermediate layer, and a rear surface layer with a biaxial stretching machine. In the three-layer stretched film (surface layer/intermediate layer/rear surface layer), the ratio of the thicknesses of the layers was 5/90/5, and stretching was performed under the following conditions:

stretching temperature in longitudinal stretching: 100° C.
in lateral stretching: 165° C.

heat setting temperature: 165° C.

heat setting time: 10 seconds

The surface of the surface layer of the resulting three-layer stretched film was subjected to a corona treatment. It was confirmed with a mixed solution NO. 38.0 for a wet tension test manufactured by Wako Pure Chemical Industries, Ltd. that the corona-treated surface had a wetting index of 38 dyn or more.

Next, the corona-treated surface of the surface layer of the three-layer stretched film was coated with the following coating solution. Namely, the following solution was prepared, was properly diluted, and was used as a coating solution. The solution used was prepared by dissolving stearyldiethanolamine at 50° C. in a mixed solvent of purified water/isopropyl alcohol (IPA) (mass ratio: 80/20). Coating was performed with a coating bar while the amount of coating was being controlled. The coating surface was dried with hot air at 100° C. for one minute.

The results of evaluation are shown in Table 10. The amount of stearyldiethanolamine on the surface of the freshness-retentive film was calculated from the amount of coating.

Table 10 evidently shows that in Examples 1 to 7 in which stearyldiethanolamine was present on the surface of the freshness-retentive film at 0.002 to 0.5 g/m², the number of E. coli cells after 24 hours was 1/100 times or less that of the control, and the antibacterial characteristics were confirmed. In contrast, in Comparative Example 1 in which the amount of stearyldiethanolamine was out of the range, the antibacterial characteristics were not found.

In Reference Examples 1 and 2 in which glycerol monostearate was present on the surface of freshness-retentive film at only 0.2 g/m² and 0.014 g/m², respectively, the antibacterial characteristics against E. coli were not found.

Among Reference Examples 3, 4, and 5 in which stearyldiethanolamine monostearate was present on the surface of the freshness-retentive film, the antibacterial characteristics against E. coli were found even in Reference Example 3 in which stearyldiethanolamine monostearate is present on the surface of the freshness-retentive film at 0.2 g/m². Reference Example 3, however, had the antibacterial characteristics significantly inferior to those of Example 1 in which stearyldiethanolamine was present at 0.2 g/m². Consequently, the antibacterial characteristics of stearyldiethanolamine are significantly superior to those of stearyldiethanolamine monostearate.

TABLE 10

| | | Example 1 | Example 2 | Example 3 | Example 4 | Example 5 | Example 6 | Example 7 |
|---|---|---|---|---|---|---|---|---|
| Amount of | | 2 × 10⁻¹ | 1 × 10⁻¹ | 5 × 10⁻² | 4 × 10⁻² | 2 × 10⁻² | 1 × 10⁻² | 5 × 10⁻³ |
| stearyldiethanolamine on | | | | | | | | |
| surface (g/m²) | | | | | | | | |
| Amount of glycerol | | | | | | | | |
| monostearate on surface | | | | | | | | |
| (g/m²) | | | | | | | | |
| Amount of | | | | | | | | |
| stearyldiethanolamine | | | | | | | | |
| monostearate on surface | | | | | | | | |
| (g/m²) | | | | | | | | |
| Antibacterial | Initial | 1.0 × 10⁵ | 1.0 × 10⁵ | 1.0 × 10⁵ | 1.0 × 10⁵ | 1.0 × 10⁵ | 1.0 × 10⁵ | 1.0 × 10⁵ |
| test (E. coli) | (colonies/g) | | | | | | | |
| | After 24 h | <1.0 × 10 | <1.0 × 10 | <1.0 × 10 | <1.0 × 10 | <1.0 × 10 | 5.0 × 10² | 1.1 × 10⁵ |
| | (colonies/g) | | | | | | | |
| | Control | 1.2 × 10⁷ | 1.2 × 10⁷ | 1.2 × 10⁷ | 1.2 × 10⁷ | 1.2 × 10⁷ | 1.2 × 10⁷ | 1.2 × 10⁷ |
| | (colonies/g) | | | | | | | |

| | | Comparative | Reference | Reference | Reference | Reference | Reference |
|---|---|---|---|---|---|---|---|
| | | Example 1 | Example 1 | Example 2 | Example 3 | Example 4 | Example 5 |
| Amount of | | 1 × 10⁻³ | | | | | |
| stearyldiethanolamine on | | | | | | | |
| surface (g/m²) | | | | | | | |
| Amount of glycerol | | | 2 × 10⁻¹ | 1.4 × 10⁻² | | | |
| monostearate on surface | | | | | | | |
| (g/m²) | | | | | | | |
| Amount of | | | | | 2 × 10⁻¹ | 6 × 10⁻² | 1.4 × 10⁻² |
| stearyldiethanolamine | | | | | | | |
| monostearate on surface | | | | | | | |
| (g/m²) | | | | | | | |
| Antibacterial | Initial | 1.0 × 10⁵ | 1.5 × 10⁵ | 2.7 × 10⁵ | 1.5 × 10⁵ | 1.9 × 10⁵ | 2.7 × 10⁵ |
| test (E. coli) | (colonies/g) | | | | | | |
| | After 24 h | 9.0 × 10⁶ | 1.2 × 10⁷ | 2.7 × 10⁷ | 8.1 × 10² | 9.4 × 10⁵ | 2.1 × 10⁷ |
| | (colonies/g) | | | | | | |
| | Control | 1.2 × 10⁷ | 1.2 × 10⁷ | 1.2 × 10⁷ | 1.2 × 10⁷ | 1.2 × 10⁷ | 1.2 × 10⁷ |
| | (colonies/g) | | | | | | |

### Example 8

The same propylene-based polymer raw material as that in Example 1 was used to mold a three-layer stretched film (surface layer/intermediate layer/rear surface layer) in the same manner as in Example 1. Stearyldiethanolamine was preliminarily compounded in the raw material for an intermediate layer instead of coating. Namely, the intermediate layer was prepared with a propylene homopolymer containing the following compounds including stearyldiethanolamine, the compounds being compounded in the content shown in Table 11. The following compounds were compounded using an isopropyl alcohol solution of the compounds (reagents (product name RIKEMAL series) manufactured by Riken Vitamin Co., Ltd.) to prepare a masterbatch, and the masterbatch was used.

masterbatch composition

stearyldiethanolamine: 1.9% by mass

stearyldiethanolamine monostearate: 6.0% by mass

glycerol monostearate: 2.0% by mass.

In the resulting three-layer stretched film (surface layer/intermediate layer/rear surface layer), the ratio of the thicknesses of the layers was 5/90/5, and the total thickness of all of the layers was 40 μm. The stretching was performed under the following conditions:

stretching temperature
longitudinal stretching: 100° C.
lateral stretching: 165° C.

heat setting temperature: 165° C.

heat setting time: 10 seconds

Stearyldiethanolamine was present on the surface of the surface layer of the resulting three-layer stretched film at 0.005 g/m². The results of evaluation on the three-layer stretched film are shown in Table 11.

### Comparative Example 2

A three-layer stretched film was prepared in the same manner as in Example 8 except that stearyldiethanolamine used in Example 8 was replaced with myristyldiethanolamine. The results of evaluation on the three-layer stretched film are shown in Table 11.

### Comparative Example 3

A three-layer stretched film was prepared in the same manner as in Example 8 except that stearyldiethanolamine used in Example 8 was replaced with lauryldiethanolamine. The results of evaluation on the three-layer stretched film are shown in Table 11.

### Comparative Example 4

A three-layer stretched film was prepared in the same manner as in Example 8 except that stearyldiethanolamine used in Example 8 was not compounded. The results of evaluation on the three-layer stretched film are shown in Table 11.

TABLE 11

| | | | | Comparative | Comparative | Comparative |
|---|---|---|---|---|---|---|
| | | | Example 8 | Example 2 | Example 3 | Example 4 |
| Amount | Stearyldiethanolamine | | 0.19 | | | |
| compounded in | Myristyldiethanolamine | | | 0.19 | | |
| intermediate layer | Lauryldiethanolamine | | | | 0.19 | |
| (% by mass) | Stearyldiethanolamine | | 0.6 | 0.6 | 0.6 | 0.6 |
| | monostearate | | | | | |
| | Glycerol monostearate | | 0.2 | 0.2 | 0.2 | 0.2 |
| Heat setting | | | Present | Present | Present | Present |
| Amount of stearyldiethanolamine on | | | 0.005 | | | |
| surface of surface layer (g/m²) | | | | | | |
| Antibacterial test | Initial (colonies/g) | | 1.5 × 10⁵ | 1.5 × 10⁵ | 1.5 × 10⁵ | 1.5 × 10⁵ |
| (E. coli) | After 24 h (colonies/g) | | <1.0 × 10 | <1.0 × 10 | <1.0 × 10 | 1.3 × 10⁶ |
| | Control (colonies/g) | | 1.2 × 10⁷ | 1.2 × 10⁷ | 1.2 × 10⁷ | 1.2 × 10⁷ |
| Antibacterial test | Initial (colonies/g) | | 1.3 × 10⁵ | 1.3 × 10⁵ | 1.3 × 10⁵ | 1.3 × 10⁵ |
| (Staphylococcus | After 24 h (colonies/g) | | <1.0 × 10 | <1.0 × 10 | <1.0 × 10 | 2.4 × 10⁴ |
| aureus) | Control (colonies/g) | | 1.1 × 10⁵ | 1.1 × 10⁵ | 1.1 × 10⁵ | 1.1 × 10⁵ |
| Antibacterial test | Initial (colonies/g) | | 1.0 × 10⁵ | | | |
| (Salmonella) | After 24 h (colonies/g) | | 2.2 × 10 | | | |
| | Control (colonies/g) | | 1.5 × 10⁶ | | | |
| Antibacterial test | Initial (colonies/g) | | 2.3 × 10⁵ | | | |
| (Vibrio | After 24 h (colonies/g) | | <1.0 × 10 | | | |
| parahaemolyticus) | Control (colonies/g) | | 2.1 × 10⁵ | | | |
| Blocking | | | A | B | B | A |
| Haze (%) | | | 6.1 | 14.0 | 13.4 | 6.2 |
| Freshness | Smell | Day 1 | A | | | A |
| retention test | | Day 3 | A | | | B |
| | | Day 5 | B | | | C |
| | The | Day 1 | 1.1 × 10³ | | | 5.1 × 10³ |
| | number of | Day 3 | 2.0 × 10⁴ | | | 7.0 × 10⁴ |
| | bacterial | Day 5 | 6.4 × 10⁴ | | | 2.2 × 10⁵ |
| | cells | | | | | |
| | (colonies/g) | | | | | |

Table 11 evidently shows that Example 8 in which 0.19% by mass of stearyldiethanolamine was compounded in the intermediate layer and stearyldiethanolamine was present on the surface of the freshness-retentive film at 0.005 g/m² showed high antibacterial activity against E. coli, Staphylococcus aureus, Salmonella, and Vibrio parahaemolyticus.

The cases (Comparative Examples 2 and 3) in which stearyldiethanolamine was replaced with myristyldiethanolamine or lauryldiethanolamine showed high antibacterial characteristics while excessive bleed and blocking were caused to make the haze more than 10%, thereby reducing transparency. In addition, these compounds might migrate to contents, and other results unsuitable for practical use were found. In the case (Comparative Example 4) in which stearyldiethanolamine was not used, no antibacterial activity was attained.

In Example 8 in which stearyldiethanolamine was present on the surface of the freshness-retentive film at 0.005 g/m² after heat setting, stearyldiethanolamine was further extracted with high-frequency waves, and the total amount of stearyldiethanolamine was measured. The total amount was 0.1% by mass. The result is within the range of 0.001 to 3% by mass.

Furthermore, a freshness retention test was performed by the following procedure. Namely, cabbage was cut into strips having a width of 5 mm, and was immersed in an aqueous solution of hypochlorous acid (concentration: 250 ppm) for 10 minutes to sterilize common bacteria. The films in Example 8 and Comparative Example 4 were formed into bags having a dimension of 100 mm×100 mm and a thickness of 30 μm. The sterilized cut cabbage (30 g) was placed in the respective bags. The bags were tightly sealed by heat sealing. Subsequently, the bags were stored in a refrigerator at 5° C. The bags were opened every day, and the smell was checked and the number of bacterial cells was measured. Samples were prepared for n=3×5 days. Evaluation was performed where no smell was ranked as “A,” a slight smell was ranked as “B,” and a significant smell was ranked as “C.”

On Day 1, the contents in the bags all had no smell, and had good results. The degree of the smell in the bags in Example 8 remained substantially the same level on Day 3 and Day 5 while the smell in the bags in Comparative Example 4 was getting stronger from an early point of time. Furthermore, the content, i.e., cabbage was mashed with a mortar, and was stirred in saline. The content was extracted through a filter, and was cultured with a nutrient agar. The number of colonies was counted. Since the number of bacterial cells is difficult to count one by one under a microscope, the number of colonies was counted, and was defined as the number of living bacterial cells CFU (colony forming unit). The number of bacterial cells shown was the average of three samples (n=3).

As a result, the freshness-retentive film in Example 8 having antibacterial characteristics reduced proliferation of bacteria more significantly than the freshness-retentive film in Comparative Example 4. Consequently, the freshness-retentive film of the present invention having high antibacterial characteristics can prevent mixing of bacteria during formation of bags and filling of cabbage. The freshness-retentive film of the present invention also can reduce proliferation of bacteria by the nutrient fluid of cabbage adhering to the inner surface of the packaging bag during storage.

### Example 9

### (1) Intermediate Layer

As a material for an intermediate layer, a linear low density polyethylene (LLDPE) including an ethylene-1-hexene copolymer (manufactured by Mitsui Chemicals, Inc., density: 0.920 g/cm³, MFR: 4.0 g/10 min, melting point: 117.3° C., weight average molecular weight (Mw): 71,700, molecular weight distribution (Mw/Mn): 2.48) was used.

### (2) Surface Layer and Rear Surface Layer

As a material for a rear surface layer, the LLDPE was used where 0.1% by mass (1000 ppm) of the material (a) and 0.1% by mass (1000 ppm) of the material (b) were compounded. As a material for a surface layer, the LLDPE was used where 0.1% by mass (1000 ppm) of the material (a), 0.1% by mass (1000 ppm) of the material (b), and 0.5% by mass (5000 ppm) of stearyldiethanolamine were compounded.

(a) Silica (trade name Sylysia 730 (average particle size: 3 μm) manufactured by Fuji Silysia Chemical Ltd.)
(b) Erucamide (trade name ATMER SA 1753 manufactured by Ciba Specialty Chemicals Inc.).

The materials were melt molded into a three-layer film composed of a surface layer, an intermediate layer, and a rear surface layer by casting. The molding conditions are shown as follows.

Molding Condition

die temperature of the extruder: 200° C.

chill temperature: 50° C.

The ratio of the thicknesses of the layers in the three-layer film (surface layer/intermediate layer/rear surface layer) was 1/3/1, and the total thickness of the film was 40 μm. The surface of the rear surface layer of the resulting three-layer film was subjected to a corona treatment. It was confirmed with a mixed solution NO. 38.0 of a wet tension test manufactured by Wako Pure Chemical Industries, Ltd. that the corona-treated surface had a wetting index of 38 dyn or more. The three-layer film was used in the antibacterial test against E. coli and in the measurement of the haze. The results are shown in Table 12.

### Comparative Example 5

A three-layer film was prepared in the same manner as in Example 9 except that stearyldiethanolamine used in Example 9 was not compounded in the surface layer. The results are shown in Table 12.

TABLE 12

| | | | Comparative |
|---|---|---|---|
| | | Example 9 | Example 5 |
| Amount of stearyldiethanolamine | | 0.5 | — |
| contained in surface layer (% by | | | |
| mass) | | | |
| Amount of stearyldiethanolamine on | | 2 × 10³ | — |
| surface of surface layer (g/m²) | | | |
| Antibacterial | Initial (colonies/g) | 1.3 × 10⁵ | 1.3 × 10⁵ |
| test (E. coli) | After 24 h | 5.7 × 10 | 7.9 × 10⁶ |
| | (colonies/g) | | |
| | Control (colonies/g) | 1.2 × 10⁷ | 1.2 × 10⁷ |

| | | |
|---|---|---|
| Haze (%) | 8.6 | 8.6 |

Table 12 evidently shows that Example 9 in which stearyldiethanolamine was present on the surface of the surface layer to be in contact with a content at 2×10⁻³ g/m² showed high antibacterial characteristics against E. coli. The freshness-retentive film had a haze below 10% and high transparency.

### [Experiment 3]

### <Test Method>

### (1) Antibacterial Test

An antibacterial test was performed in the same manner as in Experiment 1. Samples were kept for 24 hours at five different temperatures (5° C., 25° C., 29° C., 35° C., and 40° C.).

### Example 1, Comparative Example 1, Reference Examples 1 to 4

### (1) Intermediate Layer

As a material for an intermediate layer, a propylene homopolymer (melting point (Tm): 160° C., MFR: 3 g/10 min (manufactured by Prime Polymer Co., Ltd.)) was used.

### (2) Rear Surface Layer and Surface Layer

As a material for a rear surface layer and a surface layer, a propylene-ethylene random copolymer (melting point (Tm): 138° C., MFR: 7 g/10 min (manufactured by Prime Polymer Co., Ltd., trade name F327)) was used.

A three-layer film composed of the rear surface layer, the intermediate layer, and the surface layer was continuously molded with an extruder and a biaxial stretching machine at a ratio of the thicknesses of the layers of 1/8/1 to produce a three-layer stretched film. The stretching temperature for the three-layer stretched film was 100° C. in longitudinal stretching and 180° C. in lateral stretching. The heat setting temperature was 180° C., and the heat setting time was 10 seconds. Furthermore, the surface of the surface layer of the three-layer stretched film was subjected to a corona treatment so as to have a wetting index of 38 dyn.

In Example 1, stearyldiethanolamine (50 mol %) and diglycerol monopalmitate (50 mol %) were dissolved in a solution of purified water/isopropyl alcohol (IPA) (mass ratio: 10/90) heated to 50° C. In Comparative Example 1, stearyldiethanolamine (50 mol %) and glycerol monostearate (50 mol %) were dissolved in the solution of purified water/IPA heated to 50° C. In Reference Examples 1 to 3, stearyldiethanolamine, diglycerol palmitate, or glycerol monostearate was dissolved in the solution of purified water/IPA heated to 50° C. These solutions were applied onto the corona-treated surfaces of the surface layers of the three-layer stretched films with a coating bar such that the amounts of the respective compounds on the surfaces were as shown below. The coatings were dried by heating with hot air at 100° C. for one minute.

Example 1: stearyldiethanolamine at 0.20 g/m² and diglycerol monopalmitate at 0.20 g/m²

Comparative Example 1: stearyldiethanolamine at 0.20 g/m² and glycerol monostearate at 0.20 g/m²

Reference Example 1: stearyldiethanolamine at 0.20 g/m²

Reference Example 2: diglycerol monopalmitate at 0.20 g/m²

Reference Example 3: glycerol monostearate at 0.20 g/m²

Reference Example 4: control (sample was sandwiched between polyethylene films)

TABLE 13
Example 1

| | | Test temperature (° C.) | | | | | | |
|---|---|---|---|---|---|---|---|---|
| | | 5 | 25 | 29 | 35 | 37 | 40 | 50 |
| Anti- | Initial | 1.2 × 10⁵ | 1.5 × 10⁵ | 1.2 × 10⁵ | 1.2 × 10⁵ | 1.5 × 10⁵ | 1.6 × 10⁵ | 1.6 × 10⁵ |
| bacterial | (colonies/g) | | | | | | | |
| test | After 24 h, | 1.4 × 10³ | <1.0 × 10 | <1.0 × 10 | <1.0 × 10 | <1.0 × 10 | <1.0 × 10 | <1.0 × 10 |
| (E. coli) | n = 1 | | | | | | | |
| | (colonies/g) | | | | | | | |
| | After 24 h, | 3.6 × 10³ | <1.0 × 10 | <1.0 × 10 | <1.0 × 10 | <1.0 × 10 | <1.0 × 10 | <1.0 × 10 |
| | n = 2 | | | | | | | |
| | (colonies/g) | | | | | | | |
| | After 24 h, | 2.5 × 10³ | <1.0 × 10 | <1.0 × 10 | <1.0 × 10 | <1.0 × 10 | <1.0 × 10 | <1.0 × 10 |
| | n = 3 | | | | | | | |
| | (colonies/g) | | | | | | | |
| | Average | 2.5 × 10³ | <1.0 × 10 | <1.0 × 10 | <1.0 × 10 | <1.0 × 10 | <1.0 × 10 | <1.0 × 10 |
| | (colonies/g) | | | | | | | |
| | Fluctuation | Small | Small | Small | Small | Small | Small | Small |
| | Antibacterial | C | A | A | A | A | A | — |
| | activity | | | | | | | |

TABLE 14
Comparative Example 1

| | | Test temperature (° C.) | | | | | | |
|---|---|---|---|---|---|---|---|---|
| | | 5 | 25 | 29 | 35 | 37 | 40 | 50 |
| Anti- | Initial | 1.2 × 10⁵ | 1.2 × 10⁵ | 1.2 × 10⁵ | 1.2 × 10⁵ | 1.2 × 10⁵ | 1.6 × 10⁵ | 1.6 × 10⁵ |
| bacterial | (colonies/g) | | | | | | | |
| test | After 24 h, | 3.0 × 10³ | 4.3 × 10² | 1.0 × 10⁶ | <1.0 × 10 | 5.4 × 10⁵ | <1.0 × 10 | <1.0 × 10 |
| (E. coli) | n = 1 | | | | | | | |
| | (colonies/g) | | | | | | | |
| | After 24 h, | 1.0 × 10³ | 5.4 × 10² | 4.8 × 10² | <1.0 × 10 | <1.0 × 10 | <1.0 × 10 | <1.0 × 10 |
| | n = 2 | | | | | | | |
| | (colonies/g) | | | | | | | |
| | After 24 h, | 1.5 × 10³ | 2.6 × 10² | 3.3 × 10³ | 1.0 × 10⁶ | <1.0 × 10 | <1.0 × 10 | <1.0 × 10 |
| | n = 3 | | | | | | | |
| | (colonies/g) | | | | | | | |
| | Average | 1.8 × 10³ | 4.1 × 10² | 3.3 × 10⁵ | 3.3 × 10⁵ | 1.8 × 10⁵ | <1.0 × 10 | <1.0 × 10 |
| | (colonies/g) | | | | | | | |
| | Fluctuation | Small | Small | Large | Large | Large | Large | Small |
| | Antibacterial | C | A | B-D | A-D | A-D | A | — |
| | activity | | | | | | | |

TABLE 15
Reference Example 1

| | | Test temperature (° C.) | | | | | | |
|---|---|---|---|---|---|---|---|---|
| | | 5 | 25 | 29 | 35 | 37 | 40 | 50 |
| Anti- | Initial | 1.2 × 10⁵ | 1.5 × 10⁵ | 1.2 × 10⁵ | 1.2 × 10⁵ | 1.5 × 10⁵ | 1.6 × 10⁵ | 1.6 × 10⁵ |
| bacterial | (colonies/g) | | | | | | | |
| test | After 24 h, | 2.1 × 10³ | <1.0 × 10 | <1.0 × 10 | <1.0 × 10 | <1.0 × 10 | <1.0 × 10 | <1.0 × 10 |
| (E. coli) | n = 1 | | | | | | | |
| | (colonies/g) | | | | | | | |
| | After 24 h, | 3.4 × 10³ | <1.0 × 10 | <1.0 × 10 | <1.0 × 10 | <1.0 × 10 | <1.0 × 10 | <1.0 × 10 |
| | n = 2 | | | | | | | |
| | (colonies/g) | | | | | | | |
| | After 24 h, | 2.3 × 10³ | <1.0 × 10 | <1.0 × 10 | <1.0 × 10 | <1.0 × 10 | <1.0 × 10 | <1.0 × 10 |
| | n = 3 | | | | | | | |
| | (colonies/g) | | | | | | | |
| | Average | 2.6 × 10³ | <1.0 × 10 | <1.0 × 10 | <1.0 × 10 | <1.0 × 10 | <1.0 × 10 | <1.0 × 10 |
| | (colonies/g) | | | | | | | |
| | Fluctuation | None | None | None | None | None | None | None |
| | Antibacterial | B | A | A | A | A | A | — |
| | activity | | | | | | | |

TABLE 16
Reference Example 2

| | | Test temperature (° C.) | | | | | | |
|---|---|---|---|---|---|---|---|---|
| | | 5 | 25 | 29 | 35 | 37 | 40 | 50 |
| Anti- | Initial | 1.2 × 10⁵ | 1.5 × 10⁵ | 1.2 × 10⁵ | 1.2 × 10⁵ | 1.5 × 10⁵ | 1.6 × 10⁵ | 1.6 × 10⁵ |
| bacterial | (colonies/g) | | | | | | | |
| test | After 24 h, | 6.1 × 10⁴ | 2.6 × 10⁵ | 1.3 × 10⁶ | 1.3 × 10⁷ | 5.4 × 10⁶ | 2.4 × 10⁶ | <1.0 × 10 |
| (E. coli) | n = 1 | | | | | | | |
| | (colonies/g) | | | | | | | |
| | After 24 h, | 7.5 × 10⁴ | 3.0 × 10⁵ | 1.1 × 10⁶ | 8.4 × 10⁶ | 5.9 × 10⁶ | 1.7 × 10⁶ | <1.0 × 10 |
| | n = 2 | | | | | | | |
| | (colonies/g) | | | | | | | |
| | After 24 h, | 8.4 × 10⁴ | 6.2 × 10⁵ | 2.1 × 10⁶ | 7.9 × 10⁶ | 5.8 × 10⁶ | 1.9 × 10⁶ | <1.0 × 10 |
| | n = 3 | | | | | | | |
| | (colonies/g) | | | | | | | |
| | Average | 7.3 × 10⁴ | 3.9 × 10⁵ | 1.5 × 10⁶ | 9.8 × 10⁶ | 5.7 × 10⁶ | 2.0 × 10⁶ | <1.0 × 10 |
| | (colonies/g) | | | | | | | |
| | Fluctuation | Small | Small | Small | Small | Small | Small | Small |
| | Antibacterial | D | D | D | D | D | D | — |
| | activity | | | | | | | |

TABLE 17
Reference Example 3

| | | Test temperature (° C.) | | | | | | |
|---|---|---|---|---|---|---|---|---|
| | | 5 | 25 | 29 | 35 | 37 | 40 | 50 |
| Anti- | Initial | 1.2 × 10⁵ | 1.5 × 10⁵ | 1.2 × 10⁵ | 1.2 × 10⁵ | 1.2 × 10⁵ | 1.6 × 10⁵ | 1.6 × 10⁵ |
| bacterial | (colonies/g) | | | | | | | |
| test | After 24 h, | 5.9 × 10⁴ | 2.8 × 10⁵ | 1.1 × 10⁶ | 1.0 × 10⁷ | 4.6 × 10⁶ | 2.3 × 10⁶ | <1.0 × 10 |
| (E. coli) | n = 1 | | | | | | | |
| | (colonies/g) | | | | | | | |
| | After 24 h, | 8.8 × 10⁴ | 2.1 × 10⁵ | 1.8 × 10⁶ | 1.3 × 10⁷ | 8.2 × 10⁶ | 1.8 × 10⁶ | <1.0 × 10 |
| | n = 2 | | | | | | | |
| | (colonies/g) | | | | | | | |
| | After 24 h, | 8.8 × 10⁴ | 9.2 × 10⁵ | 4.3 × 10⁶ | 1.1 × 10⁷ | 7.2 × 10⁶ | 2.1 × 10⁶ | <1.0 × 10 |
| | n = 3 | | | | | | | |
| | (colonies/g) | | | | | | | |
| | Average | 7.8 × 10⁴ | 4.7 × 10⁵ | 2.4 × 10⁶ | 1.1 × 10⁷ | 6.7 × 10⁶ | 2.1 × 10⁶ | <1.0 × 10 |
| | (colonies/g) | | | | | | | |
| | Fluctuation | Small | Small | Small | Small | Small | Small | Small |
| | Antibacterial | D | D | D | D | D | D | — |
| | activity | | | | | | | |

TABLE 18
Reference Example 4

| | | Test temperature (° C.) | | | | | | |
|---|---|---|---|---|---|---|---|---|
| | | 5 | 25 | 29 | 35 | 37 | 40 | 50 |
| Anti- | Initial | 1.2 × 10⁵ | 1.2 × 10⁵ | 1.2 × 10⁵ | 1.2 × 10⁵ | 1.2 × 10⁵ | 1.6 × 10⁵ | 1.6 × 10⁵ |
| bacterial | (colonies/g) | | | | | | | |
| test | After 24 h, | 1.1 × 10⁵ | 1.3 × 10⁶ | 3.9 × 10⁶ | 2.2 × 10⁷ | 3.6 × 10⁷ | 1.6 × 10⁶ | <1.0 × 10 |
| (E. coli) | n = 1 | | | | | | | |
| | (colonies/g) | | | | | | | |
| | After 24 h, | 1.2 × 10⁵ | 1.6 × 10⁶ | 2.0 × 10⁶ | 2.1 × 10⁷ | 3.7 × 10⁷ | 1.0 × 10⁶ | <1.0 × 10 |
| | n = 2 | | | | | | | |
| | (colonies/g) | | | | | | | |
| | After 24 h, | 9.2 × 10⁴ | 1.5 × 10⁶ | 1.8 × 10⁶ | 1.4 × 10⁷ | 5.1 × 10⁷ | 1.1 × 10⁶ | <1.0 × 10 |
| | n = 3 | | | | | | | |
| | (colonies/g) | | | | | | | |
| | Average | 1.1 × 10⁵ | 1.5 × 10⁶ | 2.6 × 10⁶ | 1.9 × 10⁷ | 4.1 × 10⁷ | 1.2 × 10⁶ | <1.0 × 10 |
| | (colonies/g) | | | | | | | |
| | Fluctuation | Small | Small | Small | Small | Small | Small | Small |

The results shown in Tables 13 to 18 will be described. In comparison of Reference Examples 1 to 3 in which single components were applied,

Reference Example 1 (stearyldiethanolamine at 0.20 g/m²) had antibacterial characteristics. Reference Example 2 (diglycerol monopalmitate at 0.20 g/m²) and Reference Example 3 (glycerol monostearate at 0.20 g/m²) had antibacterial characteristics substantially identical to those of Reference Example 4 (control (sample was sandwiched between PE films)).

In comparison among the temperatures, at 5° C., an increase in the number of bacterial cells was small in Reference Example 4 (control). In Reference Example 1 (stearyldiethanolamine at 0.20 g/m²), the number of bacteria was large, and the antibacterial activity was not sufficiently demonstrated. It is presumed that a sufficient amount of stearyldiethanolamine did not bleed due to a low temperature. At 37° C., the number of bacteria in the control was largest. At 50° C., the number of bacterial cells was <1.0×10 because bacteria were dead at this temperature.

Next, the numbers of bacteria at temperatures were equal in Example 1 (stearyldiethanolamine at 0.20 g/m² and diglycerol monopalmitate at 0.20 g/m²) and Reference Example 1 (stearyldiethanolamine at 0.20 g/m²). Apparently, diglycerol monopalmitate at 0.20 g/m² does not inhibit the antibacterial activity of stearyldiethanolamine at 0.20 g/m².

If bleeding out of stearyldiethanolamine kneaded in another compound to the surface of the film is caused, a variety of glycerol esters are preferably kneaded with stearyldiethanolamine to reduce the amount of stearyldiethanolamine. The results show that use of diglycerol monopalmitate for this kneading does not inhibit the antibacterial activity of stearyldiethanolamine in bleed out thereof to the surface of the film.

In Comparative Example 1 (stearyldiethanolamine at 0.20 g/m² and glycerol monostearate at 0.20 g/m²), the number of bacterial cells at 25° C. was larger about 1.0×10² times, and the number of bacterial cells was also large at 29° C., 35° C., and 37° C. Although the sample was uniformly coated, the fluctuation in the number of bacterial cells was large, which evidently indicates that glycerol monostearate at 0.20 g/m² inhibits the antibacterial activity of stearyldiethanolamine at 0.20 g/m².

The results show that if glycerol monostearate is used to knead stearyldiethanolamine in another compound, glycerol monostearate inhibits the antibacterial activity of stearyldiethanolamine in bleed out thereof to the surface of the film.

### [Experiment 4]

### <Test Method>

### (1) Melt Flow Rate (MFR) (g/10 min)

The melt flow rate was determined by the method specified in ASTM D1238.

### (2) Density (g/cm³)

The density was determined by the method specified in ASTM D1505.

### (3) Determination of Amount of Stearyldiethanolamine on Surface

The surface of a sample film to be measured was washed with dichloromethane under an environment at room temperature (23° C.). The washing liquid was recovered, and was condensed. The predetermined volume thereof was extracted, and was silylated. The amount of stearyldiethanolamine was determined by a GC/MS manufactured by Agilent Technologies, Inc. At this time, the peak of the silyl compound in stearyldiethanolamine overlapped the peak of the silyl compound of diglycerol oleate. For this reason, the amount was determined with a GC/MS extraction ion chromatogram.

### (4) Antibacterial Test

An antibacterial test was performed in the same manner as in Experiment 1.

### Example 1

### Preparation of Masterbatch for Adhesive (C)

A composition containing 50% by mass of a linear low density polyethylene (A) [manufactured by Mitsui Chemicals, Inc., density: 0.920 g/cm³, MFR at 190° C. and a load of 2.16 kg: 4.0 g/10 min] and 50% by mass of an aromatic hydrocarbon resin [manufactured by ARAKAWA CHEMICAL INDUSTRIES, LTD., trade name ARKON A100] as an adhesive (C) was kneaded with a twin screw extruder at a resin temperature of 200° C. to be granulated. A masterbatch (MC) was prepared.

### (Preparation of Masterbatch for Antifog Additive (D))

A composition containing 90% by mass of a linear low density polyethylene (A) [manufactured by Mitsui Chemicals, Inc., density: 0.920 g/cm³, MFR at 190° C. and a load of 2.16 kg: 4.0 g/10 min] and 10% by mass of diglycerol oleate [manufactured by Riken Vitamin Co., Ltd., trade name 0-71-DE] as an antifog additive (D) was kneaded with a twin screw extruder at resin temperature of 200° C. to be granulated. A masterbatch (MD) was prepared.

### (Preparation of Masterbatch for Specific Compound (E))

A composition containing 90% by mass of a linear low density polyethylene (A) [manufactured by Mitsui Chemicals, Inc., density: 0.920 g/cm³, MFR at 190° C. and a load of 2.16 kg: 4.0 g/10 min] and 10% by mass of stearyldiethanolamine [TOKYO CHEMICAL INDUSTRY CO., LTD.] as the specific compound (E) was kneaded with a twin screw extruder at a resin temperature of 200° C. to be granulated. A masterbatch (ME) was prepared.

### (Preparation of Resin Composition)

The following materials were mixed to prepare a resin composition.

linear low density polyethylene (A) [manufactured by Mitsui Chemicals, Inc., density: 0.920 g/cm³, MFR at 190° C. and a load of 2.16 kg: 4.0 g/10 min] 39 parts by mass

high pressure low density polyethylene (B) [manufactured by DU PONT-MITSUI POLYCHEMICALS CO., LTD., density: 0.917 g/cm³, MFR at 190° C. and a load of 2.16 kg: 7.2 g/10 min] 30 parts by mass

masterbatch (MC) 10 parts by mass

masterbatch (MD) 25 parts by mass

masterbatch (ME) 5 parts by mass.

The resin composition contained 70% by mass of (A) and 30% by mass of (B) where the total of (A) and (B) was 100% by mass. In the resin composition, 5 parts by mass of (C), 2.5 parts by mass of (D), and 0.5 parts by mass of (E) were contained relative to 100 parts by mass of the total amount of (A) and (B).

### (Molding of Freshness-Retentive Film)

The resin composition was extrusion molded with an extruder equipped with a T die at a molding resin temperature of 250° C., a cast roll temperature of 25° C., a stretching ratio of 1.2, and a take-up rate of 200 m/min to form a single-layer film having a thickness of 13 μm. A freshness-retentive film was prepared.

### Comparative Example 1

A freshness-retentive film was prepared in the same manner as in Example 1 except that 5 parts by mass of the masterbatch (ME) was replaced with 4.5 parts by mass of a linear low density polyethylene (A) [manufactured by Mitsui Chemicals, Inc., density: 0.920 g/cm³, MFR at 190° C. and a load of 2.16 kg: 4.0 g/10 min].

The resulting freshness-retentive film was evaluated for the respective characteristics by the methods described above. The results of evaluation are shown in Table 19.

TABLE 19

| | | | Comparative |
|---|---|---|---|
| | | Example 1 | Example 1 |
| Specific compound (E) | | Stearyldiethanolamine | None |
| | | 5000 ppm | |
| Amount of specific compound (E) | | 0.010 | 0 |
| on surface (g/m²) | | | |
| Thickness of freshness-retentive | | 13 | 13 |
| film (μm) | | | |
| Antibacterial | Initial | 1.0 × 10⁵ | 1.0 × 10⁵ |
| test (E. coli) | (colonies/g) | | |
| | After 24 h, n = | <1.0 × 10 | 6.5 × 10⁶ |
| | 1 (colonies/g) | | |
| | After 24 h, n = | <1.0 × 10 | 3.5 × 10⁶ |
| | 2 (colonies/g) | | |
| | After 24 h, n = | <1.0 × 10 | 1.5 × 10⁶ |
| | 3 (colonies/g) | | |
| | Average | <1.0 × 10 | 3.8 × 10⁶ |
| | (colonies/g) | | |
| | Antibacterial | A | D |
| | activity | | |
| | Control | 1.4 × 10⁷ | 1.4 × 10⁷ |
| | (colonies/g) | | |
| Antibacterial | Initial | 1.1 × 10⁵ | 1.1 × 10⁵ |
| test | (colonies/g) | | |
| (Staphylococcus | After 24 h, n = | <1.0 × 10 | 8.5 × 10⁴ |
| aureus) | 1 (colonies/g) | | |
| | After 24 h, n = | <1.0 × 10 | 1.8 × 10⁴ |
| | 2 (colonies/g) | | |
| | After 24 h, n = | <1.0 × 10 | 6.3 × 10⁴ |
| | 3 (colonies/g) | | |
| | Average | <1.0 × 10 | 5.5 × 10⁴ |
| | (colonies/g) | | |
| | Antibacterial | A | D |
| | activity | | |
| | Control | 1.6 × 10⁵ | 1.6 × 10⁵ |
| | (colonies/g) | | |

Table 19 evidently shows that in Example 1 in which stearyldiethanolamine was present on the surface of the freshness-retentive film at 0.010 g/m², the number of E. coli cells and that of Staphylococcus aureus cells after 24 hours were 1/100 or less of those of the control, and the antibacterial characteristics were confirmed. In contrast, in Comparative Example 1 in which the specific compound (E) was not present on the surface of the film, the antibacterial characteristics were not found.

### [Experiment 5]

### <Test Method>

### (1) Antibacterial Test

An antibacterial test was performed in the same manner as in Experiment 1.

### Examples 1 to 10, Comparative Example 1, Reference Example 1>

### (1) Intermediate Layer

### (a) Polyethylene-Based Polymer (PE-Based)

As a material for an intermediate layer, a linear low density polyethylene (manufactured by Mitsui Chemicals, Inc., density: 0.920 g/cm³, MFR: 4.0 g/10 min, melting point: 117.3° C.) was used.

### (b) Polypropylene-Based Polymer (PP-Based)

As a material for an intermediate layer, a propylene-ethylene random copolymer (manufactured by Prime Polymer Co., Ltd., melting point (Tm): 138° C., MFR: 7 g/10 min) was used.

### (2) Surface Layer and Rear Surface Layer

### (a) Polyethylene-Based Polymer (PE-Based)

A material containing the linear low density polyethylene, 1000 ppm of silica (trade name Sylysia 730 (average particle size: 3 μm) manufactured by Fuji Silysia Chemical Ltd.), and 1000 ppm of erucamide (trade name ATMER SA 1753 manufactured by Ciba Specialty Chemicals Inc.) was used.

### (b) Polypropylene-Based Polymer (PP-Based)

A material containing the propylene-ethylene random copolymer, 1000 ppm of the silica, and 1000 ppm of the erucamide was used.

### (3) Antibacterial Component

The antibacterial component was compounded in the masterbatch such that the antibacterial component was contained in the respective layers in an amount shown in Tables 20 and 21.

(a) stearyldiethanolamine (C18 DEA)

manufactured by Riken Vitamin Co., Ltd.

(b) mixture of myristyldiethanolamine and stearyldiethanolamine (molar ratio: 4/6) (C16/C18 DEA)

manufactured by Riken Vitamin Co., Ltd.

(c) mixture of myristyldiethanolamine monostearate and stearyldiethanolamine amine monostearate (molar ratio: 4/6) (C16/C18 DEA-MS)

manufactured by Riken Vitamin Co., Ltd.

### (4) Molding of Freshness-Retentive Film (PE-Based, PP-Based)

The respective materials were used to produce a three-layer cast film composed of the rear surface layer, the intermediate layer, and the surface layer at a ratio of the thicknesses of the layers of 1/3/1. A PE-based freshness-retentive film was molded at a die temperature of the extruder of 200° C. and a chill temperature of 50° C. A PP-based freshness-retentive film was molded at a die temperature of the extruder of 230° C. and a chill temperature of 20° C. The surface of the rear surface layer (laminate layer) of the resulting freshness-retentive film was subjected to a corona treatment. It was confirmed with a mixed solution NO. 38.0 for a wet tension test manufactured by Wako Pure Chemical Industries, Ltd. that the corona-treated surface had a wetting index of 38 dyn or more.

The freshness-retentive film was subjected to an antibacterial test. The results are shown in Tables 20 and 21. Examples 1 to 10 showed sufficient antibacterial characteristics, which evidently indicates that the antibacterial component was present on the surface of the freshness-retentive film at 0.002 to 0.5 g/m².

TABLE 20

| | | Comparative | | | | | Reference |
|---|---|---|---|---|---|---|---|
| | | Example 1 | Example 1 | Example 2 | Example 3 | Example 4 | Example 1 |
| Rear surface | C18DEA (ppm) | | | | | | |
| layer | C16/C18DEA | | | | | | |
| | (ppm) | | | | | | |
| | C18/C16DEA-MS | | | | | | |
| | (ppm) | | | | | | |
| Intermediate | C18DEA (ppm) | | | | | | |
| layer | C16/C18DEA | | | | | | |
| | (ppm) | | | | | | |
| | C18/C16DEA-MS | | | | | | |
| | (ppm) | | | | | | |
| Surface | C18DEA (ppm) | | 2000 | | 1000 | | |
| layer | C16/C18DEA | | | 2000 | | 1000 | |
| | (ppm) | | | | | | |
| | C18/C16DEA-MS | | | | | | 2000 |
| | (ppm) | | | | | | |
| Antibacterial | Initial (colonies/g) | 1.2 × 10⁵ | 1.2 × 10⁵ | 1.2 × 10⁵ | 1.2 × 10⁵ | 1.2 × 10⁵ | 1.2 × 10⁵ |
| test (E. coli) | After 24 h, n = 1 | 1.0 × 10⁷ | <1.0 × 10 | <1.0 × 10 | 3.9 × 10² | 6.5 × 10⁴ | 2.8 × 10⁶ |
| PE-based | (colonies/g) | | | | | | |
| | After 24 h, n = 2 | 8.4 × 10⁶ | <1.0 × 10 | <1.0 × 10 | 7.0 × 10² | 7.8 × 10⁴ | 1.9 × 10⁶ |
| | (colonies/g) | | | | | | |
| | After 24 h, n = 3 | 9.3 × 10⁶ | 6.6 × 10⁴ | <1.0 × 10 | 6.9 × 10⁴ | 1.5 × 10⁵ | 3.1 × 10⁶ |
| | (colonies/g) | | | | | | |
| | Average | 9.2 × 10⁶ | — | <1.0 × 10 | — | 9.8 × 10⁴ | 2.6 × 10⁶ |
| | (colonies/g) | | | | | | |
| | Control (colonies/g) | 1.7 × 10⁷ | 1.7 × 10⁷ | 1.7 × 10⁷ | 1.7 × 10⁷ | 1.7 × 10⁷ | 1.7 × 10⁷ |
| Antibacterial | Initial (colonies/g) | 1.2 × 10⁵ | 1.2 × 10⁵ | 1.2 × 10⁵ | 1.2 × 10⁵ | 1.2 × 10⁵ | 1.2 × 10⁵ |
| test (E. coli) | After 24 h, n = 1 | 2.7 × 10⁶ | 3.2 × 10⁵ | <1.0 × 10 | 9.1 × 10⁵ | 6.6 × 10⁵ | 8.3 × 10⁵ |
| PP-based | (colonies/g) | | | | | | |
| | After 24 h, n = 2 | 5.3 × 10⁶ | 6.4 × 10⁵ | <1.0 × 10 | 1.2 × 10⁶ | 2.1 × 10⁴ | 2.4 × 10⁶ |
| | (colonies/g) | | | | | | |
| | After 24 h, n = 3 | 3.9 × 10⁶ | 1.1 × 10⁴ | 1.1 × 10⁵ | 5.7 × 10⁵ | 3.1 × 10⁵ | 1.5 × 10⁵ |
| | (colonies/g) | | | | | | |
| | Average | 9.2 × 10⁶ | — | <1.0 × 10 | 8.9 × 10⁵ | — | 2.6 × 10⁶ |
| | (colonies/g) | | | | | | |
| | Control (colonies/g) | 1.7 × 10⁷ | 1.7 × 10⁷ | 1.7 × 10⁷ | 1.2 × 10⁷ | 1.2 × 10⁷ | 1.7 × 10⁷ |

TABLE 21

| | | | | | | | Example |
|---|---|---|---|---|---|---|---|
| | | Example 5 | Example 6 | Example 7 | Example 8 | Example 9 | 10 |
| Rear surface | C18DEA (ppm) | | | | | | |
| layer | C16/C18DEA (ppm) | | | | | | 1000 |
| | C18/C16DEA-MS | | | | | | 4000 |
| | (ppm) | | | | | | |
| Intermediate | C18DEA (ppm) | | | | | | |
| layer | C16/C18DEA (ppm) | | | | | 1000 | 1000 |
| | C18/C16DEA-MS | | | | | 4000 | 4000 |
| | (ppm) | | | | | | |
| Surface | C18DEA (ppm) | | | 1000 | 1000 | | |
| layer | C16/C18DEA (ppm) | 1000 | 1000 | | | 1000 | 1000 |
| | C18/C16DEA-MS | 2000 | 4000 | 2000 | 4000 | 4000 | 4000 |
| | (ppm) | | | | | | |
| Antibacterial | Initial (colonies/g) | 1.2 × 10⁵ | 1.2 × 10⁵ | 1.2 × 10⁵ | — | 1.2 × 10⁵ | 1.2 × 10⁵ |
| test (E. coli) | After 24 h, n = 1 | <1.0 × 10 | <1.0 × 10 | <1.0 × 10 | — | <1.0 × 10 | <1.0 × 10 |
| PE-based | (colonies/g) | | | | | | |
| | After 24 h, n = 2 | 4.3 × 10² | 5.6 × 10² | — | — | <1.0 × 10 | <1.0 × 10 |
| | (colonies/g) | | | | | | |
| | After 24 h, n = 3 | 1.9 × 10⁵ | 2.1 × 10⁵ | — | — | 3.5 × 10³ | 3.8 × 10⁴ |
| | (colonies/g) | | | | | | |
| | Average (colonies/g) | — | — | — | — | — | — |
| | Control (colonies/g) | 1.7 × 10⁷ | 1.7 × 10⁷ | 1.7 × 10⁷ | — | 1.2 × 10⁷ | 1.2 × 10⁷ |
| Antibacterial | Initial (colonies/g) | 1.2 × 10⁵ | 1.2 × 10⁵ | 1.2 × 10⁵ | 1.2 × 10⁵ | 1.2 × 10⁵ | 1.2 × 10⁵ |
| test (E. coli) | After 24 h, n = 1 | <1.0 × 10 | <1.0 × 10 | 6.5 × 10² | <1.0 × 10 | <1.0 × 10 | <1.0 × 10 |
| PP-based | (colonies/g) | | | | | | |
| | After 24 h, n = 2 | 8.4 × 10³ | <1.0 × 10 | <1.0 × 10 | <1.0 × 10 | <1.0 × 10 | <1.0 × 10 |
| | (colonies/g) | | | | | | |
| | After 24 h, n = 3 | <1.0 × 10 | <1.0 × 10 | 7.3 × 10³ | <1.0 × 10 | <1.0 × 10 | <1.0 × 10 |
| | (colonies/g) | | | | | | |
| | Average (colonies/g) | — | <1.0 × 10 | — | <1.0 × 10 | <1.0 × 10 | <1.0 × 10 |
| | Control (colonies/g) | 1.2 × 10⁷ | 1.2 × 10⁷ | 1.2 × 10⁷ | 1.2 × 10⁷ | 1.2 × 10⁷ | 1.2 × 10⁷ |

### [Experiment 6]

### <Test Method>

### (1) Antibacterial Test

An antibacterial test was performed in the same manner as in Experiment 1. Samples were kept for 24 hours at two different temperatures (25° C. and 35° C.).

### Examples 1 to 3

### (1) Intermediate Layer

As a material for an intermediate layer, a propylene homopolymer (manufactured by Prime Polymer Co., Ltd., melting point (Tm): 160° C., MFR: 3 g/10 min) was used.

### (2) Surface Layer and Rear Surface Layer

As a material for a surface layer and a rear surface layer, a propylene-ethylene random copolymer (manufactured by Prime Polymer Co., Ltd., melting point (Tm): 138° C., MFR: 7 g/10 min) was used.

### (3) Antibacterial Component

The following antibacterial components were compounded in the masterbatch such that the antibacterial components were contained in the intermediate layer in the amounts shown in Table 22.

(a) stearyldiethanolamine (C18 DEA) manufactured by Riken Vitamin Co., Ltd.
(b) stearyldiethanolamine monostearate (C18 DEA-MS) manufactured by Riken Vitamin Co., Ltd.

### (4) Bleed Promoting Component

The following bleed promoting components were compounded in the masterbatch such that the bleed promoting components were contained in the intermediate layer in the amounts shown in Table 22.

(a) glycerol monostearate (C18 MG) manufactured by Riken Vitamin Co., Ltd.
(b) glycerol monopalmitate (C16 MG) manufactured by Riken Vitamin Co., Ltd.
(c) diglycerol monopalmitate (C16 DG) manufactured by Riken Vitamin Co., Ltd.

### (5) Molding of Freshness-Retentive Film

A three-layer film composed of the rear surface layer, the intermediate layer, and the surface layer was continuously molded with a biaxial stretching machine at a ratio of the thicknesses of the layers of 1/8/1 to produce a freshness-retentive film composed of a multi-layer stretched film. The thickness of the film after stretching was 30 μm. The stretching temperature for the freshness-retentive film was 100° C. in longitudinal stretching and 180° C. in lateral stretching. The heat setting temperature was 180° C., and the heat setting time was 10 seconds. The surface of the surface layer of the resulting freshness-retentive film was subjected to a corona treatment. It was confirmed with a mixed solution NO. 38.0 for a wet tension test manufactured by Wako Pure Chemical Industries, Ltd. that the corona-treated surface had a wetting index of 38 dyn or more.

The freshness-retentive film was subjected to an antibacterial test. The results are shown in Table 22. Examples 1 to 3 showed sufficient antibacterial characteristics, which evidently indicates that the antibacterial component was present on the surface of the freshness-retentive film at 0.002 to 0.5 g/m². In Example 2, the film had low molding characteristics during molding.

TABLE 22

| | | Example 1 | Example 2 | Example 3 |
|---|---|---|---|---|
| C18MG | | 2400 | | |
| C16MG | | | 2400 | |
| C16DG | | | | 2400 |
| C18DEA | | 2000 | 1000 | 1000 |
| C18DEA-MS | | 5000 | 5000 | 5000 |
| Anti- | Initial (colonies/g) | 1.8 × 10⁵ | 1.8 × 10⁵ | 1.8 × 10⁵ |
| bacterial | After 24 h, n = 1 | 2.3 × 10³ | 1.0 × 10⁵ | <1.0 × 10 |
| test | (colonies/g) | | | |
| (E. coli) | After 24 h, n = 2 | 3.8 × 10⁵ | 2.4 × 10⁶ | <1.0 × 10 |
| 35° C. | (colonies/g) | | | |
| | After 24 h, n = 3 | 6.7 × 10⁴ | 2.1 × 10⁵ | 2.6 × 10⁴ |
| | (colonies/g) | | | |
| | Average | — | — | — |
| | (colonies/g) | | | |
| | Control | 1.2 × 10⁷ | 1.2 × 10⁷ | 1.2 × 10⁷ |
| | (colonies/g) | | | |
| Anti- | Initial (colonies/g) | 1.1 × 10⁵ | 1.1 × 10⁵ | 1.1 × 10⁵ |
| bacterial | After 24 h, n = 1 | 1.1 × 10² | 3.8 × 10² | <1.0 × 10 |
| test | (colonies/g) | | | |
| (E. coli) | After 24 h, n = 2 | 1.0 × 10⁶ | <1.0 × 10 | <1.0 × 10 |
| 25° C. | (colonies/g) | | | |
| | After 24 h, n = 3 | 9.4 × 10⁵ | <1.0 × 10 | <1.0 × 10 |
| | (colonies/g) | | | |
| | Average | — | — | <1.0 × 10 |
| | (colonies/g) | | | |
| | Control | 1.2 × 10⁶ | 1.2 × 10⁶ | 1.2 × 10⁶ |
| | (colonies/g) | | | |

| | | | |
|---|---|---|---|
| Molding characteristics | ◯ | X | ◯ |

### [Experiment 7]

### <Test Method>

### (1) Antibacterial Test

An antibacterial test was performed in the same manner as in Experiment 1.

### Examples 1 to 7, Comparative Example 1

### (1) Intermediate Layer

As a material for an intermediate layer, a linear low density polyethylene (manufactured by Mitsui Chemicals, Inc., density: resin density shown in Table 23, MFR: 4.0 g/10 min, melting point: 117.3° C.) was used.

### (2) Surface Layer and Rear Surface Layer

As a material for a surface layer and a rear surface layer, a material containing the linear low density polyethylene, 1000 ppm of silica (trade name Sylysia 730 (average particle size: 3 μm) manufactured by Fuji Silysia Chemical Ltd.), and 1000 ppm of erucamide (trade name ATMER SA 1753 manufactured by Ciba Specialty Chemicals Inc.) was used.

### (3) Additives

The following antibacterial component was compounded in the masterbatch such that the antibacterial component was contained in the respective layers in the amounts shown in Table 23.

(a) stearyldiethanolamine (C18 DEA)

manufactured by Riken Vitamin Co., Ltd.

In Example 7, an antifog additive was compounded in the masterbatch such that 0.07% by mass of the antifog additive (a polyethylene-based masterbatch containing 7% by mass of C16/C18 diglycerol lide and 3% by mass of di/trioxyethylene sorbitan fatty acid ester) was contained in the surface layer.

### (4) Molding of Freshness-Retentive Film

The respective materials were used to produce a three-layer cast film composed of the rear surface layer, the intermediate layer, and the surface layer at a ratio of the thicknesses of the layers of 1/3/1. The freshness-retentive film was molded at a die temperature of the extruder of 200° C. and a chill temperature of 50° C. The surface of the rear surface layer of the resulting freshness-retentive film was subjected to a corona treatment. It was confirmed with a mixed solution NO. 38.0 for a wet tension test manufactured by Wako Pure Chemical Industries, Ltd. that the corona-treated surface had a wetting index of 38 dyn or more.

The freshness-retentive film was subjected to an antibacterial test. The results are shown in Table 23. Examples 1 to 7 showed sufficient antibacterial characteristics, which evidently indicates that the antibacterial component was present on the surface of the freshness-retentive film at 0.002 to 0.5 g/m².

TABLE 23

| | | Comparative | | | | | | | |
|---|---|---|---|---|---|---|---|---|---|
| | | Example 1 | Example 1 | Example 2 | Example 3 | Example 4 | Example 5 | Example 6 | Example 7 |
| Thickness of | | 30 | 30 | 30 | 30 | 30 | 30 | 30 | 30 |
| freshness-retentive film | | | | | | | | | |
| (μm) | | | | | | | | | |
| Rear surface | Resin | 920 | 920 | 920 | 920 | 940 | 935 | 940 | 920 |
| layer | density | | | | | | | | |
| | (g/cm³) | | | | | | | | |
| | C18DEA | | | | 1000 | | | | |
| | (ppm) | | | | | | | | |
| Intermediate | Resin | 920 | 920 | 920 | 920 | 940 | 935 | 940 | 940 |
| layer | density | | | | | | | | |
| | (g/cm³) | | | | | | | | |
| | C18DEA | | | 1000 | 1000 | | 1000 | 1000 | 1000 |
| | (ppm) | | | | | | | | |
| Surface layer | Resin | 920 | 920 | 920 | 920 | 920 | 920 | 920 | 920 |
| | density | | | | | | | | |
| | (g/cm³) | | | | | | | | |
| | C18DEA | | 1000 | 1000 | 1000 | 1000 | 1000 | 1000 | 1000 |
| | (ppm) | | | | | | | | |
| Antibacterial | Initial | 1.4 × 10⁵ | 1.4 × 10⁵ | 1.4 × 10⁵ | 1.4 × 10⁵ | 1.4 × 10⁵ | 1.4 × 10⁵ | 1.2 × 10⁵ | 1.2 × 10⁵ |
| test (E. coli) | (colonies/g) | | | | | | | | |
| | After 24 h, n = 1 | 9.3 × 10⁴ | <1.0 × 10 | 6.5 × 10² | <1.0 × 10 | <1.0 × 10 | <1.0 × 10 | <1.0 × 10 | <1.0 × 10 |
| | (colonies/g) | | | | | | | | |
| | After 24 h, n = 2 | 8.6 × 10⁵ | 2.6 × 10⁵ | 3.8 × 10² | <1.0 × 10 | <1.0 × 10 | 2.6 × 10⁴ | 8.5 × 10⁴ | <1.0 × 10 |
| | (colonies/g) | | | | | | | | |
| | After 24 h, n = 3 | 7.3 × 10⁵ | 3.7 × 10⁴ | 1.4 × 10³ | 1.2 × 10² | 3.3 × 10³ | <1.0 × 10 | <1.0 × 10 | 1.3 × 10⁴ |
| | (colonies/g) | | | | | | | | |
| | Average | — | — | 8.1 × 10² | — | — | — | — | — |
| | (colonies/g) | | | | | | | | |
| | Control | 1.2 × 10⁷ | 1.2 × 10⁷ | 1.2 × 10⁷ | 1.2 × 10⁷ | 1.2 × 10⁷ | 1.2 × 10⁷ | 1.7 × 10⁷ | 1.7 × 10⁷ |
| | (colonies/g) | | | | | | | | |

### [Experiment 8]

### <Test Method>

### (1) Antibacterial Test

An antibacterial test was performed in the same manner as in Experiment 1.

### Example 1, Comparative Examples 1 to 5

### (1) Intermediate layer

As a material for an intermediate layer, a propylene homopolymer (manufactured by Prime Polymer Co., Ltd., melting point (Tm): 160° C., MFR: 3 g/10 min) was used.

### (2) Surface layer and rear surface layer

As a material for a surface layer and a rear surface layer, a propylene-ethylene random copolymer (manufactured by Prime Polymer Co., Ltd., melting point (Tm): 138° C., MFR: 7 g/10 min) was used.

### (3) Antibacterial Component

The following antibacterial components were compounded in the masterbatch such that the antibacterial components were contained in the intermediate layer in the amounts shown below.

(a) stearyldiethanolamine (C18 DEA)

manufactured by Riken Vitamin Co., Ltd., 2000 ppm

(b) stearyldiethanolamine monostearate (C18 DEA-MS)

manufactured by Riken Vitamin Co., Ltd., 6000 ppm.

(4) Molding of freshness-retentive film

A three-layer film composed of the rear surface layer, the intermediate layer, and the surface layer was continuously molded with a biaxial stretching machine at a ratio of the thicknesses of the layers of 1/8/1 to prepare an original film for stretching. One week later, the original film for stretching was stretched 5 times in the longitudinal direction and 10 times in the lateral direction with a batch stretching machine to produce a freshness-retentive film composed of a multi-layer stretched film. The thickness of the film after stretching was 30 μm. Before stretching, the original film for stretching was preheated at 165° C. for a time shown in Table 24. As the preheating time is longer, a larger amount of the antibacterial component bleeds out to the surface of the film to enhance the antibacterial characteristics. Accordingly, the freshness-retentive film showing high antibacterial characteristics by preheating even for a short time is preferred. The stretching temperature for the freshness-retentive film was 100° C. in longitudinal stretching and 165° C. in lateral stretching. The heat setting temperature was 65° C., and the heat setting time was 10 seconds. In Example 1 and Comparative Examples 1 and 2, the surfaces of the surface layers of the resulting freshness-retentive films were subjected to a corona treatment. It was confirmed with a mixed solution NO. 38.0 for a wet tension test manufactured by Wako Pure Chemical Industries, Ltd. that the corona-treated surfaces had wetting index of 38 dyn or more. In contrast, in Comparative Examples 3 to 5, the non-corona-treated surfaces had wetting index of less than 35 dyn.

The freshness-retentive films were subjected to an antibacterial test. The results are shown in Table 24. Example 1 showed sufficient antibacterial characteristics, which evidently indicates that the antibacterial component was present on the surface of the freshness-retentive film at 0.002 to 0.5 g/m².

TABLE 24

| | | Comparative | Comparative | | Comparative | Comparative | Comparative |
|---|---|---|---|---|---|---|---|
| | | Example 1 | Example 2 | Example 1 | Example 3 | Example 4 | Example 5 |
| Preheating temperature (° C.) | | 165 | 165 | 165 | 165 | 165 | 165 |
| Preheating time (sec) | | 60 | 180 | 300 | 60 | 180 | 300 |
| Corona treatment | | Treated | Treated | Treated | Not treated | Not treated | Not treated |
| Antibacterial | Initial | 1.2 × 10⁵ | 1.4 × 10⁵ | 1.4 × 10⁵ | 1.2 × 10⁵ | 1.4 × 10⁵ | 1.4 × 10⁵ |
| test (E. coli) | (colonies/g) | | | | | | |
| | After 24 h, n = | 6.3 × 10⁶ | 8.9 × 10⁴ | 8.7 × 10³ | 1.8 × 10⁶ | 1.0 × 10⁵ | 3.9 × 10⁵ |
| | 1 (colonies/g) | | | | | | |
| | After 24 h, n = | 5.2 × 10⁶ | 1.2 × 10⁵ | 7.5 × 10³ | 4.9 × 10⁶ | 1.9 × 10⁵ | 2.7 × 10⁵ |
| | 2 (colonies/g) | | | | | | |
| | After 24 h, n = | 6.1 × 10⁶ | 1.1 × 10⁵ | 1.8 × 10⁴ | 3.3 × 10⁶ | 1.3 × 10⁵ | 2.6 × 10⁴ |
| | 3 (colonies/g) | | | | | | |
| | Average | 5.9 × 10⁶ | 1.1 × 10⁵ | 1.1 × 10⁴ | 3.3 × 10⁶ | 1.4 × 10⁵ | — |
| | (colonies/g) | | | | | | |

This application claims priority from Japanese Patent Application No. 2013-51536, filed on Mar. 14, 2013, Japanese Patent Application No.

2013-108524, filed on May 23, 2013, Japanese Patent Application No. 2013-139180, filed on Jul. 2, 2013, Japanese Patent Application No. 2013-217871, filed on Oct. 18, 2013, and Japanese Patent Application No. 2013-240601, filed on Nov. 21, 2013, the entire contents of which are hereby incorporated by reference.

As above, the invention of the present application has been described with reference to Embodiments and Examples, but the invention of the present application will not be limited to Embodiments and Examples above. The configuration and details of the invention of the present application can be modified in various ways understandable by persons skilled in the art within the scope of the invention of the present application.

### INDUSTRIAL APPLICABILITY

The freshness-retentive film according to the present invention can retain the freshness of vegetables, fruit, meat, and fresh fish, particularly cut vegetables sold in supermarkets, convenience stores, grocery stores, and the like. Specifically, high antibacterial activity can be attained by wrapping such food products with the freshness-retentive film according to the present invention or enclosing the food products in bags formed of the film, so that fresh food products, particularly cut vegetables can be protected against rot, and can be kept hygienic to avoid food intoxication. Furthermore, the freshness-retentive film according to the present invention can be widely used as a packaging material such as packaging bags because the film is devised such that the antibacterial component is prevented from directly migrating to contents so as not to enter the human body.

1. A freshness-retentive film, comprising at least one compound selected from the group consisting of palmityldiethanolamine, stearyldiethanolamine, glycerol monolaurate, and diglycerol monolaurate, wherein the at least one compound is present on at least one surface at 0.002 to 0.5 g/m².

2. The freshness-retentive film according to claim 1, wherein the freshness-retentive film comprises the compound in an amount of 0.001 to 3% by mass.

3. The freshness-retentive film according to claim 1, wherein the freshness-retentive film comprises at least one of a propylene-based polymer and an ethylene-based polymer.

4. The freshness-retentive film according to claim 1, wherein at least one surface has a wetting index of 35 dyn or more.

5. The freshness-retentive film according to claim 1, wherein the freshness-retentive film further comprises at least one of myristyldiethanolamine monostearate and stearyldiethanolamine monostearate.

6. The freshness-retentive film according to claim 1, wherein a region comprises the compound in a thickness-wise direction from a surface of the film to be in contact with a content, the region ranging from 50 to 90% of the overall thickness of the film.

7. The freshness-retentive film according to claim 1, wherein the freshness-retentive film comprises two or more layers, and wherein the freshness-retentive film comprises the compound only in a layer having a surface of the film to be in contact with a content.

8. The freshness-retentive film according to claim 1, wherein the freshness-retentive film comprises an ethylene-based polymer, and the density of the ethylene-based polymer increases in a thickness-wise direction from the surface of the film to be in contact with a content.

9. A freshness-retentive film, comprising:
0.01 to 1.0% by mass of alkyldiethanolamine, and
0.01 to 1.0% by mass of at least one of diglycerol monopalmitate and diglycerol monomyristate.

10. The freshness-retentive film according to claim 9, wherein the alkyldiethanolamine is present on at least one surface at 0.002 to 0.5 g/m².

11. The freshness-retentive film according to claim 9, wherein the alkyldiethanolamine is at least one of palmityldiethanolamine and stearyldiethanolamine.

12. A freshness-retentive film, comprising:
50 to 95% by mass of a linear low density polyethylene (A) having a density of 0.85 to 0.95 g/cm³, and
5 to 50% by mass of a high pressure low density polyethylene (B) having a density of 0.91 to 0.93 g/cm³, where the total amount of the linear low density polyethylene (A) and the high pressure low density polyethylene (B) is 100% by mass,
0.5 to 10 parts by mass of an adhesive (C),
0.5 to 5 parts by mass of an antifog additive (D), and
0.001 to 3 parts by mass of at least one specific compound (E) selected from the group consisting of palmityldiethanolamine, stearyldiethanolamine, glycerol monolaurate, and glycerol monocaprate relative to 100 parts by mass of the total amount of the linear low density polyethylene (A) and the high pressure low density polyethylene (B),
wherein the specific compound (E) is present on at least one surface at 0.002 to 0.5 g/m².

13. A packaging material, comprising a freshness-retentive film according to claim 1.
